(19) United States
(12) Patent Application Publication
(10) Pub. No.: US 2026/0088699 A1
(43) Pub. Date: Mar. 26, 2026

(54) MULTI-MODE VOLTAGE REGULATOR

(71) Applicant: TEXAS INSTRUMENTS INCORPORATED, DALLAS, TX (US)

(72) Inventors: Divya KAUR, DELHI (IN); Angelo PEREIRA, ALLEN, TX (US); Christy SHE, ALLEN, TX (US); Ari VAANANEN, OULU (FI); Sri Navaneethakrishnan EASWARAN, PLANO, TX (US)

(21) Appl. No.: 19/042,471

(22) Filed: Jan. 31, 2025

Related U.S. Application Data
(60) Provisional application No. 63/698,158, filed on Sep. 24, 2024.

(51) Int. Cl. H02M 1/00; G05F 1/56; H02M 1/084; H02M 3/07

(52) U.S. Cl. CPC H02M 1/0045; G05F 1/56; H02M 1/0016; H02M 1/0845; H02M 3/07

(57) ABSTRACT

An example multi-mode voltage regulator is described. The voltage regulator can have an output terminal. The voltage regulator can include a mode detector that can be configured to determine whether an inductive element is coupled to the output terminal based on an amount of inductance at the output terminal. The mode detector is configured to set the voltage regulator to operate in either a buck mode of operation or a linear dropout (LDO) mode of operation based on the amount of inductance at the output terminal.

### CROSS-REFERENCE TO RELATED APPLICATIONS

This application claims the benefit of U.S. Provisional Application No. 63/698,158, filed 24 Sep. 2024, entitled: SELF-CONFIGURABLE REGULATOR WITH MODE CHANGE STEP-UP CONVERTER. The entirety of this provisional application is hereby incorporated by reference for all purposes.

### TECHNICAL FIELD

This disclosure relates to voltage regulation. More particularly, this disclosure relates to a multi-mode voltage regulator.

### BACKGROUND

Voltage regulators are used in electronic systems to provide a stable output voltage despite fluctuations in an input voltage or varying power demands. By providing consistent power, voltage regulators allow for reliable and efficient operation of electronic devices and protect sensitive components from voltage instability, which could otherwise lead to malfunction or damage of circuit components. Voltage regulators are used in a wide range of applications, including consumer electronics (e.g., smartphones, laptops, etc.), automotive systems (e.g., infotainment, engine control units, etc.), industrial equipment (e.g., robotics, automation controllers, etc.), medical devices (e.g., portable diagnostic equipment, implantable devices, etc.), etc.

### SUMMARY

A first example relates to a system that includes a voltage regulator. The voltage regulator can have an output terminal. The voltage regulator can include a mode detector that can be configured to determine whether an inductive element is coupled to the output terminal based on an amount of inductance at the output terminal. The mode detector can be configured to set the voltage regulator to operate in either a buck mode of operation or a linear dropout (LDO) mode of operation based on the amount of inductance at the output terminal.

A second example relates to a circuit comprising a transistor having a control terminal and a step-up converter having first and second inputs and an output. The output of the step-up converter can be coupled to the control terminal of the transistor. The circuit can further include a phase signal generator having first and second outputs. The first output of the phase signal generator can be coupled to the first input of the step-up converter, and the second output of the phase signal generator can be coupled to the second input of the step-up converter. The circuit can further include a level shifter that can include an input and an output. The input of the level shifter can be coupled to the output of the step-up converter, and the output of the level shifter can be coupled to the control terminal of the transistor.

A third example relates to a method that can include filtering one or more sequences of voltage pulses applied to an output terminal to detect an amount of inductance at the output terminal. An output of a multi-mode voltage regulator can be coupled to the output terminal. The method can further include evaluating each of the filtered one or more sequence of voltage pulses to a pseudo-inductive threshold representative of a parasitic inductance at the output terminal to provide one or more sets of inductor detection signals and setting the multi-mode voltage regulator to one of a first mode or a second mode of operation based on a logical state of the one or more sets of inductor detection signals.

### BRIEF DESCRIPTION OF THE DRAWINGS

FIG. 1 illustrates an example of a block diagram of a voltage regulator.

FIGS. 2A-2B illustrates another example of a block diagram of a voltage regulator.

FIG. 3 illustrates an example of a block diagram of a mode detector.

FIG. 4 illustrates an example of a portion of a mode detector.

FIG. 5 illustrates an example of a flowchart of a method for setting an operating mode of a voltage regulator.

FIG. 6 illustrates an example of an inductor detector circuit.

FIG. 7A illustrates an example of a block diagram of a portion of a driver stage of a voltage regulator.

FIG. 7B is an example of a step-up converter of a voltage regulator.

FIG. 8 illustrates an example of a level shifter of a voltage regulator.

FIG. 9 is an example of a voltage regulation system for providing a regulated voltage.

FIG. 10 is an example of a voltage regulation system for providing a regulated LDO output voltage.

FIG. 11 illustrates an example of a waveform diagram relating to an operation of a step-up converter of a voltage regulator.

FIG. 12 an example of a waveform diagram relating to an operation of a phase generator of a voltage regulator.

FIG. 13 illustrates an example of a waveform diagram relating to an operation of a regulator.

FIG. 14 illustrates another example of a waveform diagram relating to an operation of a regulator.

FIG. 15 illustrates an example of a waveform diagram for configuring a regulator to operate in a buck mode of operation.

FIG. 16 illustrates an example of a waveform diagram for configuring a regulator to operate in a linear dropout (LDO) mode of operation.

FIG. 17 illustrates an example of a flowchart of a method for setting an operating mode of a voltage regulator.

FIG. 18 illustrates an example of a datacenter system.

### DETAILED DESCRIPTION

Power management integrated circuits (PMICs) are utilized in electronic systems and devices, such as smartphones, laptops, and embedded systems to regulate voltage, manage power consumption and deliver stable rail voltages. PMICs are integrated circuits designed to manage power distribution within the electronic system based on a power source (e.g., a battery, wall adapter, or other power supply). Components within the electronic system, including, for example, subsystems, processors, memory modules, sensors, and communication interfaces, operate based on specific voltage and current levels. PMICs are used to provide regulated voltage and current levels so that these components operate or function properly. For example, a processor may need 1.8 volts (V), while a sensor may need 3.3V. Additionally, current demands of a component in the electronic system can vary based on workload or operational mode. For instance, a processor can draw higher current during intensive processing tasks and lower current during idle periods. PMICs can dynamically adjust a current supplied to components, such as a processor, to optimize power delivery and reduce power waste.

For example, PMICs can be configured with a number of different voltage regulators to supply regulated voltages to various components within the electronic system. Example voltage regulators can include switching regulators, such as buck converters and boost converters, and linear voltage regulators (LDOs). Switching regulators can be used to supply regulated operating voltages to components of the electronic system that are capable of tolerating switching noise, such as processors, memory modules, and other types of high-power digital circuits. Switching regulators can be used for high-power applications due to the energy efficiency and heat dissipation capabilities of such devices. By contrast, LDOs can be used for noise-sensitive components, such as, for example, analog circuits and radio-frequency (RF) modules, as such voltage regulators can provide a stable, low-noise output voltage when compared to the regulated voltage provided by the switching regulator. Although LDOs are less efficient than switching regulators because such circuits dissipate excess voltage as heat, LDOs are preferred over switching regulators for low-power applications, which need a clean, ripple-free voltage for proper component operation or functionality.

PMICs can be customized with different combinations of voltage regulators, such as LDOs and buck converters, to meet specific system requirements and application constraints. Tailoring the number and type of regulators can reduce production costs (e.g., bill of materials and packaging), save board space and improve component or system performance. For example, electronic systems that have lower power demands or fewer voltage rails, a custom PMIC can be designed that includes a reduced number of buck converters or LDOs. A voltage rail refers to a power line or connection that distributes a consistent voltage level (e.g., a regulated operating voltage) to one or more components in the electronic system. Voltage rails can be referred to by an amount of operating voltage that such rails can provide (e.g., a 3.3V rail or a 5V rail). In some applications, ripple and noise can influence which types of voltage regulators are incorporated into a PMIC design. For example, noise-sensitive circuits, such as analog components or RF modules, need a regulated LDO output voltage (a voltage that is free or substantially free of noise). To enhance the flexibility of PMICs to accommodate (e.g., be used in different system and/or application requirements), PMICs can be configured with a BLDO (Buck-LDO) circuit. A BLDO circuit is a type of voltage regulator that can be operated in either buck mode or LDO mode based on electronic system and/or application requirements. This dual-mode capability of the BLDO circuit enables designers to adapt PMICs to varying power demands without a need for specific system or application custom PMIC designs.

Incorporating the BLDO circuit into a PMIC design requires additional pins on the PMIC (when compared to a PMIC design that does not include the BLDO circuit) to support a configurability across an output stage (a power stage) and driver stage of the BLDO circuit. For instance, additional pins are needed on the PMIC (e.g., an IC package) to manage a configuration of the BLDO circuit across the output stage and driver stage. These additional pins increase the package cost and size of the PMIC. Furthermore, use of additional pins increases the footprint of the PMIC, thereby increasing printed circuit board (PCB) footprint.

In accordance with one or more examples described herein, a multi-mode voltage regulator circuit (referred to herein as a regulator for simplicity) for a PMIC that does not require use of additional pins when compared to existing PMIC designs that use the BLDO circuit. Unlike conventional BLDO-based PMICs that rely on additional power pins for driver and/or output stage configuration, the multi-mode regulator integrates these functionalities internally, thereby eliminating a need for additional power pins.

The regulator, as described herein, is capable of operating in an LDO mode or a buck mode of operations, and, in some examples, in a fault mode of operation. Thus, in some examples, the regulator can be referred to as a self-configurable BLDO regulator. In some examples, the regulator includes a mode detector circuit that can automatically configure (or set) the multi-mode regulator into an appropriate mode of operation, such as buck mode, LDO mode, or fault mode based on whether an external inductor is or is not coupled to an output terminal (e.g., an output pin) of the PMIC. Furthermore, the regulator uses a dual-mode step-up converter, which can supply a driver stage and/or output stage with proper voltages during a respective mode of operation, thereby eliminating a need for an external power supply, as in existing regulators configured with a BLDO circuit. Thus, a regulator architecture, as described herein, can support high-speed performance in buck mode while delivering low-noise, low-dropout performance in LDO mode. The regulator can be adapted to a wide range of power demands across various electronic systems, including, but not limited to, consumer electronics, automotive applications, embedded systems, and industrial electronics, etc.

A PMIC configured with the multi-mode regulator, as described herein, achieves a reduced package size, lower manufacturing costs, and allows for use of a more simplified PCB layout by eliminating a need for additional pins and external configurations as in other PMIC configurations such as PMIC designs that incorporate the BLDO circuit. Resultantly, a PMIC configured with the multi-mode regulator, as described herein, results in a more compact, flexible, and cost-effective power management solution capable of meeting diverse power demands. Furthermore, the PMIC with the multi-mode regulator, as described herein, can be used in a variety of applications, systems, and/or devices, such as factory automation, programmable logic controllers (PLCs), vision cameras, human machine interfaces (HMIs), heating, ventilation and air conditioning (HVAC), thermostats, video doorbells, building security, video surveillance, industrial PC, energy monitoring, electrical vehicle (EV) charging, smart meters, solar inverters, data concentrators, test and measurement protection relays, patient monitoring and diagnostics, imaging, ultrasound, baby monitoring, infusion pumps, appliances, user interfaces, video analysis, robotic vacuums, robotic lawnmowers, smart phones, netbooks, portable media players, audio players, digital still cameras, automotive clusters, automotive infotainment systems, digital radio, body lighting, and other types of applications, systems and/or devices.

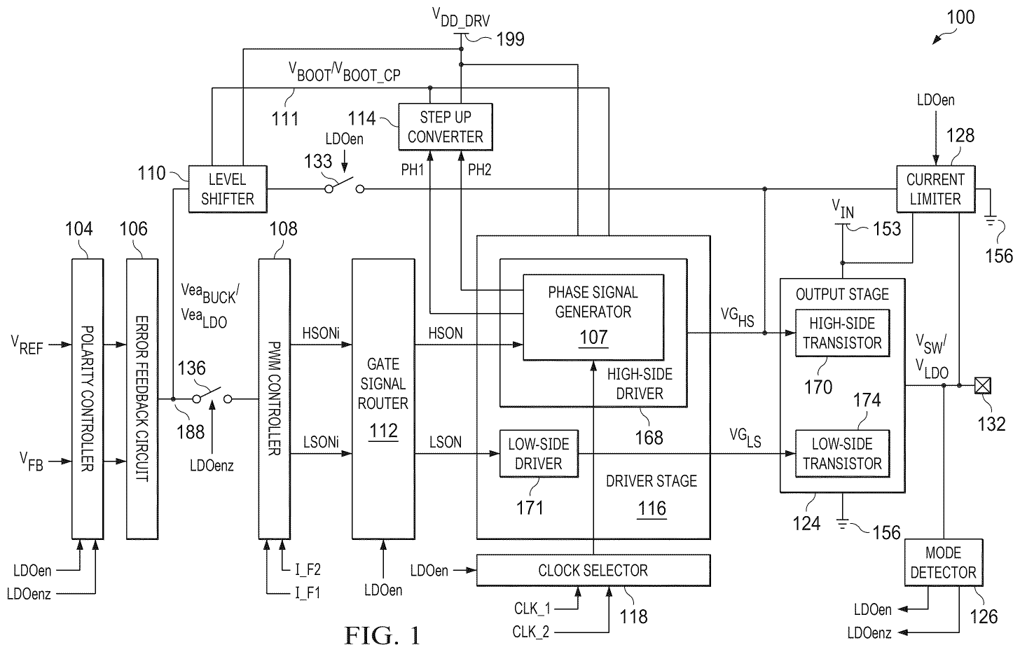

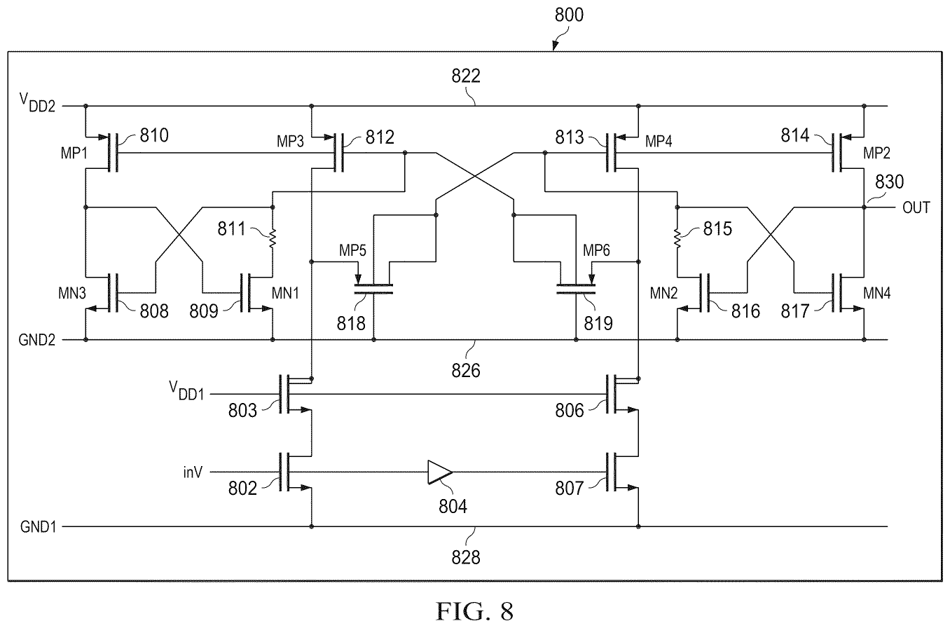

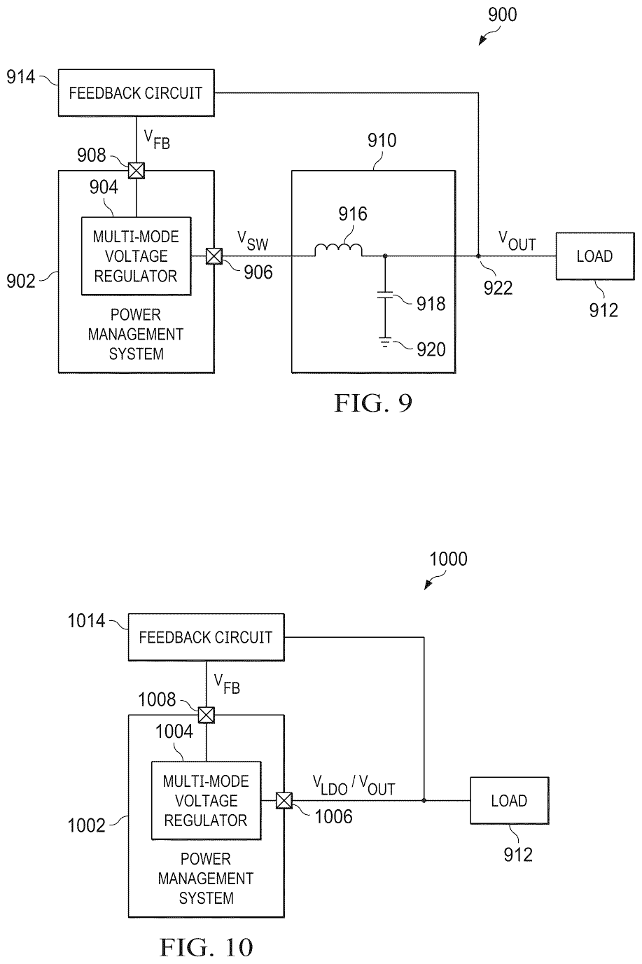

FIG. 1 illustrates an example of a block diagram of a multi-mode voltage regulator circuit 100 (referred herein for simplicity as a regulator 100). In some examples, the regulator 100 can be implemented as part of a power management system (e.g., a power management system 902 of FIG. 9 or a power management system 1002 of FIG. 10). The regulator 100 can be used to provide an output terminal voltage (also can be referred to as an output terminal voltage) at an output terminal 132 of the regulator 100. In some examples, the output terminal 132 corresponds to an output terminal 132 of the power management system. The output terminal 132 can correspond to an output pin (or terminal) of the PMIC. Thus, in some examples, the output terminal 132 can be coupled to the output terminal of the power management system. Upon the regulator 100 being powered (e.g., receiving proper voltages for operation), the regulator 100 can be configured to operate in a mode configuration mode (or a mode detection mode) to configure/set an operating mode (voltage regulating mode) of the regulator 100.

The regulator 100 can be set to operate in a buck mode of operation, an LDO mode operation, and, in some instances, in an error mode of operation. In examples in which the regulator 100 operates in the LDO mode of operation, the regulator 100 can provide a regulated LDO output voltage (identified as “V_{LDO}” in FIG. 1). The regulator 100 can be configured to operate in the LDO mode of operation to deliver power to one or more loads that are noise sensitive, which can be referred to herein as noise sensitive loads. Example noise sensitive loads can include, but not limited to, analog components, RF modules, and other types of noise-sensitive circuits/components. In examples in which the regulator 100 operates in the buck mode of operation, the regulator 100 can provide a switching voltage (identified as “V_{SW}” in FIG. 1) at the output terminal 132. An inductor can be coupled to the output terminal 132 and configured in series with a capacitor to provide a regulated voltage based on the switching voltage, as described herein. For example, the regulator 100 can be configured to operate in the buck mode of operation to deliver power to one or more loads that are noise insensitive, which can be referred to herein as non-noise sensitive loads. Example non-noise sensitive loads can include, but not limited to, processors, memory modules, types of digital circuits, etc.

The regulator 100 includes a polarity controller 104 configured to enable a selection and operation of different modes of the regulator 100, such as the buck and the LDO mode. The polarity controller 104 compensates for differences in polarity of feedback input voltages, such as a mode reference voltage (identified as “V_{REF}” in FIG. 1) and a feedback output voltage (identified as “V_{FB}” in FIG. 1), provided to an error feedback circuit 106 of the regulator 100. The error feedback circuit 106 can be implemented as an amplifier. The polarity of feedback input connections to the error feedback circuit 106 can be adjusted to achieve negative feedback, which differs depending on whether the regulator 100 operates in buck mode or LDO mode. The polarity controller 104 can be configured to dynamically route the mode reference voltage and feedback output voltage to the appropriate polarity inputs of the error feedback circuit 106 for the selected mode of operation.

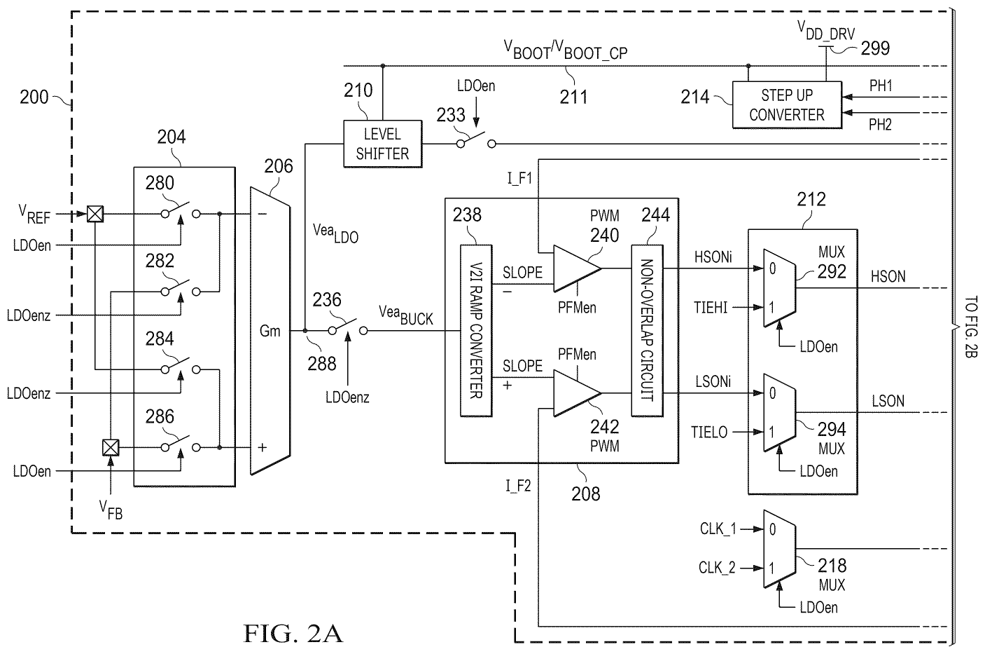

The polarity controller 104 can be implemented as a set of switches. The mode reference voltage can be provided by a band gap or equivalent voltage generator. The feedback output voltage can be provided by a voltage scaling circuit (e.g., by a voltage scaling circuit 258 as shown in FIG. 2). In one configuration, referred to herein as a first example, the voltage scaling circuit can be coupled to the output terminal 132. This configuration is used when the regulator 100 supplies a sensitive load with the regulated LDO output voltage in the LDO mode. In the first example, the voltage scaling circuit provides the feedback output voltage based on the regulated LDO output voltage. In another configuration, referred to herein as a second example, the voltage scaling circuit provides the feedback output voltage based on the switching voltage. This configuration is used when the regulator 100 is configured to supply power to a non-sensitive load. In the second example, the voltage scaling circuit can be coupled to the output of an LC (inductor-capacitor) filter, or LC tank circuit, which can be coupled to the output terminal 132. The LC filter smooths the switching voltage to provide the regulated voltage to a load. The polarity controller 104 can dynamically route the mode reference voltage and feedback output voltage to appropriate polarity inputs of the error feedback circuit 106 for different regulator operating modes.

For example, a first input of the polarity controller 104 can be configured to receive at a first input the mode reference voltage and at the second input the feedback output voltage. A third input of the polarity controller 104 can receive an LDO enable signal (identified as “LDOen” in FIG. 1) at a logical high level (“1”) from a mode detector 126 of the regulator 100, for example, in response to the mode detector 126 determining that the regulator 100 is to operate in the LDO mode of operation. In some examples, a fourth input of the polarity controller 104 can receive an LDO disable signal (identified as “LDOenz” in FIG. 1) at a logical high level (“1”) from the mode detector 126, for example, in response to the mode detector 126 determining that the regulator 100 is to operate in the buck mode of operation. The LDO enable and disable signals are opposite polarity such that the polarity controller 104 is either in BUCK or LDO mode. The mode detector 126 can provide the LDO enable signal at the logical high level/state at a first output in response to detecting (or determining) that no external inductor is coupled to the output terminal 132 corresponding to determining that regulator 100 is to operate in the LDO mode of operation. By outputting the LDO enable signal at the logical high state, the mode detector 126 configures (sets) the regulator 100 to operate in the LDO mode of operation.

In some examples, the mode detector 126 is configured to detect a presence of inductance at the output terminal 132 to determine an appropriate mode of operation for the voltage regulator. A detection of parasitic inductance at the output terminal 132 corresponds to determining that no external inductor is coupled to the output terminal 132. Parasitic inductance, which can result from stray inductive elements inherent in a circuit design or packaging, exhibit lower inductance values than those of an intentionally coupled external inductor. This distinction allows the mode detector 126 to determine whether an external inductor is present or absent. For instance, in the absence of an external inductor, the parasitic inductance at the output terminal 132, can be detected by the mode detector 126. This detection can then trigger the mode detector 126 to configure the regulator 100 to operate in the LDO mode of operation. By contrast, when an external inductor is coupled to the output terminal, the inductance detected at the output terminal 132 would exceed a threshold value indicative of parasitic inductance, prompting the regulator 100 to operate in the buck mode of operation.

In some examples, in response to detecting that no external inductor is coupled to the output terminal 132, the mode detector 126 does not provide the LDO enable signal (corresponding to the LDO enable signal being at a logical low level “0”). Rather, in some instances, the mode detector 126 can provide the LDO disable signal at a logical high level (“1”) at a second output in response to determining that the external inductor is coupled to the output terminal 132 corresponding to determining that regulator 100 is to operate in the buck mode of operation. By outputting the LDO disable signal at the logical high state, the mode detector 126 configures (sets) the regulator 100 to operate in the buck mode of operation. The LDO disable signal at the logical high level can be provided to a fourth input of the polarity controller 104, as shown in FIG. 1. For example, the polarity controller 104 can provide the mode reference voltage to a first input of the error feedback circuit 106 and the feedback output voltage to a second output of the error feedback circuit 106 in response to receiving one or more LDO enable signals. In other examples, the polarity controller 104 can provide the mode reference voltage to the second input of the error feedback circuit 106 and the feedback output voltage to the first output of the error feedback circuit 106 in response to receiving one or more LDO disable signals.

In yet some examples, the mode detector 126 provides a single signal (e.g., the LDO enable signal) to the polarity controller 104, which can include an inverter to generate a complementary signal (the LDO disable signal). The polarity controller 104 in such examples can use the LDO enable signal for one configuration (e.g., LDO mode) and invert the LDO enable signal internally to generate the complementary signal (the LDO disable signal) for the other configuration (e.g., buck mode). This configuration reduces a number of output signals from the mode detector 126, thereby simplifying a design of the regulator 100.

In some examples, the error feedback circuit 106 can output an error feedback voltage (or error feedback signal) based on the mode reference voltage and the feedback output voltage. In some examples, the error voltage is referred to as an amplified error voltage. The error feedback circuit 106 can establish at a compensation node 188 of the regulator 100 the error voltage (error feedback signal) based on the feedback output voltage and the feedback reference voltage. The error voltage provided at the compensation node 188 during the buck mode of operation of the regulator 100 can be referred to herein as a buck error voltage (identified as “Vea_{BUCK}” in FIG. 1). The error voltage provided at the compensation node 188 during the LDO mode of operation of the regulator 100 can be referred to herein as an LDO error voltage (identified as “Vea_{LDO}” in FIG. 1).

In some examples, the regulator 100 includes a pulse width modulation (PWM) control switch 136 and a PWM controller 108. The PWM controller 108 can be configured to control (e.g., regulate) the switching voltage or switching waveform at the output terminal 132 during the buck mode of operation of the regulator 100. The PWM controller 108 can be configured to control switching transistors, high-side and low-side transistors 170, 174 of an output stage (power stage) 124 of the regulator 100, such as on- and off-times to provide the switching voltage at the output terminal 132 during the buck mode of operation of the regulator 100. The PWM control switch 136 is configured to control whether the PWM controller 108 is enabled. For example, the PWM control switch 136 can be enabled (e.g., closed) during the buck mode of operation of the regulator 100 in response to receiving the LDO disable signal at the logical high level. In response to the PWM control switch 136 being enabled (closed), the buck error voltage can be used by the PWM controller 108 to provide a high-side gate control signal (identified as “HSONi” in FIG. 1) and a low-side gate control signal (identified as “LSONi” in FIG. 1). The high-side gate control signal can be used to control when the high-side gate voltage (shown as “VG_{HS}” in FIG. 1) is provided to the high-side transistor 170. The low-side gate control signal can be used to control when a low-side gate voltage (shown as “VG_{LS}” in FIG. 1) is provided to the low-side transistor 174.

For example, an input of the PWM controller 108 can receive the error voltage (the buck error voltage) in response to the PWM control switch 136 being closed. The PWM controller 108 can output the high- and low-side gate control signals based on the buck error voltage and first and second current feedback signals (identified as “I_F1” and “I_F2” in FIG. 1, respectively) during the buck mode of operation of the regulator 100. The first and second current feedback signals can be derived from the output stage 124 of the regulator 100. In the buck mode of operation of the regulator 100, the PWM controller 108 provides high-side and low-side gate control signals for generation of gate drive voltages for driving high-side and low-side transistors 170 and 174. The high-side gate control signal can be output at a first output of the PWM controller 108 based on the buck error voltage and the first feedback current signal. For example, when the high-side gate control signal is active or at a logical high state, the high-side transistor 170 is on and a node voltage potential at the output terminal 132 is equal to an input voltage provided by an input voltage source 153. The low-side gate control signal can be output at a second output of the PWM controller 108 based on the buck error voltage and the second feedback current signal. For example, when the low-side grate control signal is active or at a logical high, the low-side transistor 174 is on and the node voltage potential at the output terminal 132 is at a ground 156.

The PWM controller 108 can include internal circuits, such as pulse-width modulators and ramp generators, to modulate gate control signals according to a duty cycle to switch the high- and low-side transistors 170, 174 in a defined (or specified) manner to provide the switching voltage at the output terminal 132. A first ramp generator of the PWM controller 108 can produce a falling ramp signal for high-side modulation and a second ramp generator of the PWM controller 108 can produce a rising ramp signal for low-side modulation. The rising and falling ramps signals can be compared to the error feedback signal from the error feedback circuit 106 to determine when to provide the high-side and low-side gate control signals. By dynamically adjusting a duty cycle of the high-side and low-side gate control signals, the PWM controller 108 controls a switching behavior of the high-side and low-side transistors 170, 174 (e.g., when these transistors are on and off). A duty cycle of a logical high state of the high-side gate control signal determines a proportion of time that the high-side transistor 170 remains on during each switching cycle. A duty cycle of a logical high state of the low-side gate control signal determines a proportion of time that the low-side transistor 174 remains on during each switching cycle. Adjusting the duty cycle of the high-side and low-side gate control signals sets a timing and duration of switching transitions of the switching voltage at the output terminal 132. Switching transitions refer to periodic changes between a high voltage state and a low voltage state of the switching voltage at the output terminal 132, as controlled by the on and off states of the high-side and low-side transistors 170, 174.

In some examples, the regulator 100 includes a gate signal router 112 to control whether the low- and high-side gate control signals are provided (routed) to a driver stage 116 of the regulator 100. The gate signal router 112 can be implemented as a set of multiplexers. A first input of the gate signal router 112 can be coupled to the first output of the PWM controller 108 to receive the high-side gate control signal. A second input of the gate signal router 112 can be coupled to the second output of the PWM controller 108 to receive the low-side gate control signal. A third input of the gate signal router 112 can be coupled to the mode detector 126 to receive the LDO enable signal at the logical high level, such as when the mode detector 126 determines that no inductor is coupled to the output terminal 132. During the buck mode of operation of the regulator 100, the gate signal router 112 provides the low- and high-side gate control signals to the driver stage 116 (shown as “HSON” and “LSON” in FIG. 1, respectively) in response to receiving the LDO enable signal at the logical high level. During the LDO mode of operation of the regulator 100, the gate signal router 112 does not provide the low- and high-side gate control signals to the driver stage 116 as the LDO enable signal is in (or at) a high state (“1”). For example, during the LDO mode of operation of the regulator 100, the gate signal router 112 does not provide the low- and high-side gate control signals for active switching. Instead, when the LDO enable signal is at the logical high state, a low-side gate of the driver stage 116 (a low-side driver 171) is coupled to a logical low level (e.g., 0 V) to deactivate the low-side transistor 174, and a high-side gate (a high-side driver 168) is deactivated or controlled based on a specific type of output needed for LDO mode of operation. This configuration ensures proper operation of the regulator 100 in the LDO mode without a need for switching transistors for voltage regulation.

As shown in FIG. 1, the driver stage 116 includes the high-side driver 168 and the low-side driver 171. A first input of the driver stage 116 can receive the high-side gate control signal and a second input of the driver stage 116 can receive the low-side gate control signal. During the buck mode of operation, the high-side driver 268 can provide the high-side gate voltage at a first output of the driver stage 216 in response to receiving the high-side gate control signal. The low-side driver 271 can provide the low-side gate voltage at a second output of the driver stage 216 in response to receiving the low-side gate control signal during the buck mode of operation.

In some examples, the driver stage 116 can receive a first clock signal (identified as “CLK_1” in FIG. 1) at a third input from a clock selector 118 during the buck mode of operation of the regulator 100 and a second clock signal (identified as “CLK_2” in FIG. 1) from the clock selector 118 during the LDO mode of operation of the regulator 100. The first and second clock signals can differentiate between switching frequencies for buck and LDO mode operations. In some examples, the first clock signal can correspond to the high-side gate control signal. In yet further examples, the first clock signal can be synchronized with or used to provide the first clock signal. The clock selector 118 includes a first input to receive the first clock signal, which can be provided by a first clock generator and a second input to receive a second clock signal, which can be provided by a second clock generator, and a signal select input to receive the LDO enable signal. The first clock signal can operate at a higher clock frequency than the second clock signal.

By way of example, the first clock signal can have a clock frequency of about 2 Megahertz (MHz), and a clock frequency of the second clock signal can be in a range of about 20 Kilohertz (KHz) to about 250 Khz. The clock frequency of the first and second clock signals can be based on a desired performance and regulator architecture design. The first clock signal can be used to synchronize a buck high side and low side gate control to a predetermined frequency. Such synchronization in some examples can be used to control Electro-Magnetic Interference (EMI) or to optimize buck efficiency which can be affected by losses incurred in switching on and off the transistors 170 and 174. The second clock signal can be used to control phases of the bootstrap circuit or step-up converter 114 that can provide a high side transistor supply. The second clock signal can operate at a different and lower frequency than the first clock signal. A frequency of the second clock signal can be based on a desired output impedance of a supply needed for the high side transistor 170 in LDO mode without significant droop. The clock selector 118 can provide the first clock signal to the driver stage 116 when the LDO enable signal is at the logical low level. The clock selector 118 can provide the second clock signal to the driver stage 216, for example, when the LDO enable signal is at the logical high level.

In some examples, the driver stage 116 includes a phase signal generator 107. While the example of FIG. 1 illustrates the phase signal generator 107 implemented as part of the driver stage 116 (the high-side driver 168), in other examples, the phase signal generator 107 can be implemented outside of the driver stage 16 or the high-side driver 168. The phase signal generator 107 can be configured to provide first and second phase signals (identified as “PH1” and “PH2” respectively in FIG. 1) to a step-up converter 114 of the regulator 100, in some instances, referred to as a voltage converter 114. During the buck mode of operation, these phase signals are in phase with each other and are provided based on the high-side gate control signal. In other examples, such as during the LDO mode of operation, the phase signal generator 107 provides the step-up converter 114 with phase signals that are out of phase with each other. These out-of-phase signals can be provided based on the second clock signal during the LDO mode of operation. The term “in phase” indicates that the first and second phase signals rise and fall about simultaneously, and thus maintain about the same timing, while the term “out of phase” indicates that the signals rise and fall at about opposite times, such that one is high while the other is low.

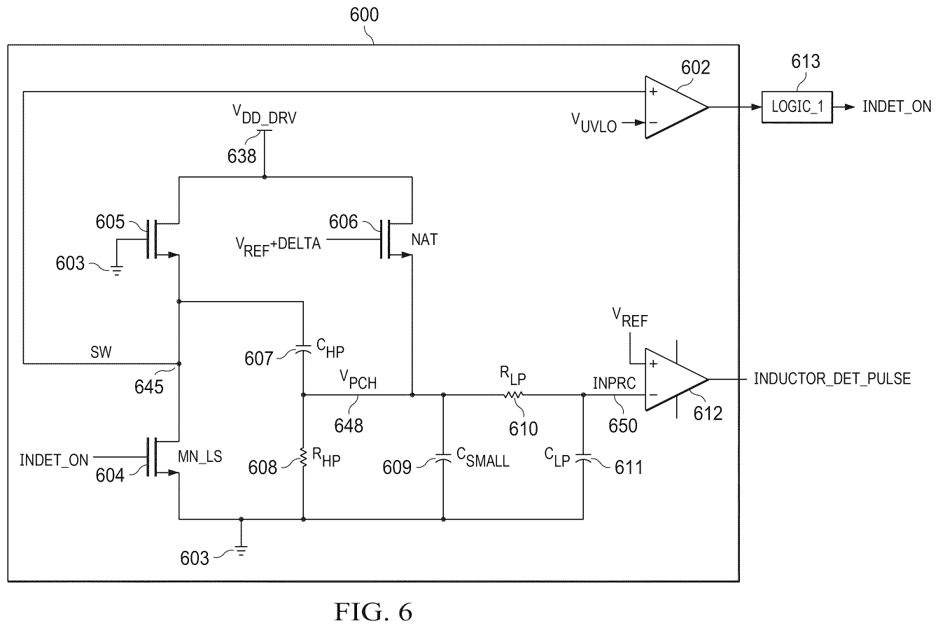

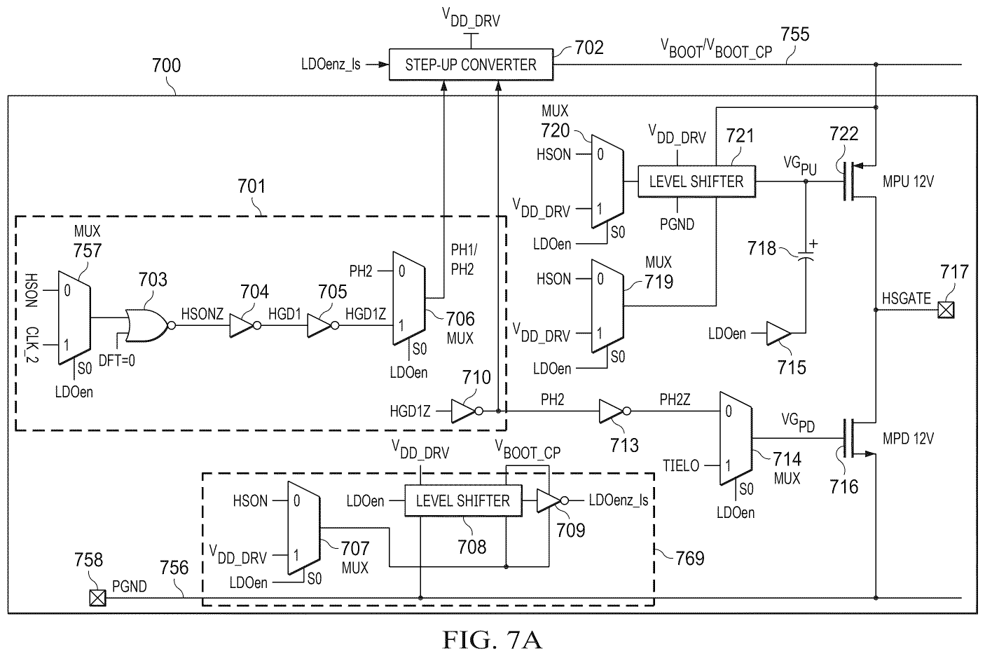

The first and second phase signals can represent timing signals used to control an operation of the step-up converter 114 in a voltage converter mode, such as a bootstrap mode and a charge pump mode. The first phase signal can represent a rising and falling edge timing for a part of a switching cycle of the step-up converter 114. Thus, the first phase signal can control a charging or activation of capacitors (e.g., capacitors 723 and 739 of FIG. 7B) of the step-up converter 114 corresponding to controlling the voltage converter mode of the step-up converter 114. The second phase signal represents a complementary timing to the first phase signal. For example, the step-up converter 114 is configured to operate in a charge pump mode in response to receiving the first and second phase signals that are out-of-phase. The step-up converter 114 is configured to operate in a bootstrap mode in response to receiving the first and second phase signals that are in phase.

For example, the step-up converter 114 can receive a driver supply voltage (identified as “V_{DD_DRV}” in FIG. 1), which can be provided by a driver supply voltage source 199. The step-up converter 114 can output a boot voltage (identified as “V_{BOOT}” in FIG. 1) on a step-up voltage rail 111 of the regulator 100. In the buck mode of operation, the step-up converter 114 is configured as a bootstrap circuit and can output the boot voltage on the step-up voltage rail 111 based on the driver supply voltage. The boot voltage can be generated in response to receiving first and second phase signals that are in phase, allowing the step-up converter 114 to operate in a bootstrap mode during the buck mode of operation. The boot voltage may not be a constant value in buck mode. The boot voltage can be held at the input voltage when the high-side transistor 170 is off, and then the voltage is raised to about two times the input voltage (excluding any losses) when the high-side transistor 170 is turned on. In the LDO mode of operation, the step-up converter 114 can be configured to operate as a charge pump and output a charge pump voltage (identified as “V_{BOOT_CP}” in FIG. 1) on the step-up voltage rail 111 based on the driver supply voltage. The charge pump voltage can be a nearly constant voltage. Thus, the charge pump voltage can represent a steady-state (high) voltage, which can be used for applications that need a stable voltage output. The charge pump voltage can be generated in response to the step-up converter 114 receiving first and second phase signals that are out of phase with each other. This configuration allows the step-up converter 114 to efficiently generate the steady-state voltage needed to supply a driver of the high-side transistor 170 during the LDO mode of operation.

For example, during the buck mode of operation of the regulator 100, the high-side driver 168 can provide the high-side gate voltage based on the boot voltage and the driver supply voltage in response to receiving the high-side gate control signal. Similarly, the low-side driver 171 drives the low-side transistor 174 of the output stage 124 by providing the gate of the low-side transistor 174 with the low-side gate voltage based on the driver supply voltage in response to receiving the low-side gate control signal. The low-side gate drive voltage causes the low-side transistor 174 to conduct. The high- and low-side transistors 170, 174 alternate in conducting at a predetermined switching frequency. An output terminal voltage at the output terminal 132 alternates between the input voltage or a ground voltage at the ground 156 depending on if the high side transistor 170 is on or if the low side transistor 174 is on. A duty cycle of the output terminal voltage can set an output load voltage (a regulated voltage) at a load node (e.g., a load node 298 of FIG. 2). The output terminal voltage at the load node can represented by the following expressions:

$${V}_{OUT} = \frac{{T}_{ON - HS}}{{T}_{ON - HS} + {T}_{ON - LS}} {V}_{IN} , \qquad ( 1 )$$

wherein V_{OUT} is the regulated output voltage provided at the load node, T_{ON-HS} is a time duration which the high-side transistor 170 is conducting (e.g., on phase) in a switching cycle, T_{ON-LS} is a time duration during which the low-side transistor 174 is conducting (e.g., on phase) in the switching cycle, and V_{IN} is the input voltage provided by the input voltage source 153.

In the expression (1), a sum of the T_{ON-HS} and T_{ON-LS} can represent a total period of the switching cycle, which can be approximately constant and equal to a period of the first clock signal.

In some examples, the regulator 100 includes a level shifter 110. During the LDO mode of operation of the regulator 100, the level shifter 110 can receive the error voltage as the LDO error voltage provided at the compensation node 188. During the LDO mode of operation of the regulator 100, the PWM control switch 136 is disabled (e.g., open) and thus the PWM controller 108 does not receive the error voltage and does not output the high- and low-side gate control signals. The level shifter 110 can receive the charge pump voltage from the step-up voltage rail 111 during the LDO mode of operation. As described herein, the step-up converter 114 can output the charge pump voltage on the step-up voltage rail 111 based on the driver supply voltage and in response to receiving first and second phase signals that are out of phase during the LDO mode of operation of the regulator 100. The first and second phase signals can be provided based on the second clock signal, as described herein.

In some examples, such as the first example, the regulator 100 operates in the LDO mode of operation. During the LDO mode of operation of the regulator 100, the high-side transistor 170 is driven by the level shifter 110. The level shifter 110 can provide at an output the high-side gate voltage to drive the high-side transistor 170 based on the charge pump voltage, the LDO error voltage and the driver supply voltage. For example, the LDO error voltage can be adjusted by the error feedback circuit 106 (e.g., by an error amplifier) to a level suitable for driving the gate of the high-side transistor 170. The level shifter 110 can translate this adjusted LDO error voltage to a higher or lower voltage level corresponding to the high-side gate voltage based on the charge pump voltage to drive the high-side transistor 170.

In some examples, an LDO gate drive switch 133 can be used to couple the output of the level shifter 110 to the gate of the high-side transistor 170. The LDO gate drive switch 133 can be enabled (e.g., closed) in response to receiving the LDO enable signal at the high logical level. By closing the LDO gate drive switch 133 this provides or establishes a current path from the output of the level shifter 110 to the gate of the high-side transistor 170. Enabling the LDO gate drive switch 133 allows the level shifter 110 to provide a gate drive voltage to the gate of the high-side transistor 170, thereby enabling the high-side transistor 170 to provide the regulated LDO output voltage at the output terminal 132 during the LDO mode of operation.

In some examples, the regulator 100 includes a current limiter 128. The current limiter 128 can be configured to monitor the current flowing through the high-side transistor 170 to prevent excessive current from reaching the output terminal 132 during the LDO mode of operation. The current limiter 128 can dynamically adjust the high-side gate voltage provided by the level shifter 110 to control the amount of current flowing through the high-side transistor 170.

For example, as current flows from the input voltage source 153 through the high-side transistor 170 to the output terminal 132, the current can be monitored by the current limiter 128. When the current flowing through the high-side transistor 170 exceeds a predefined threshold, the current limiter 128 provides an electrical path from the output of the level shifter 110 to the ground 156 (e.g., couples the output of the level shifter 110 to the ground 156). This reduces the high-side gate drive voltage provided by the level shifter 110 at the gate of the high-side transistor 170, causing the high-side transistor 170 to behave more resistively. By making the high-side transistor 170 more resistive, a voltage drop from the input voltage to the regulated LDO output voltage is across a higher resistance and this curtails the current flowing through the high-side transistor 170 to the output terminal 132, thereby preventing excessive current from reaching the output terminal 132, and protecting a load coupled to the output terminal 132. Once the current falls below the predefined threshold, the current limiter 128 decouples (or disconnects) the output of the level shifter 110 from the ground 156. This allows the level shifter 110 to restore a full gate drive voltage to the high-side transistor 170, enabling the high-side transistor 170 to resume normal operation (e.g., conducting or switching) to provide the regulated LDO output voltage.

FIGS. 2A-2B is an example of a block diagram of a multi-mode voltage regulator circuit 200 (referred herein for simplicity as a regulator 200). In some examples, the regulator 200 can be implemented as part of a power management system (e.g., a power management system 902 of FIG. 9 or a power management system 1002 of FIG. 10). In some examples, the regulator 200 corresponds to the regulator 100 of FIG. 1. The regulator 200 can be used to provide an output terminal voltage (also can be referred to as an output terminal voltage) at an output terminal 232 (corresponding to the output terminal 132 of FIG. 1) of the power management system. The regulator 200 can operate in a buck mode or an LDO mode of operation, in yet further examples, the regulator 200 can operate in an error mode of operation. In examples in which the regulator 200 operates in the buck mode of operation, the regulator 200 can provide a switching voltage (identified as “V_{SW}” in FIGS. 2A-2B) at the output terminal 232. In examples in which the regulator 200 operates in the LDO mode of operation, the regulator 200 can provide a regulated LDO output voltage (identified as “V_{LDO}” in FIGS. 2A-2B) at the output terminal 232.

For example, the regulator 200 includes a polarity controller 204 (corresponding to the polarity controller 104 of FIG. 1) and an error feedback circuit 206 (corresponding to the error feedback circuit 106 of FIG. 1), which function to provide an (amplified) error feedback voltage (or error feedback signal) for stabilizing the output terminal voltage at the output terminal 232 during the buck and the LDO mode of operation of the regulator 200. The polarity controller 204 is configured to drive the error feedback circuit 206 by selectively routing input voltages based on a mode of operation of the regulator 200. The polarity controller 204 can be configured to control routing of input voltages, such as a mode reference voltage (identified as “V_{REF}” in FIGS. 2A-2B) and a feedback output voltage (identified as “V_{FB}” in FIGS. 2A-2B)) to a proper polarity input of the error feedback circuit 206. For example, in some instances, a polarity switch can occur in a polarity of the mode reference voltage or the feedback output voltage. The polarity controller 204 is configured to enable a selection and operation of different modes of the regulator 200, such as the buck and the LDO mode.

The polarity controller 204 includes switches 280-286. The switches 280, 284 can be coupled to a band gap or equivalent voltage generator to receive the mode reference voltage. The switches 282, 286 can be coupled to a voltage scaling circuit 258 to receive the feedback output voltage, which can be a portion (or fraction) of the output terminal voltage at the output terminal 232. The voltage scaling circuit 258 can be external to the regulator 200, as shown in FIGS. 2A-2B. The polarity controller 204 can receive an LDO enable signal (identified as “LDOen” in FIGS. 2A-2B). The LDO enable signal can be provided by a mode detector 226. In some examples, the LDO enable signal can be provided by an external system or circuit (e.g., a controller), which can determine or set an operating mode of the regulator 200. For example, the LDO enable signal 226 can be provided to an external pin of a circuit that includes the regulator 200, such as a PMIC and the regulator 200 can be coupled to the external pin to receive the LDO enable signal 226. In yet some examples, a memory bit, such as a register or a flip-flop of the external system or circuit can store a state of the LDO enable signal. This bit can be written by a controller or another control unit during system initialization or operation. A stored value corresponding to the memory bit can determine whether the regulator 200 is to operate in the LDO or buck mode of operation. The mode detector 226 can provide the LDO enable signal at a logical high level or state (“1”) at a first output in response to determining that no external inductor (e.g., an inductor 264) is coupled to the output terminal 232 corresponding to determining that regulator 200 is to operate in the LDO mode of operation. By outputting the LDO enable signal at the logical high state, the mode detector 226 configures (sets) the regulator 200 to operate in the LDO mode of operation. The LDO enable signal can be used to enable the switches 280, 286 in response to the mode detector 226 detecting that the external inductor is not coupled to the output terminal 232.

In some examples, in response to determining that the external inductor is coupled to the output terminal 232, the mode detector 226 does not provide the LDO enable signal (corresponding to the LDO enable signal being at a logical low level “0”). In other examples, the mode detector 226 can provide an LDO disable signal (identified as “LDOenz” in FIGS. 2A-2B) at a logical high level (“1”) at a second output in response to determining that the external inductor is coupled to the output terminal 232 corresponding to determining that regulator 200 is to operate in the buck mode of operation. By outputting the LDO disable signal at the logical high state, the mode detector 226 configures (sets) the regulator 200 to operate in the buck mode of operation. The LDO disable signal can be used to enable the switches 282, 284 in response to the mode detector 226 detecting that the external inductor is coupled to the output terminal 232.

In some examples, in response to the switches 280, 286 being enabled by the LDO enable signal, the mode reference voltage is provided to a first input (identified as “−” in FIGS. 2A-2B) of the error feedback circuit 206 and the feedback output voltage is provided to a second input (identified as “+” in FIGS. 2A-2B) of the error feedback amplifier 206. In other examples, in response to the switches 282, 284 being enabled by the LDO disable signal, the feedback output voltage is provided to the first input of the error feedback circuit 206 and the mode reference voltage is provided to the second input of the error feedback circuit 206. The error feedback circuit 206 provides at a compensation node 288 in the regulator 200 (corresponding to the compensation node 188 of FIG. 1) the (amplified) error voltage (error feedback signal) based on the feedback output voltage and the feedback reference voltage. The error voltage provided at the compensation node 288 during the buck mode of operation of the regulator 200 can be referred to as a buck error voltage (identified as “Vea_{BUCK}” in FIGS. 2A-2B). The error voltage provided at the compensation node 288 during the LDO mode of operation of the regulator 200 can be referred to as an LDO error voltage (identified as “Vea_{LDO}” in FIGS. 2A-2B).

In some examples, the regulator 200 includes a PWM control switch 236 (corresponding to the PWM control switch 136 of FIG. 1). The PWM control switch 236 is configured to control whether a PWM controller 208 (corresponding to the PWM controller 108 of FIG. 1) of the regulator 200 is enabled. For example, the PWM control switch 236 can be enabled (e.g., closed) during the buck mode of operation of the regulator 200 in response to receiving the LDO disable signal at the logical high level. In response to the PWM control switch 236 being enabled (closed), the buck error voltage can be used by the PWM controller 208 to provide a high-side gate control signal (identified as “HSONi” in FIGS. 2A-2B) and a low-side gate control signal (identified as “LSONi” in FIGS. 2A-2B).

The PWM controller 208 is configured to control the switching voltage or switching waveform at the output terminal 232 during the buck mode of operation of the regulator 200. The PWM controller 208 includes a voltage-to-current (V2I) ramp converter 238 (referred to herein for simplicity as a converter 238), a first PWM circuit 240, a second PWM circuit 242 and a non-overlap circuit 244. The PWM controller 208 can be configured to control switching transistors, high-side and low-side transistors 270, 274 (identified respectively as “M_{HS}” and “M_{LS}” in FIGS. 2A-2B) of an output stage (power stage) 224 of the regulator 200, such as on- and off-times of these transistors to provide the switching voltage at the output terminal 232.

For example, the converter 238 can include a V2I circuit to sense (measure) a voltage at the compensation node 288. The V2I circuit can provide an error current signal that is indicative of the buck error voltage. The converter 238 can include a ramp generator to provide a negative (or falling) ramp signal (identified as “Slope−” in FIGS. 2A-2B) and a positive (or rising) ramp signal (identified as “Slope+” in FIGS. 2A-2B) based on the error current signal. The negative ramp signal can represent a ramp waveform that decreases over a time window, whereas the positive ramp signal can represent a ramp waveform that increases over a time window. The negative ramp signal can be provided to a first input of the first PWM circuit 240 and the positive ramp signal can be provided to a first input of the second PWM circuit 242.

The second input of the first PWM circuit 240 is configured to receive a first current feedback signal (identified as “I_F1” in FIGS. 2A-2B). The first PWM circuit 240 can be configured to provide a first output voltage feedback signal based on the first current feedback signal and the negative ramp signal. The second input of the second PWM circuit 242 is configured to receive a second current feedback signal (identified as “I_F2” in FIGS. 2A-2B). The second PWM circuit 242 can be configured to provide a second output voltage feedback signal based on the second current feedback signal and the positive ramp signal. The first and second current feedback signals can represent the switching voltage at the output terminal 232. The first and second PWM circuits 240-242 can be configured to receive a pulse frequency enable signal (identified as “PFMen” in FIGS. 2A-2B) to enable the first and second PWM circuits 240-242 for generation of the high- and low-side gate control signals.

In some examples, the non-overlap circuit 244 of the PWM controller 208 can be configured to receive the high- and low-side gate controls signal from the first and second PWM circuits 240-242, respectively. The non-overlap circuit 244 can be implemented using a combination of digital logic gates, flip-flops, and/or timing circuits. The non-overlap circuit 244 can control when the high- and low-side gate control signals are asserted to a driver stage 216 (corresponding to the driver stage 116 of FIG. 1) so that the high- and low-side transistors 270, 274 do not turn on simultaneously. The non-overlap circuit 244 can add a time delay to separate in time conduction periods of the high-side and low-side transistors 270, 274 to prevent simultaneous conduction of the high- and low-side transistors 270, 274.

For example, the high-side gate control signal is output by the non-overlap circuit 244 to cause the high-side transistor 270 to conduct. During this period (e.g., when the high-side gate control is at the logical high level), the low-side gate control signal is not asserted high by the non-overlap circuit 244 and the low-side transistor 274 is off (is not conducting), allowing the high-side transistor 270 to conduct and transfer current, which can be provided by an input voltage source 253 (corresponding to the input voltage source 153 of FIG. 1), to the output terminal 232. In some examples, the low-side gate control signal is asserted high by the non-overlap circuit 244 to cause the low-side transistor 274 to conduct, for example, when the high-side transistor 270 is not conducting. During this period (e.g., when the low-side gate control is at the logical high level), the high-side gate control signal is asserted logic low by the non-overlap circuit 244 such that the high-side transistor 270 is off (is not conducting), allowing a current to flow from the output terminal 232 through the low-side transistor 274 to a ground 256 (corresponding to the ground 156 of FIG. 1).

In some examples, the regulator 200 includes a gate signal router 212 (corresponding to the gate signal router 112 of FIG. 1) to control how the low- and high-side gate control signals are asserted to the driver stage 216. During the buck mode of operation of the regulator 200, the gate signal router 212 provides the low- and high-side gate control signals to the driver stage 216. During the LDO mode of operation of the regulator 200, the gate signal router 212 does not provide the low- and high-side gate control signals to the driver stage 116.

The gate signal router 212 includes a first multiplexer 292 and a second multiplexer 294. The first multiplexer 292 can receive the high-side gate control signal at a first input. A second input of the first multiplexer 292 can be coupled to the ground 256 and thus can be at about 0V (identified as “TIEHI” in FIGS. 2A-2B). During the LDO mode of operation of the regulator 200, a signal select input of the first multiplexer 292 can receive the LDO enable signal at the logical high level (“1”). The second multiplexer 294 can receive the low-side gate control signal at a first input. A second input of the second multiplexer 294 can be coupled to the ground 256 and thus can be at about 0V (identified as “TIELO” in FIGS. 2A-2B). During the LDO mode of operation of the regulator 200, a signal select input of the second multiplexer 294 can receive the LDO enable signal at the logical high level.

In some examples, during the buck mode of operation of the regulator 200, the first multiplexer 292 is configured to provide at an output the high-side gate control signal (identified as “HSON” in FIGS. 2A-2B), which can be coupled to a first input of the driver stage 216, such as when the LDO enable signal is at a logical low level (“0”). During the buck mode of operation, a high-side driver 268 (identified as “DRVH” in FIGS. 2A-2B) of the driver stage 216 can provide the high-side gate voltage at a first output of the driver stage 216 in response to the high-side gate control signal. The second multiplexer 294 is configured to provide at an output the low-side gate control signal (identified as “LSON” in FIGS. 2A-2B), which can be coupled to a second input of the driver stage 216 such as when the LDO enable signal is at the logical low level. During the buck mode of operation, a low-side driver 271 (identified as “DRVL” in FIGS. 2A-2B) of the driver stage 216 can provide the low-side gate voltage at a second output of the driver stage 216 in response to the low-side gate control signal.

In some examples, during the LDO mode of operation of the regulator 200, respective first inputs of the first and second multiplexer 292-294 can be used to couple (e.g., electrically couple) the first and second inputs of the driver stage 216 to the ground 256 when the LDO enable signal is at the logical high level. In this configuration, a high-side driver input is tri-stated (e.g., not driven to any value) as an output stage of the driver stage 216 is coupled to a level shifter (e.g., an analog level shifter, in some examples, a level shifter 210 of FIGS. 2A-2B), while a low-side driver input is set to 0. By coupling the first and second inputs of the driver stage 216 to the ground 256 in this manner, the use of the high-side gate control signal and low-side gate control signal for generation of the high-side and low-side gate voltages is prevented, ensuring the high- and low-side transistors 270, 274 are not driven during the LDO mode of operation. Accordingly, by coupling the first and second inputs of the driver stage 216 to the ground 256, prevents the use of the high-side gate control signal and low-side gate control signal for generation of the high-side and low-side gate voltages for driving the high- and low-side transistors 270, 274, respectively.

In some examples, the driver stage 216 can receive a first clock signal (identified as “CLK_1” in FIGS. 2A-2B) at a third input and a second clock signal (identified as “CLK_2” in FIGS. 2A-2B), which can be provided by a third multiplexer 218 (corresponding to the clock selector 118 of FIG. 1). The first and second clock signals of FIGS. 2A-2B can correspond to the first and second clock signals of FIG. 1. The third multiplexer 218 includes a first input to receive the first clock signal, which can be provided by a first clock generator and a second input to receive a second clock signal provided by a second clock generator, and a signal select input to receive the LDO enable signal. The first clock signal can operate at a higher clock frequency than the second clock signal. The third multiplexer 218 can provide the first clock signal to the driver stage 216 during the buck mode of operation of regulator 200, for example, when the LDO enable signal is at the logical low level). The third multiplexer 218 can provide the second clock signal to the driver stage 216 during the LDO mode of operation of regulator 200, for example, when the LDO enable signal is at the logical high level.

In some examples, the driver stage 216 includes a phase signal generator 207 (corresponding to the phase signal generator 107 of FIG. 1). While the example of FIGS. 2A-2B illustrates the phase signal generator 207 implemented as part of the driver stage 216 (the high-side driver 268), in other examples, the phase signal generator 207 can be implemented outside of the driver stage 216 or the high-side driver 268. The phase signal generator 207 can be configured to provide first and second phase signals (identified as “PH1” and “PH2” respectively in FIGS. 2A-2B) to a step-up converter 214 of a regulator 200 (corresponding to the step-up converter 114 of FIG. 1). During the buck mode of operation, these phase signals are in phase with each other and are provided based on the high-side gate control signal. In other examples, during the LDO mode of operation, the phase signal generator 207 provides the step-up converter 214 with phase signals that are out of phase with each other. These out-of-phase signals are provided based on the second clock signal during the LDO mode of operation.

For example, the step-up converter 214 can receive a driver supply voltage (identified as “V_{DD_DRV}” in FIGS. 2A-2B), which can be provided by a driver supply voltage source 299 (corresponding to the driver supply voltage source 199 of FIG. 1). The step-up converter 214 can output a boot voltage (identified as “V_{BOOT}” in FIGS. 2A-2B) on a step-up voltage rail 211 of the regulator 200 (corresponding to the step-up voltage rail 111 of FIG. 1). For example, the step-up converter 214 can output the boot voltage on the step-up voltage rail 211 based on the driver supply voltage and in response to receiving first and second phase signals that are in phase, such as during the buck mode of operation of the regulator 200. In some examples, the step-up converter 214 can output a charge pump voltage (identified as “V_{BOOT_CP}” in FIGS. 2A-2B) on the step-up voltage rail 211 based on the driver supply voltage and in response to receiving first and second phase signals that are out of phase with respect to each other, such as during the LDO mode of operation of the regulator 200.

For example, during the buck mode of operation of the regulator 200, the high-side driver 268 can provide the high-side gate voltage based on the boot voltage and the driver supply voltage in response to receiving the high-side gate control signal. The high-side gate voltage causes the high-side transistor 270 to conduct corresponding to a stepping down of an input voltage (identified as “V_{IN}” in FIGS. 2A-2B), which can be provided by an input voltage source 253 (corresponding to the input voltage source 153 of FIG. 1), to a desired output voltage (the switching voltage). During the buck mode of operation of the regulator 200, the low-side driver 271 drives the low-side transistor 274 of the output stage 224 by providing the gate of the low-side transistor 274 with the low-side gate voltage based on the driver supply voltage in response to receiving the low-side gate control signal. The low-side gate drive voltage causes the low-side transistor 274 to conduct so that the current flows from the output terminal 232 to the ground 256 to reduce the switching voltage at the output terminal 232 (e.g., drive the switching voltage to about 0V).

The high- and low-side transistors 270, 274 alternate in conducting overtime at a switching frequency to provide the switching voltage at the output terminal 232. The term “switching frequency” refers to a rate at which the high-side and low-side transistors 270, 274 turn on and off and represents a number of complete switching cycles that can occur over a period of time. The term “switching cycle” refers to a complete sequence of operations during which the high- and low-side transistors 270, 274 are alternately turned on and off to provide the switching voltage at the output terminal 232 during the buck mode of operation of the regulator 200. Each switching cycle includes an on-phase and an off-phase. During the on phase, the high-side transistor 270 is turned on (conducts) while the low-side transistor 274 is turned off and during the off-phase the low-side transistor 274 is turned on (conducts) and the high-side transistor 270 is turned off. A duration of each phase of a switching cycle is determined by a duty cycle, which is a proportion of time a switching transistor (e.g., the high- or low-side transistor 270, 274) is on when compared to a total duration of the duty cycle, as determined by a gate control signal (e.g., the high- or low-side gate control signal).

For example, during each switching cycle, when the high-side gate control signal is active (is at a logical high state), the high-side driver 268 drives the gate of the high-side transistor 270 to turn on the high-side transistor 270. This allows current to flow from the input voltage source 253 through the high-side transistor 270 to the output terminal 232, effectively stepping down the input voltage provided by the input voltage source 253 to a desired output voltage level. The high-side transistor 270 conducts for a determined duration, known as an on-time, which is defined by a duty cycle of a PWM control signal (e.g., the high-side gate control signal) provided by the first PWM circuit 240. Once the on-time is complete, the high-side gate control signal transitions low (into a logical low state), and the high-side transistor 270 turns off. The low-side gate control signal transitions into a logical high state and activates the low-side driver 271 to turn on the low-side transistor 274. This allows current to flow from the output terminal 232 to the ground 256, completing a switching cycle.

As shown in FIGS. 2A-2B, the high-side transistor 270 is connected between the input voltage source 253 and the output terminal 232. A source of the high-side transistor 270 can be coupled to the input voltage source 253 and a drain of the high-side transistor 270 can be coupled to the output terminal 232. The low-side transistor 274 can be coupled between the output terminal 232 and the ground 256. A source of the low-side transistor 274 can be coupled to the ground 256 and a drain of the low-side transistor 274 can be coupled to the output terminal 232. The high-side and low-side transistors 270, 274 can be N-channel metal-oxide-semiconductor field effect transistors (N-channel MOSFETs).

In some examples, the output stage 124 includes a first V2I converter 272 and a second V2I converter 276. The first V2I converter 272 is configured to detect (sense) a drain-to-source of the high-side transistor 270 indicative of the output voltage at the output terminal 232 during the on-phase of the switching cycle. The V2I converter 276 is configured to sense (detect) a drain-to-source voltage of the low-side transistor 274 indicative of the output voltage at the output terminal 232 during the off-phase of the switching cycle. The first and second V2I converters 272, 276 convert respective sensed drain-to-source voltages into a proportional current corresponding to the first and second current feedback signals, as described herein. For example, the first V2I converter 272 provides the first current feedback signal to the first PWM circuit 240 and the second V2I converter 276 provides the second current feedback signal to the second PWM circuit 242. The first and second feedback signals can be used to adjust a duty cycle of PWM signals (e.g., the high and low-side gate control signals) based on the switching voltage across a drain-source pair of the high and low-side transistors 270, 274, respectively.

In some examples, such as in applications in which the regulator 200 is used to provide power to a non-noise sensitive load, referred to herein as a second example, an inductor 264 can be coupled to the output terminal 232. The inductor 264 can be an external inductor, as shown in FIGS. 2A-2B. In the second example, the inductor 264 can have an inductance of about 220 nano-henries (nH) and a capacitor 266 coupled to the inductor 264 can have a capacitance of about 50 microfarads (μF) by way of example. The first terminal of the inductor 264 can be coupled to the output terminal 232 (e.g., output pin of the PMIC, for example), while the second terminal of the inductor 264 can be coupled to a first terminal of the capacitor 266. The second terminal of the capacitor 266 can be coupled to the ground 256, and the non-noise sensitive load can be coupled to the first terminal of the capacitor 266. In this configuration, the inductor 264 functions to smooth out the fluctuations in the switching voltage at the output terminal 232, which results from switching of the high-side and low-side transistors 270, 274 to provide a regulated voltage (identified as “V_{OUT}” in FIGS. 2A-2B).

For example, when the high-side transistor 270 conducts, current flows through the inductor 264, causing the inductor 264 to store energy. When the high-side transistor 270 is turned off and the low-side transistor 274 is turned on, the energy stored in the inductor 264 is transferred to the capacitor 266 to establish the regulated voltage at a load node 298. The capacitor 266 and the inductor 264 function to filter out high-frequency noise and stabilize (regulate) the switching voltage (e.g., provided to the non-noise sensitive load) to provide the regulated voltage.

By providing a low-impedance path for alternating current (AC) signals to the ground 256, the capacitor 266 smooths the switching voltage to provide a substantially stable direct current (DC) voltage corresponding to the regulated voltage. Thus, the inductor 264 and capacitor 266 form a low-pass filter and curtail a voltage ripple in the switching voltage at the output terminal 232 so that an amplitude of the switching voltage is consistent over time (stable or smooth) to provide the regulated voltage at the load node 298. Thus, the regulated voltage is a substantially ripple free voltage version of the switching voltage at the output terminal 232.

As shown in FIGS. 2A-2B, the voltage scaling circuit 258 can be coupled to a load node 298 to sense the regulated voltage. The voltage scaling circuit 258 includes a first resistor 260 and a second resistor 262 that can be coupled in series. The voltage scaling circuit 258 can be coupled to the load node 298, allowing the voltage scaling circuit 258 to sense the regulated voltage to provide a voltage that can be a fraction of the regulated voltage (corresponding to the feedback output voltage as described herein) based on a resistance of the first and second resistors 260-262. The feedback output voltage can be received by the polarity controller 204 and used according to one or more examples herein.

In some examples, the regulator 200 includes a level shifter 210 (corresponding to the level shifter 110 of FIG. 1). The level shifter 210 can receive the error voltage as the LDO error voltage provided at the compensation node 288 during the LDO mode of operation of the regulator 200. During the LDO mode of operation of the regulator 200, the PWM control switch 236 is disabled (e.g., open) and thus the PWM controller 208 does not receive the error voltage and does not output the high- and low-side gate control signals. The level shifter 210 receives the charge pump voltage from the step-up voltage rail 211 during the LDO mode of operation. As described herein, the step-up converter 214 can output the charge pump voltage on the step-up voltage rail 211 based on the driver supply voltage and in response to receiving first and second phase signals that are out of phase. The first and second phase signals can be provided based on the second clock signal, as described herein.

In some examples, such as in applications in which the regulator 200 is used to power a noise sensitive load, referred to herein as a first example, the inductor 264 can be omitted. In some instances, in the first example, the capacitor 266 can be omitted. In the second example, the capacitor 266 can have a capacitance in a range of about 1-10 μF by way of a non-limiting example. In the second example, the regulator 200 operates in the LDO mode of operation. During the LDO mode of operation of the regulator 200, the high-side transistor 270 is driven by the level shifter 210. The level shifter 210 can provide at an output thereof the high-side gate voltage to drive the high-side transistor 270 based on the charge pump voltage and the LDO error voltage. For example, the LDO error voltage can be adjusted by the error feedback circuit 206 (e.g., by an error amplifier) to a level suitable for driving the gate of the high-side transistor 270. The level shifter 210 can translate this adjusted LDO error voltage to a higher or lower voltage level corresponding to the high-side gate voltage based on the charge pump voltage to drive the high-side transistor 270.

In some examples, an LDO gate drive switch 233 can be used to couple the output of the level shifter 210 to the gate of the high-side transistor 170. The LDO gate drive switch 233 can be enabled (e.g., closed) in response to receiving the LDO enable signal at the high logical level. By closing the LDO gate drive switch 233 this provides or establishes a current path from the output of the level shifter 210 to the gate of the high-side transistor 270. This configuration allows the level shifter 210 to provide a gate drive voltage to the gate of the high-side transistor 270, thereby enabling the high-side transistor 270 to provide a regulated LDO output voltage at the output terminal 232 during the LDO mode of operation.

In some examples, the regulator 200 includes a current limiter 228 (corresponding to the current limiter 128 of FIG. 1) to control an amount of current flowing through the high-side transistor 270, such as during the LDO mode of operation of the regulator 200. In other examples, the current limiter 228 can be omitted from the regulator 200. The current limiter 228 includes a transistor 250 (identified as “M_{HS-SNS}” in FIGS. 2A-2B). A source of the transistor 250 can be coupled to the output terminal 232 and thus to the source of the high-side transistor 270 and to the drain of the low-side transistor 274. The transistor 250 receives at a gate the high-side gate voltage and thus can be coupled to the gate of the high-side transistor 270. The current limiter 228 includes a third resistor 248. A first terminal of the third resistor 248 can be coupled to the input voltage source 253 to receive the input voltage and a second terminal of the third resistor 248 can be coupled to a drain of the transistor 250. A voltage sensing amplifier 246 (identified as “LDO ILM AMP” in FIGS. 2A-2B) of the current limiter 228 can be coupled across the third resistor 248. The voltage sensing amplifier 246 can be implemented as an amplifier.

For example, a first input of the voltage sensing amplifier 246 can be coupled to the first terminal of the third resistor 248 and a second input of the voltage sensing amplifier 246 can be coupled to the second terminal of the third resistor 248. An output of the voltage sensing amplifier 246 can be coupled to a transistor 254 of the current limiter 228. A drain of the transistor 254 can be coupled to the LDO gate drive switch 233 and thus to the output of the level shifter 210. A source of the transistor 254 can be coupled to a drain of a transistor 252 of the current limiter 228. A source of the transistor 252 can be coupled to the ground 256 and a gate of the transistor 252 can be coupled to the first output of the mode detector 226 to receive the LDO enable signal.

In some examples, the current limiter 228 can be configured to monitor (sense) the current flowing through the high-side transistor 270 using the transistor 250 and limit the current through the high-side transistor 270 to protect the regulator 200 and/or a connected load from excessive current. For example, the current flowing through the high-side transistor 270 creates a voltage drop across the third resistor 248, which corresponds to a magnitude of the current flowing through the high-side transistor 270. This voltage drop can be sensed by the voltage sensing amplifier 246, which provides a sensed voltage at an output of the voltage sensing amplifier 246. This sensed voltage can be indicative of the magnitude of the current flowing through the high-side transistor 270 (or to the output terminal 232). The voltage sensing amplifier 246 provides the sensed voltage to the gate of the transistor 254. If the sensed voltage exceeds a predefined threshold corresponding to a maximum allowable current, the transistor 254 is activated to curtail a gate drive voltage provided by the level shifter 210 to the high-side transistor 270. The predefined threshold corresponds to a voltage level at which the gate of transistor 254 can conduct.

In some examples, in response to the transistor 254 being activated (e.g., in a conductive state), an electrical path can be created between the output of the level shifter 210 and the ground 256 (while LDO gate drive switch 233 is closed). By creating this path, the current limiter 228 reduces the high-side gate drive voltage at the gate of the high-side transistor 270, thereby reducing the current flowing through the high-side transistor 270 and turning off the high-side transistor 270. As a result, the current limiter 228 protects the regulator 200 and/or the load coupled to the output terminal 232 from overcurrent conditions. Once the current flowing through the high-side transistor 270 (or to the output terminal 232) decreases below the predefined threshold, the transistor 254 is deactivated. This cessation of conduction of the transistor 254 allows the level shifter 210 to restore the gate drive voltage to the high-side transistor 270, enabling the high-side transistor 270 to resume normal operation (e.g., conducting/switching) to provide the regulated linear voltage.

Accordingly, the current limiter 228 can be used to curtail the current flowing through the high-side transistor 270 to prevent excessive current from reaching the output terminal 232 (or a load coupled to the output terminal 232). As such, the current limiter 128 functions as a protection circuit to protect the regulator 200 and/or node from overcurrent conditions. By using the current limiter 228 in the regulator 200 allows the regulator 200 to operate reliably under varying load conditions or demands.

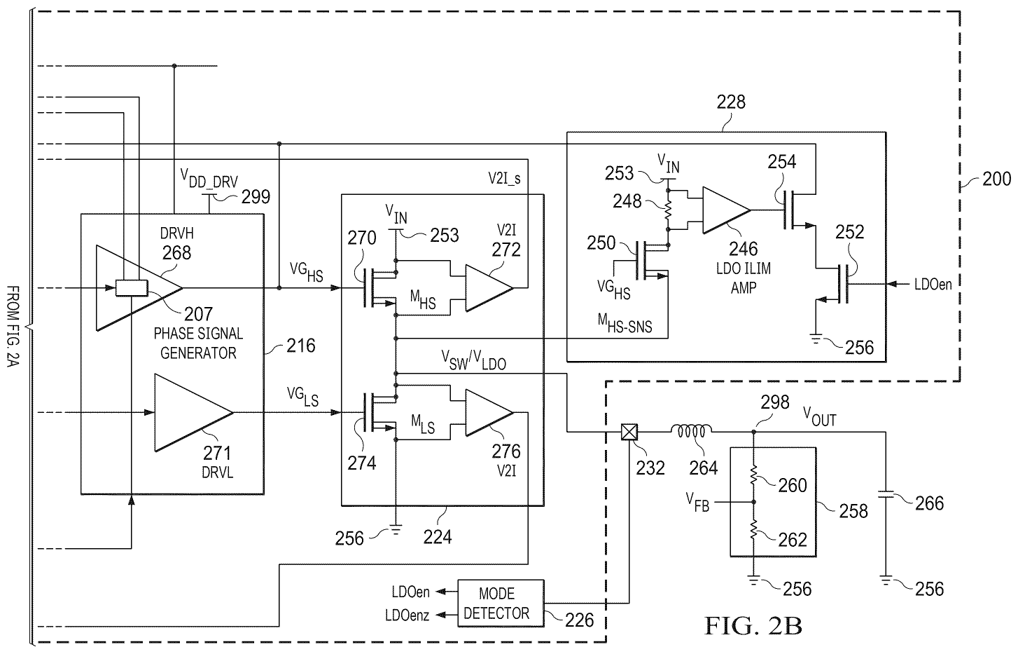

FIG. 3 illustrates an example of a mode detector circuit 300 (for simplicity referred to herein as a mode detector 300) that can be used for setting an operating mode of the regulator 100 of FIG. 1 or the regulator 200 of FIGS. 2A-2B. The mode detector 300 can correspond to the mode detector 126 of FIG. 1 or the mode detector 226 of FIGS. 2A-2B. The mode detector 300 includes a pull-up transistor 302 and a pull-down transistor 304 configured to provide and regulate voltage pulses at an output terminal 306 for mode detection corresponding to detecting whether an external inductor is coupled to the output terminal 306.

The pull-up transistor 302 can be a P-channel MOSFET transistor. In yet other examples, the pull-up transistor 302 can be an N-channel MOSFET transistor. In examples in which the pull-up transistor 302 is implemented as an N-channel MOSFET transistor, the pull-up transistor 302 can be driven by the control circuit 310. By implementing the pull-up transistor 302 as the N-channel MOSFET transistor reduces a circuit area since N-channel MOSFETs are smaller in size compared to P-channel MOSFETs. The pull-down transistor 304 can be an N-channel MOSFET transistor. The pull-up transistor 302 can be coupled in parallel with the high-side transistor 170 of FIG. 1 or the high-side transistor 270 of FIGS. 2A-2B. The pull-down transistor 304 can be coupled in parallel with the low-side transistor 174 of FIG. 1 or the low-side transistor 274 of FIGS. 2A-2B. The pull-down transistor 304 can include a body diode (a built-in diode) that can be formed between drain and source terminals due to a transistor's physical structure. In normal operation, pull-down transistor 304 can be inactive, but the pull-down transistor 304 can conduct current when a drain-to-source voltage is negative, allowing current to flow in a reverse direction. The body diode of the pull-down transistor 304 can be utilized for a rapid dissipation of residual energy. This occurs when the body diode of the pull-down transistor 304 conducts during particular operational conditions, enabling efficient discharge of stored energy in a circuit. Leveraging the body diode of the pull-down transistor 304 enhances system efficiency by facilitating faster transitions and avoiding energy buildup.

For example, the pull-up transistor 302 can be coupled between the input voltage source 153, 253 and the output terminal 306, which can correspond to the output terminal 132 of FIG. 1 or the output terminal 232 of FIGS. 2A-2B. A drain of the pull-up transistor 302 can be coupled to the input voltage source 153, 253 to receive the input voltage, as shown in FIGS. 1-2. A source of the pull-up transistor 302 can be coupled to the output terminal 306. A drain of the pull-down transistor 304 can be coupled to the output terminal 306 and a source of the pull-down transistor 304 can be coupled to a ground node (or terminal) 308 (identified as “PGND” in FIG. 3), which can be coupled to a ground (e.g., the ground 156 of FIG. 1 or the ground 256 of FIGS. 2A-2B). A gate of the pull-up transistor 302 can be driven by a pull-up transistor gate drive voltage that can be provided by a control circuit 310. A gate of the pull-down transistor 304 can also be driven by a pull-down transistor gate drive voltage provided by the control circuit 310.

For example, during an inductor detection mode of operation upon initialization, the control circuit 310 can drive the gates of the pull-up and pull-down transistors 302-304 to facilitate the generation of a sequence of voltage pulses at the output terminal 306. In some examples, the control circuit 310 is configured to output the LDO enable signal during the inductor detection mode of operation, which can be used to configure the step-up converter 114, 214 to provide a boot voltage (e.g., the boot voltage, as shown in FIGS. 1 and 2A-2B) according to one or more examples, as described herein. The control circuit 310 can use the boot voltage to control a turning on and off of the pull-up and pull-down transistors 302-304 in a controlled sequence (to generate the sequence of voltages at the output terminal 306. The control circuit 310 receives gate drive signals from the inductor detector logic 314 and responds by applying appropriate gate voltages to the pull-up and pull-down transistors 302-304 to turn on and off these transistors in a controlled sequence. The control circuit 310 can notify (or alert) the inductor detector logic 314 in response to outputting a gate drive voltage for a corresponding pull-up or pull-down transistor. The sequence of voltage pulses provided by the pull-up and pull-down transistors 302-304 can be used for detecting a presence of an external inductor 316 (identified as “L_{EXT}” in FIG. 3) coupled to the output terminal 306. The external inductor 316 and an external capacitor 318 (identified as “C_{EXT}” in FIG. 3) can form an external LC filter 320. A first terminal of the inductor 316 can be coupled to the output terminal 306, and a second terminal can be coupled to a first terminal of the capacitor 318. The second terminal of the capacitor 318 can be coupled to the ground node 308.

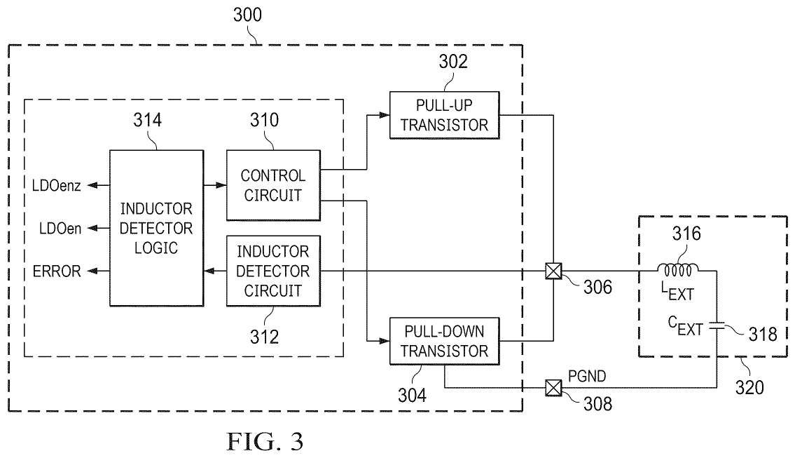

The mode detector 300 can further include an inductor detector circuit 312 and inductor detector logic 314, which can be configured to process voltage pulses at the output terminal 306 to determine whether the external inductor 316 is present (e.g., coupled or not coupled to the output terminal 306). The inductor detector circuit 312 provides detection signals based on the voltage pulses at the output terminal 306. The inductor detector circuit 312 can include a comparator and an internal RC filter (e.g., an internal RC filter 438 of FIG. 4). This internal RC filter suppresses parasitic inductance spikes by smoothing noise and transient effects in the voltage pulses, generating a filtered voltage pulse. Parasitic inductance can arise from unintended inductive elements in a circuit, such as physical traces (wire traces) or other physical connections, rather than from the external inductor 316. The internal RC filter can provide a filtered voltage pulse that can represent an amount of inductance present at the output terminal 306, which can be referred to as output terminal inductance. A parasitic inductance refers to an inductive behavior present at the output terminal 306 due to the unintended inductive elements. The parasitic inductance can represent a minimum inductance (baseline) at the output terminal 306, attributable to unintended inductive elements, when no external inductor 316 is coupled. The output terminal inductance can include an unintended parasitic inductance (the parasitic inductive baseline) or a combination of the unintended parasitic inductance and the inductance of the external inductor 316 (referred to herein as a combined inductance), if the external inductor 316 is coupled to the output terminal 306. Thus, the mode detector 300 can distinguish between when the external inductor 316 is coupled to the output terminal 306 for buck mode and parasitic inductive elements for LDO mode. Therefore, the mode detector 300 can differentiate intentional inductance from parasitic inductance.

By way of further example, the comparator compares the filtered voltage pulse to a reference voltage corresponding to a pseudo-inductive threshold representing the parasitic inductive. The output of the comparator indicates whether the voltage pulse satisfies a threshold condition. The voltage pulse satisfies the threshold condition when the filtered voltage pulse is equal to or greater than the reference voltage. The inductor detector logic 314 receives inductor detection signals from the inductor detector circuit 312, for example, from a comparator output of the inductor detector circuit 312. The inductor detector logic 314 uses the detection signals to determine whether the external inductor 316 is coupled to the output terminal 306 for setting an operating mode of the regulator 100, 200. For example, the inductor detector logic 314 evaluates whether the inductor detection signals satisfied the threshold condition. For example, if the inductor 316 is present, impedance characteristics of the inductor 316 modify the behavior of the voltage pulses, resulting in inductor detection signals that meet the threshold condition.

In some examples, the inductor detector logic 314 controls the control circuit 310 by sending signals to configure the gate voltages of the pull-up and pull-down transistors 302-304. For example, when initiating a voltage pulse, the inductor detector logic 314 instructs the control circuit 310 to apply a gate voltage to the pull-up transistor 302, turning it on and allowing a current to flow from the input voltage source 153, 253 to the output terminal 306. After a defined pulse width, the inductor detector logic 314 can configure the control circuit 310 to turn off the pull-up transistor 302 and turn on the pull-down transistor 304, providing a discharge path from the output terminal 306 to the ground node 308.

In some examples, the inductor detector logic 314 outputs an LDO enable signal (identified as “LDOen” in FIG. 3) indicating that the inductor 316 is coupled to the output terminal 306 based on the inductor detection signals, thereby configuring (setting) the regulator 100, 200 to operate in the LDO mode of operation. In other examples, the inductor detector logic 314 outputs an LDO disable signal (identified as “LDOenz” in FIG. 3) indicating that the inductor 316 is not coupled to the output terminal 306 based on the inductor detection signals, thereby configuring the regulator 100, 200 to operate in the buck mode of operation.

The mode detector 300 allows for self-configuration of the regulator 100, 200 by automatically determining an appropriate operating mode based on an inductance present at the output terminal 306. For example, the mode detector 300 can distinguish between an intentional inductor (also referred to as an external inductor 316) or an inductance above a defined threshold (e.g., the threshold condition), and parasitic inductance, which is an inherent characteristic of a circuit (e.g., as shown in FIG. 3) and below the defined threshold. When the mode detector 300 detects the external inductor 316 (e.g., the threshold condition is satisfied), the mode detector 300 configures the regulator 100, 200 to operate in buck mode, utilizing the external inductor 316 (corresponding to the inductor 264 of FIGS. 2A-2B) to smooth switching voltages for high-efficiency power delivery. In other examples, when parasitic inductance is detected (e.g., the threshold condition is not satisfied) at the output terminal 306 corresponding to the external inductor 316 not being coupled to the output terminal 306, the mode detector 300 sets the regulator 100, 200 to LDO mode of operation, providing low-noise, ripple-free voltage regulation suitable for one or more sensitive components (e.g., one or more loads). This self-configuration capability eliminates a need for external control signals or manual reconfiguration, enhancing a regulator's flexibility and adaptability across diverse applications and varying load conditions.

By way of further examples, the inductor detector logic 314 can configure the voltage regulator 100, 200 to operate in the buck mode in response to determining that each voltage pulse in a sequence of pulses satisfies the threshold, based on inductor detection signals provided by the comparator. If the sequence of voltage pulses does not satisfy the threshold, with at least one inductor detection signal being at a logical low, the inductor detector logic 314 can initiate a retry process. This process involves applying a subsequent sequence of voltage pulses to the output terminal 306. The retry process can be repeated for a defined number of retry loops. If the maximum number of retry loops is reached and the last sequence of pulses still does not satisfy the threshold, the inductor detector logic 314 can set the voltage regulator 100, 200 to operate in the LDO mode. This occurs if at least one inductor detection signal for the final sequence remains at the logical low. Alternatively, if the maximum number of retry loops is reached and one or more voltage pulses in the last sequence satisfy the threshold, the inductor detector logic 314 can set the voltage regulator 100, 200 to operate in an error mode. This corresponds to at least one inductor detection signal for the final sequence being at the logical high.

FIG. 4 illustrates an example of a portion of a mode detector circuit 400 (for simplicity referred to herein as a mode detector 400). In some examples, the mode detector 400 corresponds to the mode detector 126 of FIG. 1, the mode detector 226 of FIGS. 2A-2B, or the mode detector 300 of FIG. 1. The mode detector 400 includes an inductor detector circuit 402 (corresponding to the inductor detector circuit 312 of FIG. 3) and inductor detector logic 435 (corresponding to the inductor detector logic 314 of FIG. 3). The inductor detector circuit 402 is configured to detect a voltage pulse at an output terminal 406 (corresponding to the output terminal 132 of FIG. 1, the output terminal 232 of FIG. 3 or the output terminal 306 of FIG. 3), which can be provided by a pull-up transistor 302 of FIG. 3 according to one or more examples, as described herein. A sequence of voltage pulses can be provided by the pull-up transistor 302 at the output terminal 406 according to the examples herein. By way of example the sequence of voltage pulses is three voltage pulses, but in other examples, the sequence of voltage pulses can include more or less voltage pulses. In some examples, if an external inductor, such as the inductor 316 of FIG. 3, is coupled to the output terminal 406, voltage pulses at the output terminal 406 can have a first pulse width. In other examples, such as when the external inductor is not coupled to the output terminal 406, the voltage pulses at the output terminal 406 can have a second pulse width. The first pulse width can be greater than the second pulse width. This is because the inductor 316 stores energy and delays a rate at which a voltage at the output terminal 406 decreases, thereby extending a duration that the voltage at the output terminal 406 is at a high voltage level.

The inductor detector circuit 402 can be configured to receive a driver supply voltage (identified as “VDD_DRV” in FIG. 4), which can be provided by a drive supply voltage source 403 (corresponding to the driver supply voltage source 199 of FIG. 1 or the driver supply voltage source 299 of FIGS. 2A-2B). An inductor detector circuit 402 includes a first resistor 404 and a second resistor 405. A first terminal of the first resistor 404 can be coupled to a positive terminal of the drive supply voltage source 403 and a second terminal of the first resistor 404 can be coupled to a first terminal of the second resistor 405. A second terminal of the second resistor 405 can be coupled to a ground 430 (in some instances the ground 156 of FIG. 1 or the ground 256 of FIGS. 2A-2B) and to a negative terminal of the drive supply voltage source 403. The inductor detector circuit 402 includes a comparator 410, which in some instances can be implemented as an amplifier.

The comparator 410 has a first input (e.g., an inverting input) and a second input (e.g., a non-inverting input). The first input of the comparator 410 can be coupled to a first internal node 443 to couple the first input of the comparator 410 to the second terminal of the first resistor 404 and to the first terminal of the second resistor 405. A first input comparator voltage (identified as “INM” in FIG. 4) can be established at the first internal node 443 based on a resistance of resistors 404-405 and the driver supply voltage. The first input comparator voltage can be a fraction of the driver supply voltage (e.g., 0.55*VDD_DRV). The first input comparator voltage can represent or correspond to a parasitic inductance baseline present at the output terminal 406. Thus, the first input comparator voltage can be referred to as a pseudo-inductive threshold.

The inductor detector circuit 402 includes a third resistor 407 (identified as “Rᵢₙₜ” in FIG. 4) and a capacitor 408 (identified as “Cᵢₙₜ” in FIG. 4). A first terminal of the third resistor 407 can be coupled to an output terminal 406. A first terminal of the capacitor 408 (e.g., a positive terminal or plate) can be coupled to a second terminal of the third resistor 407 and to the second input of the comparator 410. A second terminal of the capacitor 408 (e.g., a negative terminal or plate) can be coupled to the ground 430. A second input comparator voltage (also can be referred to as a filtered comparator input voltage (identified as “INPRC” in FIG. 4) can be established at a second internal node 444 to which the second terminal of the capacitor 408 can be coupled. The second input comparator voltage at the second internal node 444 can be provided based on a resistance of the third resistor 407 and a capacitance of the capacitor 408.

The third resistor 407 and the capacitor 408 can form an RC filter 438 that can be part of the inductor detector circuit 402 and thus can be referred to as an internal RC filter 438. In some examples, the second input comparator voltage is referred to as a filtered voltage pulse. The filtered voltage pulse provided by the RC filter 438 reflects an amount of inductance present at the output terminal 406. The internal RC filter 438 can correspond to the RC filter as described herein with respect to FIG. 3. The internal RC filter 438 can be coupled to the output terminal 406. The RC filter 438 can be sized to suppress a parasitic inductance spike. In some examples, the external LC filter 320, formed by the inductor 316 and the capacitor 318, of FIG. 3, and the internal RC filter 438 can be coupled to the output terminal 406 to form an impedance network. The internal RC filter 438 can have an internal impedance and the external LC filter 320 can have an external impedance. An inductance of the inductor 316 can be referred to as external inductance. In some examples, when the inductance of the external inductor is less than a maximum threshold value, the impedance of the external filter is less than the impedance of the internal filter, and the voltage at the second input of the comparator is lower than the voltage at the first input, the comparator 410 does not provide an inductor detection signal. This condition corresponds to the output of the comparator being at a low voltage level, such as approximately zero volts. In other examples, when the inductance of the external inductor is greater than a minimum threshold value, the impedance of the external filter is higher than the impedance of the internal filter, and the voltage at the second input of the comparator 410 is higher than the voltage at the first input, the comparator provides the inductor detection signal. This condition corresponds to the output of the comparator being at a high voltage level, indicating a logical high state.

The inductor detector logic 435 includes a pulse validation logic 452. The pulse validation logic 452 includes first, second, and third flip-flop circuits 416, 418, 419, which can be used to implement a three-bit array, or in other examples, the mode detector 400 may include a fourth flip-flop circuit, for implementing a four-bit array. The first, second, and third flip-flop circuits 416, 418, 419 can be implemented as D flip-flop circuits. An output of the comparator 410 can be coupled to a clock input (represented as a “>” in FIG. 4) of the first flip-flop circuit 416 to receive the inductor detection signal. A data input (identified as “D” in FIG. 4) of the first flip-flop circuit 416 can be coupled to an output of a first inverter 415 of the pulse validation logic 452, whose input can be coupled to an output (identified as “Q” in FIG. 4) of the first flip-flop circuit 416. A first voltage pulse status signal (identified as “ldet1” in FIG. 4) can be established at the output of the first flip-flop circuit 416. The first voltage pulse status signal reflects the status of the first detected pulse in the sequence of voltage pulses at the output terminal 406 that satisfy a threshold condition. For example, if a voltage pulse status signal is at a logical high level (“1”), this indicates that the voltage pulse applied at the output terminal 406 satisfied the threshold condition (e.g., the second input comparator voltage was equal to or greater than the first input comparator voltage). If the voltage pulse status signal is at a logical low level (“0”), this indicates that the voltage pulse applied at the output terminal 406 did not satisfy the threshold condition (e.g., the second input comparator voltage was less than the first input comparator voltage).

A complementary output (identified as “Q̅” in FIG. 4) of the first flip-flop circuit 416 can be coupled to a clock input of the second flip-flop circuit 418. A data input (identified as “D” in FIG. 4) of the second flip-flop circuit 418 can be coupled to an output of a second inverter 417 of the pulse validation logic 452, whose input can be coupled to an output (identified as “Q” in FIG. 4) of the second flip-flop circuit 418. A second voltage pulse status signal (identified as “ldet2” in FIG. 4) can be established at the output of the second flip-flop circuit 418. The second voltage pulse status signal reflects the status of the second detected pulse in the sequence of voltage pulses at the output terminal 406 satisfying the threshold condition. A complementary output (identified as “Q̅” in FIG. 4) of the second flip-flop circuit 416 can be coupled to a clock input of the third flip-flop circuit 419. A data input (identified as “D” in FIG. 4) of the third flip-flop circuit 419 can be coupled to a low voltage level (identified as “TIEHI” in FIG. 4) and thus can be coupled to ground.

Each of the first, second, and third flip-flop circuits 416, 418, 419 includes clear inputs to receive a clear signal (identified as “clr” in FIG. 4). The clear signal causes the outputs of the first, second, and third flip-flop circuits 416, 418, 419 to enter a predefined state, such as a logical low state (e.g., “0”), and respective complementary outputs to enter a logical high state (e.g., “1”). A third voltage pulse status signal (identified as “ldet3” in FIG. 4) can be established at the output of the third flip-flop circuit 419, reflecting the status of the third detected pulse in the sequence of voltage pulses at the output terminal 406 satisfying the threshold condition.

In some examples, the inductor detector logic 435 further includes pulse detection and reset logic 450. The pulse detection and reset logic 450 can include a detection logic reset circuit 413. The detection logic reset circuit 413 can provide at an output the clear signal based on an output from a voltage pulse index counter 411 of the pulse detection and reset logic 450. The detection logic reset circuit 413 can be implemented as an edge-detection circuit. The voltage pulse index counter 411 can be implemented as a divide-by-4 circuit. An output of the voltage pulse index counter 411 can be coupled to an input of the detection logic reset circuit 413. The voltage pulse index counter 411 can track a number of detected voltage pulses at the output terminal 406, incrementing a count value with each pulse detected by the first index pulse generator 412. When a count value of the voltage pulse index counter 411 reaches a predefined maximum count (e.g., three pulses, four pulses, etc.), the voltage pulse index counter 411 can trigger the detection logic reset circuit 413 to provide the clear signal, resetting the detection logic. This reset allows the mode detector 400 to process subsequent sequences of voltage pulses.

In yet further examples, the inductor detector logic 435 includes retry decision logic 454, which includes a retry loop counter 424. The retry loop counter 424 can be implemented as a divide-by-4 circuit to track a number of retry loops when an applied sequence of voltage pulses at the output terminal 406 fails to satisfy the threshold condition. The retry loop counter 424 increments a count value upon receiving retry pulse signals from a second index pulse generator 422. When the count value of the retry loop counter 424 reaches a maximum count value, the retry loop counter 424 outputs a maximum retry signal (identified as “RETRY_MAX” in FIG. 4) to a fourth flip-flop circuit 425. This signal indicates that a maximum retry limit has been reached. Inputs to the retry loop counter 424 include outputs from the detection logic reset circuit 413 and the second index pulse generator 422.

The retry decision logic 454 also includes the fourth flip-flop circuit 425, implemented as a D flip-flop circuit. A data input (identified as “D” in FIG. 4) of the fourth flip-flop circuit 425 can be coupled to a ground (identified as “TIEHI” in FIG. 4), which can correspond to the ground 156 of FIG. 1 or the ground 256 of FIGS. 2A-2B. The clock input of the fourth flip-flop circuit 425 can be coupled to the output of the retry loop counter 424 to receive the maximum retry signal. In response to receiving the maximum retry signal, the fourth flip-flop circuit 425 outputs an end retry loop signal (identified as “RETRY_END” in FIG. 4). This signal is sent to the first input of an AND gate 427, as shown in FIG. 4. The second input of the AND gate 427 can be coupled to an output of the first NOR gate 426, which processes the first and second voltage pulse status signals. The first NOR gate 426 outputs a logical high signal (“1”) when both the first and second voltage pulse status signals are at a logical low level (“0”). The AND gate 427 outputs a retry completion signal at an output when inputs to the AND gate 427 are at a logical high level (“1”), indicating that the retry attempts have been exhausted and the sequence of voltage pulses has failed to satisfy the threshold condition. The retry completion signal can be provided to the second NOR gate 428 of the mode selection logic 456.

In some examples, the second NOR gate 428 receives two inputs: the retry completion signal from the AND gate 427 and the validation signal (identified as “LDET” in FIG. 4) from the first buffer 420. The validation signal represents whether the third voltage pulse of the sequence has satisfied the threshold condition. If both the retry completion signal and the validation signal are at a logical high level (“1”), the second NOR gate 428 does not provide a signal (corresponding to a logical low signal (“0”)). This logical low at an output of the second NOR gate 428 indicates that the voltage pulse sequence (e.g., all voltage pulses of the sequence) has failed to satisfy the threshold condition. By coordinating the retry completion signal and the validation signal, the second NOR gate 428 allows for a proper mode of operation to be determined based on the sequence of voltage pulses and retry loop logic. The output of the second NOR gate 428 is coupled to an input of a second buffer 429, which can provide a mode detected signal (identified as “mode_det” in FIG. 4).

The mode detector 400 can include output decision logic 440. The output decision logic 440 can receive the mode detected signal and the first, second and third first voltage pulse status signals. The output decision logic 440 can output an LDO enable signal (identified as “LDOen” in FIG. 4) based on an evaluation of the mode detected signal and a status of the voltage pulse signals. For example, if the mode detected signal indicates that the voltage pulse sequence has failed to satisfy the threshold condition, and the first, second, and third voltage pulse status signals indicate that none of the voltage pulses of the sequence of voltage pulses satisfied the threshold condition (criteria), the output decision logic 440 provides the LDO enable signal to configure (set) the regulator to operate in the LDO mode operation. In other examples, if the voltage pulse status signals and the mode detected signal indicates a valid sequence (e.g., the mode detected signal is at a logical low level), the output decision logic 440 can output an LDO disable signal (identified as “LDOenz” in FIG. 4). In some examples, if all voltage pulse status signals remain invalid (logical low) after a maximum retry attempts have been exhausted, the output decision logic 440 can provide an error signal (identified as “ERROR” in FIG. 4) to indicate that neither buck mode nor LDO mode can be properly determined. The regulator 100, 200 can enter an error mode of operation in response to the error signal. The regulator 100, 200 is referred to as being an error mode of operation when the output decision logic 440 outputs the error signal as neither the LDO enable or disable signal are provided in a logical high level (“1”).

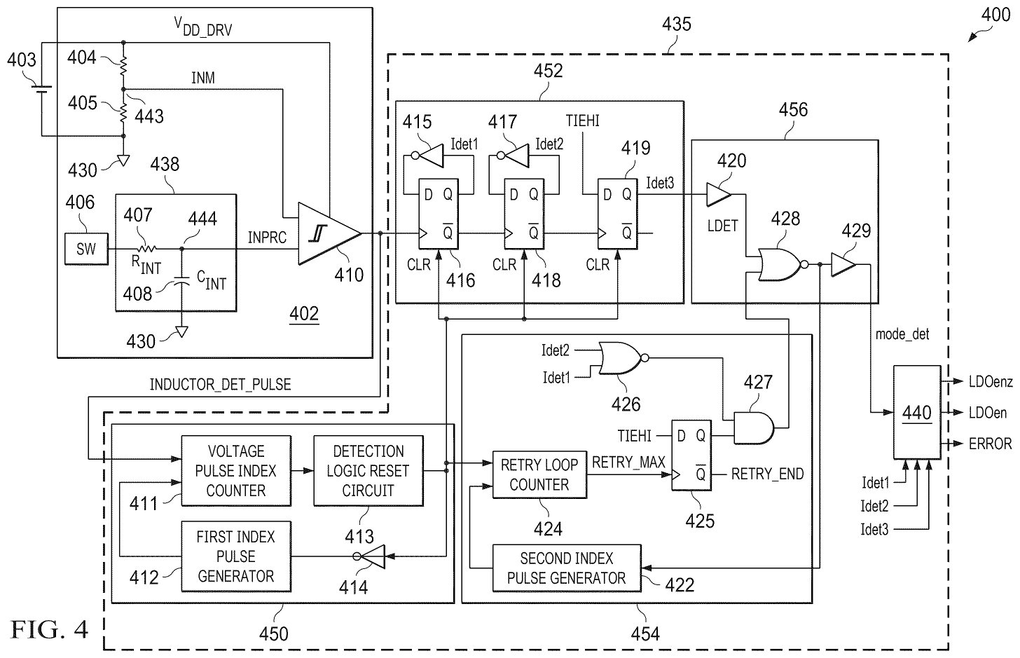

FIG. 5 illustrates an example of a method 500 for setting an operating mode of a regulator, such as the regulator 100 of FIG. 1 or the regulator 200 of FIGS. 2A-2B. The method 500 can be implemented by the mode detector 126 of FIG. 1, the mode detector 126 of FIGS. 2A-2B, the mode detector 300 of FIG. 3 or the mode detector 400 of FIG. 4. In some examples, one or more steps (or blocks) of the method 500 can be implemented by the inductor detector logic 314 of FIG. 3 or the inductor detector logic 435 of FIG. 4. The method 500 can begin at block 502 (identified as “START” in FIG. 5), for example, in response to the mode detector 126, 226, 300, or 400 being enabled (e.g., powered on). Thus, at block 502, the regulator 100, 200 can operate in an inductor detection mode. At block 504, a voltage pulse index counter (k) (corresponding to the voltage pulse index counter 411 of FIG. 4), and a retry loop counter (m) (corresponding to the retry loop counter 424 of FIG. 4) can be initialized to set respective count values to zero. The voltage pulse index counter can track a number of voltage pulses of a sequence of voltage pulses that have been applied at an output terminal, such as one of the output terminals 132, 232, 306 and 406. The retry loop counter can track a number of retry loops performed when an initial sequence of voltage pulses does not satisfy a threshold condition for determining a mode of operation for the regulator 100, 200, as described herein.

In some examples, at block 504 a detection array, which, by way of non-limiting example, can be a 4-bit array (ldet <3:0>) can be initialized and respective bit values can be set to zero. In some examples, the detection array can be implemented using a set of flip-flop circuits, which can include the flip-flop circuits 416, 418, 419 of FIG. 4. A value of “0” for a bit in the detection array indicates a filtered voltage pulse was less than or equal to a pseudo-inductive threshold, while a value of “1” indicates that the filtered voltage pulse was greater than or equal to the pseudo-inductive threshold. Each bit of the detection array can indicate whether a given voltage pulse of the sequence of voltage pulses was greater than or equal to the pseudo-inductive threshold. For example, if the detection array is the 4-bit array, ldet<1> (a first bit) can indicate a pseudo-inductive threshold comparison status of a first voltage pulse of the sequence of voltage pulses, ldet<2> (a second bit) can indicate a pseudo-inductive threshold detection status of a second voltage pulse of the sequence of voltage pulses, ldet<3> (a third bit) can indicate a pseudo-inductive threshold detection status of a third voltage pulse of the sequence of voltage pulses, and ldet<4> (a fourth bit) can indicate a pseudo-inductive threshold detection status of a fourth voltage pulse of the sequence of voltage pulses. In yet further examples, at block 504, a mode detected signal (corresponding to the mode detected signal of FIG. 4) can be set to a logical high state (“1”), which is a default state. The mode detected signal can be used as a status indicator to represent whether a voltage pulse detection process has been completed for the regulator 100, 200.

At block 506, the voltage pulse detection process is initialized (started) by turning on the pull-up transistor 302 of FIG. 3 to provide a first voltage pulse of the sequence of voltage pulses at the output terminal 132, 232, 306 or 406 and the inductor detector circuit 312 is turned on to detect the first voltage pulse at the output terminal 406. As described herein, the control circuit 310 can be used to turn on the pull-up transistor 302. In examples herein, the sequence of voltage pulses includes four voltage pulses, however, in other examples, the sequence of voltages pulses can include more or less than four voltage pulses. The pull-up transistor 302 and the inductor detector circuit 312 can be turned on for a defined period of time, for instance, 100 nanoseconds (ns), as a non-limiting example. Thus, in some examples, the first voltage pulse can have a pulse width of about 100 ns. At block 508, the first voltage pulse at the output terminal 306, 406 can be filtered by the internal RC filter 438 of FIG. 4 to provide a first filtered voltage pulse (corresponding to the second input comparator voltage, identified as “INPRC” in FIG. 4).

At block 510, a determination can be made whether the first filtered voltage pulse is greater than or equal to the pseudo-inductive threshold (corresponding to the first input comparator voltage, identified as “INM” in FIG. 4). In some examples, the method 500 can proceed from block 510 to block 512 in response to determining that the first filtered voltage pulse is less than the pseudo-inductive threshold (identified as “no” in FIG. 5), indicating that the first filtered voltage pulse is below the pseudo-inductive threshold. At block 512, the first bit of the detection array is set to 0 to indicate that the first voltage pulse did not meet a threshold condition corresponding to the first filtered voltage pulse being less than the pseudo-inductive threshold, and the method 500 proceeds from block 512 to block 516.

In other examples, the method 500 can proceed from block 510 to block 514 in response to determining that the first filtered voltage pulse is greater than the pseudo-inductive threshold (identified as “yes” in FIG. 5). At block 514, the first bit of the detection array is set to 1 to indicate that the first voltage pulse satisfied the threshold condition, and the method 500 proceeds from block 514 to block 516. At block 516, the voltage pulse index counter can be incremented by one to indicate a completion of processing one voltage pulse in the sequence of voltage pulses.

At block 518, the pull-up transistor 302 of FIG. 3 is turned-off (e.g., after 100 ns). In some examples, at block 518, the pull-down transistor 304 is turned by the control circuit 310 to provide an electrical path from the output terminal 132, 232, 306 or 406 to the ground node (or terminal) 156, 256, 308, or 430 to curtail (reduce) a voltage at the output terminal 132, 232, 306 or 406 to a lower voltage level, such as about 0V. The method 500 proceeds from block 518 to block 520. At block 520, a determination is made whether the voltage pulse index counter has reached a maximum counter value (or a total number of voltage pulses in the sequence of voltage pulses). Thus, at block 520, in some instances, the method 500 can include determining whether a current count value of the voltage pulse index counter is equal to a total number of voltage pulses in the sequence of voltage pulses.

In some examples, the current count value of the voltage pulse index counter does not equal a maximum counter value (identified as “no” in FIG. 5) and the method 500 can proceed (loop back) from block 520 to block 522 to process a next voltage pulse in the sequence of voltage pulses in a same or similar manner as the first voltage pulse, as described herein. In other examples, the current count value of the voltage pulse index counter does equal the maximum counter value and the method 500 can proceed from block 520 back to block 518 (identified as “yes” in FIG. 5). The voltage pulse detection process is completed in response to determining that the current count value of the voltage pulse index counter is equal to the maximum counter value.

At block 522, the method 500 includes determining whether bits of the detection array have a bit value of “1”. For example, if the sequence of voltage pulses corresponds to four voltage pulses, at block 522, each of the bits of the detection array can be checked to determine if each of the bits of the detection are “1”. In some examples, the method 500 proceeds from block 522 to block 524 in response to determining (identified as “yes” in FIG. 5) that bits of the detection array have a bit value of “1”. At block 524, the regulator 100, 200 can be configured (set) to operate in the buck mode of operation in response to the bits in the detection array having a bit value of “1”. For example, at block 524, the mode detection signal can be in the logical low state (“0”), indicating that the regulator 100, 200 is to operate in the buck mode of operation. In some examples, at block 524, the voltage pulse index counter and the retry loop counter can be stopped. In some examples, at block 524, the LDO disable signal (identified as “LDOenz” in FIGS. 1-2) can be outputted by the mode detector 126, 226, 300 or 400 at a logical high level (“1”) to configure the regulator 100, 200 to operate in the buck mode of operation. In some examples, the method 500 proceeds from block 524 to block 536. At block 536, the mode detector 126, 226, 300, or 400 is disabled, such as powered off (identified as “Stop” in FIG. 5).

In other examples, the method 500 proceeds from block 522 to block 526 in response to determining (identified as “yes” in FIG. 5) that the sequence of voltage pulses (e.g., all the voltage pulses of the sequence) did not satisfy the threshold condition corresponding to not all of the bits in the detection array having a bit value of “1”. At block 526, a current count value of the retry loop counter is checked (evaluated) to determine whether the current count value is equal to a maximum count value (a maximum number of retry loop count value).

The method 500 can proceed from block 526 back to block 528 in response to determining (identified as “no” in FIG. 5) that the current count value of the retry loop counter does not equal to the maximum number of retry loop count value. At block 528, a subsequent sequence of voltage pulses, which can be referred to as a second voltage pulse sequence, can be applied to the output terminal 132, 232, 306 or 406 and a subsequent voltage pulse detection process can be implemented according to one or more examples, as described herein. In some examples, at block 528, the subsequent voltage pulse detection process can be referred to as a retry loop process. Thus, the method 500 can loop back from block 528 back to block 506.

In some examples, the method 500 proceeds from block 526 to block 530 in response to determining (identified as “yes” in FIG. 5) that the current count value of the retry loop counter equals the maximum number of retry loop count value. At block 530, the bits of the detection array are checked (evaluated) to determine whether the bits have a bit value of “0”. The method 500 proceeds from block 532 to block 532 in response to determining (identified as “yes” in FIG. 5) that the bits of the detection array do not have a bit value “0” indicating that the threshold condition has not been satisfied.

At block 532, the regulator 100, 200 can be configured (set) to operate in the LDO mode of operation in response to determining that the sequence of voltage pulses did not satisfy the threshold condition. For example, at block 532, the mode detection signal can be in the logical high state, indicating that the regulator 100, 200 is to operate in the LDO mode of operation. In some examples, at block 532, the voltage pulse index counter and the retry loop counter can be stopped. In some examples, at block 532, the LDO enable signal (identified as “LDOen” in FIGS. 1-2) can be outputted by the mode detector 126, 226, 300 or 400 at a logical high level (“1”) to configure the regulator 100, 200 to operate in the LDO mode of operation. In some examples, the method 500 proceeds from block 532 to block 536. At block 536, the mode detector 126, 226, 300, or 400 is disabled.

In some examples, the method 500 proceeds from block 532 to block 534 in response to determining (identified as “no” in FIG. 5) that one or more bits of the detection array do not have a bit value of “0”. In examples in which the one or more bits of the detection array do not have the bit value of “0” this indicates a fault condition with respect to the regulator 100, 200. For example, at block 534, the mode detector 126, 226, 300 or 400 is configured to output an error signal (identified as “ERROR” in FIGS. 3-4) indicating that the regulator 100, 200 is in a fault mode corresponding to operating the regulator 100, 200 in a fault or error mode of operation. The error signal can be provided to a fault management system of a PMIC, where the error signal can be processed to determine an appropriate response. For example, the fault management system of the PMIC can trigger corrective actions, such as by alerting an external system (e.g., a microcontroller, a microprocessor, a host system, etc.) in response to receiving the error signal from the regulator 100, 200. In some examples, at block 534, the voltage pulse index counter and the retry loop counter can be stopped. In some examples, at block 534, the mode detector 126, 226, 300 or 400 does not output the LDO enable or disable signal corresponding to these signals being at a logical low level, which can correspond to the regulator 100, 200 operating in the error mode of operation. In some examples, the method 500 proceeds from block 534 to block 536. At block 536, the mode detector 126, 226, 300, or 400 is disabled.

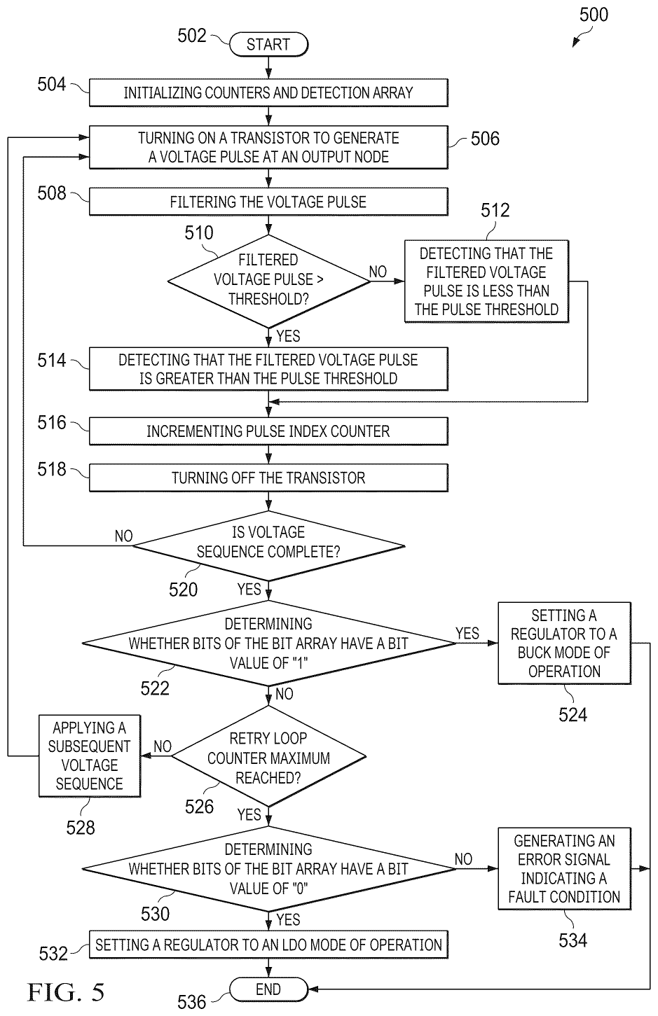

FIG. 6 illustrates an example of an inductor detector circuit 600 that can be used as an inductor detector circuit 312 of FIG. 3 or the inductor detector circuit 402 of FIG. 4. The inductor detector circuit 600 can be configured to detect a presence of an external inductor coupled to an output terminal 645, for example, when the regulator 100, 200 is operating in an inductor detection mode (e.g., in response to the regulator 100, 200 being powered). In some examples, the inductor detector circuit 600 can be referred to as a pre-biased inductor detector circuit 600 as this circuit can compensate for pre-bias conditions that can be present at the output terminal 645. Pre-bias refers to an initial voltage present on the output terminal 645, before active operation begins (e.g., determining whether an external inductor is coupled to the output terminal 645). The pre-bias voltage can arise from various sources, such as residual charge remaining on the output terminal 645 from previous operations, leakage currents from connected circuitry, or pre-charged external components such as capacitors coupled to the output terminal 645. High pre-bias conditions can cause instability during startup, increased power dissipation, or operational issues in the mode detector 126, 226, 300, 400. The inductor detector circuit 600 is configured to curtail pre-bias conditions within a startup time of a regulator, such as the regulator 100, 200 for proper operation of the regulator 100, 200 and minimize energy losses during a startup transition. The inductor detector circuit 600 can be configured to compensate for pre-bias conditions by generating controlled low-voltage pulses at the output terminal 645 during startup.

The inductor detector circuit 600 includes a first comparator 602, which can be implemented as an amplifier. The first comparator 602 can be referred to as a pre-bias the first comparator 602 in some instances. A first terminal (identified as “+” in FIG. 6) of the first comparator 602 can be coupled to the output terminal 645, which can correspond to the output terminal 132 of FIG. 1, the output terminal 232 of FIGS. 2A-2B, the output terminal 306 of FIG. 3, or the output terminal 406 of FIG. 4. An output terminal voltage can be provided at the output terminal 645 according to the examples described herein. A second terminal (identified as “−” in FIG. 6) of the first comparator 602 can be coupled to a reference voltage generator to receive a pre-bias reference voltage (identified as “V_{UVLO}” in FIG. 6). An output of the first comparator 602 can be coupled to an input of a logic circuit 613. The logic circuit 613 can be referred to as a pre-bias detection logic circuit. In some examples, the logic circuit 613 can be implemented as part of a mode comparator circuit, such as the mode detector 126 of FIG. 1, the mode detector 226 of FIGS. 2A-2B, the mode detector 300 of FIG. 3 or the mode detector 400 of FIG. 4. In yet other examples, the inductor detector circuit 600 includes the logic circuit 613.

The first comparator 602 compares the output terminal voltage to the pre-bias reference voltage to provide a pre-bias comparison voltage (or signal). The logic circuit 613 can evaluate the pre-bias comparison voltage to determine whether the output terminal voltage exceeds the pre-bias reference voltage, indicating a need for a corrective action. The logic circuit 613 uses the pre-bias comparison voltage to determine whether the output terminal voltage is greater than the pre-bias reference voltage. For example, if the pre-bias comparison voltage (a difference voltage) indicates that the output terminal voltage is greater than the pre-bias reference voltage, the logic circuit 613 provides a gate voltage (identified as “INDET_ON” in FIG. 6) to drive a gate of a first transistor 604 (identified as “MN_LS” in FIG. 6) of the inductor detector circuit 600 that can be coupled to the output terminal 645. A drain of the first transistor 604 can be coupled to the output terminal 645. A source of the first transistor 604 can be coupled to a ground 603 (e.g., the ground 156 of FIG. 1 or the ground 256 of FIGS. 2A-2B). A source of a second transistor 605 of the inductor detector circuit 600 can be coupled to the gate of the first transistor 604. A gate of the second transistor 605 can be coupled to the ground 603. For example, to create low-voltage pulses, the first transistor 604 is activated to create (generate) low voltage pulses at the output terminal 645. Instead of fully discharging the output terminal 645 to the ground 603, which would waste energy, the first transistor 604 can pull the output terminal 645 to ground or to a minimum possible voltage level. These low-voltage pulses can be used for detecting an inductive behavior at the output terminal 645 while preserving energy efficiency.

In some examples, a drain of the second transistor 605 can be coupled to a driver supply voltage source 638 (e.g., the driver supply voltage source 199 of FIG. 1 or the driver supply voltage source 299 of FIGS. 2A-2B) to receive a driver supply voltage (identified as “V_{DD_DRV}” in FIG. 6). The drain of the second transistor 605 can be coupled to a drain of a third transistor 606. To stabilize a bias condition voltage (identified as “V_{PCH}” in FIG. 6), the inductor detector circuit 600 includes the third transistor 606 configured as a source follower. The source follower allows the inductor detector circuit 600 to respond to voltage changes at the output terminal 645 while minimizing noise and preserving signal integrity. A gate of the third transistor 606 can receive a reference offset voltage (identified as “V_{ref}+Delta” in FIG. 6). A source of the third transistor 606 can be coupled to an internal node 648 to establish the pre-bias condition voltage. The third transistor 606 is used to stabilize the pre-bias condition voltage, such as during transient conditions by buffering and conditioning the voltage based on the reference offset voltage. The reference offset voltage can be provided based on a reference voltage (identified as “V_{ref}” in FIG. 6) and a delta voltage (identified as “DELTA” in FIG. 6). For example, a summing amplifier can be used to sum the reference voltage and the delta voltage to provide the reference offset voltage. The reference voltage can be provided by a reference voltage generator and the delta voltage can be provided by a delta voltage generator by way of example.

In some examples, the inductor detector circuit 600 can further include a first capacitor 607 (identified as “C_{HP}” in FIG. 6), a first resistor 608 (identified as “R_{HP}” in FIG. 6), a second capacitor 609 (identified as “C_{SMALL}” in FIG. 6), a second resistor 610 (identified as “R_{LP}” in FIG. 6), and a third capacitor 611 (identified as “C_{LP}” in FIG. 6). The first capacitor 607 and the first resistor 608 form a high-pass filter and process the low-voltage pulses generated at the output terminal 645. The high-pass filter removes a DC component from the output terminal voltage at the output terminal 645, thereby isolating transient responses that can be caused by the low-voltage pulses. The second resistor 610 and the third capacitor 611 form an RC filter (or a low-pass filter). The RC filter smooths a signal to produce a filtered comparator input voltage (“Inprc”), which can be provided at an internal node 650 of the inductor detector circuit 600. A first terminal of the first capacitor 607 can be coupled to the output terminal 645 and thus to the source of the second transistor 605 and the drain of the first transistor 604. A second terminal of the first capacitor 607 can be coupled to a first terminal of the first resistor 608, to a first terminal of the second resistor 610, and to a first terminal of the second capacitor 609. Thus, the second terminal of the first capacitor 607, the first terminal of the second capacitor 609, first terminal of the first resistor 608 and the first terminal of the first resistor 608 can be coupled to the internal node 648. A second terminal of the first resistor 608 can be coupled to the ground 603. A second terminal of the second capacitor 609 can be coupled to the ground 603. A second terminal of the second resistor 610 can be coupled to a first terminal of the third capacitor 611. A second terminal of the third capacitor 611 can be coupled to the ground 603.

The first and second capacitors 607 and 609 can be used as a capacitive divider to dynamically couple transient voltage changes from the output terminal 645 to the internal node 648. The capacitance of first capacitor 607 can be greater than that the capacitance of the second capacitor 609, allowing the capacitive divider to reflect a transient behavior of the output terminal 645, including negative voltage spikes caused by the inductive behavior of an external inductor coupled to the output terminal 645. These spikes can be expressed as

$$V = - L \times \frac{di}{dt}$$

and can be transiently coupled to the pre-bias condition voltage to enable the inductor detector circuit 600 to respond dynamically to changes at the output terminal 645.

The inductor detector circuit 600 further includes a second comparator 612, which can be implemented as an amplifier. A first terminal (identified as “+” in FIG. 6) of the second comparator 612 can be coupled to the reference voltage generator to receive the reference voltage. A second terminal (identified as “−” in FIG. 6) of the second comparator 612 can be coupled to the second terminal of the second resistor 610 and the first terminal of the third capacitor 611. The second terminal of the second resistor 610 and the first terminal of the third capacitor 611 can be coupled to the internal node 650. An output of the second comparator 612 can be coupled to inductor detector logic, such as the inductor detector logic 314 of FIG. 3.

As shown in FIG. 6, a filtered comparator input voltage (identified as “Inprc” in FIG. 6) can be generated at an internal node 650 of the inductor detector circuit 600. The filtered comparator input voltage can be provided to a second comparator 612, where the filtered comparator input voltage can be compared to the reference voltage. If the filtered comparator input voltage is greater than the reference voltage, the comparator toggles, signaling a condition that requires adjustment, such as resolving pre-bias or detection of a valid voltage pulse. The second comparator 612 can output an inductor detection signal (identified as “Inductor_det_pulse” in FIG. 4) in response to the filtered comparator input voltage being greater than the reference voltage and provided to inductor detector logic, such as the inductor detector logic 314 of FIG. 3 or the inductor detector logic 435 of FIG. 4.

As described herein, the inductor detector logic 314, 434 can process inductor detection signals to determine whether an external inductor is coupled to the output terminal 645 corresponding to setting (configuring) the regulator 100, 200 to operate in either a buck mode or LDO mode of operation. For example, the inductor detector logic 314, 434 can evaluate inductor detection signals to determine whether an external inductor is or is not coupled to the output terminal 645 to set an operating mode of the regulator 100, 200, as described herein.

FIG. 7A illustrates an example of a block diagram of a portion of a driver stage 700. In some examples, the driver stage 700 corresponds to the driver stage 116 of FIG. 1 or the driver stage 216 of FIGS. 2A-2B. The driver stage 700 includes a phase signal generator 701, which can correspond to the phase signal generator 107 of FIG. 1 or the phase signal generator 207 of FIGS. 2A-2B. The phase signal generator 701 includes a NOR gate 703, a first multiplexer 757, first inverter 704 and a second inverter 705. In yet some examples, the NOR gate 703 can be replaced with an inverter. A first input of the first multiplexer 757 can receive a high-side gate control signal (identified as “HSON” in FIG. 7A) corresponding to the high-side gate control signal of FIGS. 1-2. In some examples, the first multiplexer 757 can correspond to the clock selector 118 of FIG. 1 or the third multiplexer 218 of FIG. 2. Thus, in some examples, the high-side gate control signal can correspond to the first clock signal, as shown in FIGS. 1 and 2A-2B. The high-side gate control signal can set a boot voltage on a step-up voltage rail 755 during buck mode operation and can operate at any frequency, such as in the range of 2-4 MHz by way of non-limiting example. A second input of the first multiplexer 757 can receive a second clock signal (identified as “CLK_2” in FIG. 7A) corresponding to the second clock signal of FIGS. 1-2. For example, the second clock signal can be provided by the clock selector 118 of FIG. 1 or the third multiplexer 218 of FIGS. 2A-2B according to one or more examples, as described herein. A signal select input of the first multiplexer 757 is to receive an LDO enable signal (identified as “LDOen” in FIG. 7A) corresponding to the LDO enable signal of FIGS. 1-2.

For example, the first multiplexer 757 can receive the high-side gate control signal from the gate signal router 112 of FIG. 1 or the gate signal router 212 of FIGS. 2A-2B according to one or more examples, as described herein. The first multiplexer 757 can receive the high-side gate control signal during a buck mode of operation of the regulator 100 of FIG. 1 or the regulator 200 of FIGS. 2A-2B. During the buck mode of operation of the regulator 100, 200, the LDO enable signal is at a logical low level (“0”), and the first multiplexer 757 provides the high-side gate control signal to a first input of the NOR gate 703 (in other examples a first input of the inverter). In other examples, such as when the regulator 100, 200 is operating in the LDO mode of operation, the LDO enable signal is at a logical high level (“1”), and the first multiplexer 757 provides the second clock signal to the first input of the NOR gate 703.

A second input of the NOR gate 703 (in other examples a second input of the inverter) can be coupled to a logical low level (identified as “DFT=0” in FIG. 7A) during the LDO or buck mode of operation of the regulator 100, 200. For example, the second input of the NOR gate 703 can be at the logical low level during normal operation (e.g., the LDO and buck mode of operation), and at a logical high level, for example, during a debugging operation of the regulator 100, 200 (e.g., to test a circuit path). In some examples, the second input of the NOR gate 703 can be coupled to a ground (e.g., the ground 156 of FIG. 1 or the ground 256 of FIGS. 2A-2B). An output of the NOR gate 703 can be coupled to an input of the first inverter 704. The NOR gate 703 can apply a NOR logic operation based on voltages at first and second inputs to produce at an output an inverted high-side gate control signal (identified as “HSONZ” in FIG. 7A). The NOR gate 703 can provide the high-side gate control signal when the high-side gate control signal (or in other instances the second clock signal) is at a logical low level (“0”). The first inverter 704 can provide at an output a first high-side gate control signal (identified as “HGD1” in FIG. 7A) in response to receiving at an input the inverted high-side gate control signal. The second inverter 705 can receive the first high-side gate control signal at an input and provide at an output a first inverted high-side gate control signal (identified as “HGD1Z” in FIG. 7A).

The phase signal generator 701 further includes a second multiplexer 706. A first input of the second multiplexer 706 can receive a second phase signal (identified as “PH2” in FIG. 7A) and at a second input the second multiplexer 706 can receive the first inverted high-side gate control signal. In the buck mode of operation, the second multiplexer 706 provides (provides) the second phase signal at an output as a first phase signal (identified as “PH1” in FIG. 7A). In the LDO mode of operation, the second multiplexer 706 provides at an output the first inverted high-side gate control signal as the first phase signal in response to receiving the LDO enable signal at a clock select input, as shown in FIG. 7A. The first inverted high-side gate control signal can be provided to a third inverter 710 of the phase signal generator 701 to produce (provide) the second phase signal, which can be provided to the first input of the second multiplexer 706. The first and second phase signals of FIG. 7A can correspond to the first and second phase signals of FIGS. 1-2.

In the buck mode of operation, the second multiplexer 706 provides at its output the second phase signal to a first input of a step-up converter 702. The step-up converter 702 can correspond to the step-up converter 114 of FIG. 1 or the step-up converter 214 of FIGS. 2A-2B. The second phase signal output by the third inverter 710 can be provided to a second input of the step-up converter 702 during the buck mode of operation. Because the first phase signal is the first inverted high-side gate control signal and the second phase signal is a second inverted high-side gate control signal, the first and second phase signals provided to the step-up converter 702 are in phase during the buck mode of operation.

In the LDO mode of operation, the second multiplexer 706 provides the first inverted high-side gate control signal (identified as “HGD1Z” in FIG. 7A) as the first phase signal to the first input of the step-up converter 702. The second phase signal output by the third inverter 710 can be provided to the second input of the step-up converter 702 during the LDO mode of operation. Because the first phase signal is the first high-side gate control signal and the second phase signal is the second inverted high-side gate control signal, the first and second phase signals provided to the step-up converter 702 are out of phase during the LDO mode of operation.

In some examples, the driver stage 700 includes an inverted LDO signal generator 769 that can be used to produce an inverted LDO enable signal (identified as “LDOenz_Is” in FIG. 7B). The inverted LDO signal generator 769 includes a third multiplexer 707, a first level shifter 708 and a fourth inverter 709. In yet further examples, the phase signal generator 701 includes the inverted LDO signal generator 769 or the step-up converter 702 includes the inverted LDO signal generator 769. A first input of the third multiplexer 707 can receive the high-side gate control signal and a second input of the third multiplexer 707 can receive a driver supply voltage (identified as “VDD_DRV” in FIGS. 2A-2B), which can be provided by the driver supply voltage source 199 of FIG. 1 or the driver supply voltage source 299 of FIGS. 2A-2B. The third multiplexer 707 provides the driver supply voltage at an output in response to receiving at a signal select input the LDO enable signal, such as during the LDO mode of operation of the regulator 100, 200. The third multiplexer 707 provides the high-side gate control signal at an output when the LDO enable signal is at the logical low level, such as during the buck mode of operation of the regulator 100, 200.

For example, during the buck mode of operation of the regulator 100, 200, the third multiplexer 707 provides the high-side gate control signal to a first input of the first level shifter 708. In other examples, such as when the regulator 100, 200 operates in the LDO mode of operation, the third multiplexer 707 provides the driver supply voltage to the first input of the first level shifter 708. A second input of the first level shifter 708 can be coupled to a ground bus 756 and thus to a ground node 758 to couple the first level shifter 708 to a ground (e.g., the ground 156 of FIG. 1 or the ground 256 of FIGS. 2A-2B). A third input of the first level shifter 708 can receive the LDO enable signal, for example, when the regulator 100, 200 operates in the LDO mode of operation. A fourth input of the first level shifter 708 can receive the driver supply voltage and a fifth input of the first level shifter 708 can receive a boot voltage (identified as “V_{BOOT}” in FIG. 7A). The fifth input of the first level shifter 708 can be coupled to a step-up voltage rail 755 (corresponding to the step-up voltage rail 111 of FIG. 1 or the step-up voltage rail 211 of FIGS. 2A-2B). As described herein, the step-up converter 702 can provide the boot voltage on the step-up voltage rail 755.

In some examples, an output of the first level shifter 708 can be coupled to an input of the fourth inverter 709, which can receive a level shifted LDO enable signal and invert the level shifted LDO enable signal to provide the inverted level-shifted LDO enable signal at a logical high level (“1”), for example, during the LDO mode of operation of the regulator 100, 200. The first level shifter 708 can shift a voltage level of the LDO enable signal to a voltage level that is sufficient to cause a gate of transistors (e.g., transistors 728-729 of the step-up converter 702, as shown in FIG. 7B) to conduct.

Thus, in some examples, the inverted level-shifted LDO enable signal is a gate drive voltage. A power input of the fourth inverter 709 can receive the boot voltage for powering internal components of the fourth inverter 709 to provide the inverted level-shifted LDO enable signal with sufficient amplitude for driving corresponding transistors (e.g., the transistors 728-729 of FIG. 7B). A signal select input of the fourth inverter 709 can receive the driver supply voltage from the third multiplexer 707 to allow for inversion of the level-shifted LDO enable signal provided by the first level shifter 708, such as during the LDO mode of operation of the regulator 100, 200. Because the LDO enable signal is at a logical low level during the buck mode of operation, the first level shifter 708 does not output a signal and thus the fourth inverter 709 does not provide an inverted level-shifted signal corresponding to the level-shifted LDO enable signal being at a logical low level.

In some examples, the driver stage 700 further includes a fifth inverter 713. An input of the fifth inverter 713 can be coupled to the output of the third inverter 710 and thus can receive the second phase signal. The fifth inverter 713 can provide at an output an inverted second phase signal (identified as “PH2Z” in FIG. 7A), which can be provided to a first input of a fourth multiplexer 714. A second input of the fourth multiplexer 714 can be coupled to the ground (identified as “TIELO” in FIGS. 2A-2B). Thus, the second input of the fourth multiplexer 714 can be coupled to (or tied to) to the ground 156 of FIG. 1 or the ground 256 of FIGS. 2A-2B.

In some examples, the second input of the fourth multiplexer 714 can be coupled to a ground bus 756 and thus to the ground node 758, which can be coupled to the ground 156 of FIG. 1 or the ground 256 of FIGS. 2A-2B. An output of the fourth multiplexer 714 can be coupled to a gate of a lower high-side gate driver transistor 716. During the buck mode of operation, the fourth multiplexer 714 can drive the gate of the lower high-side gate driver transistor 716 with the inverted second phase signal. During the LDO mode of operation, the fourth multiplexer 714 couples the gate of the lower high-side gate driver transistor 716 to the second input of the fourth multiplexer 714 and thus the gate of the lower high-side gate driver transistor 716 is at about 0V corresponding to being turned-off.

As shown in FIG. 7A, a source of the lower high-side gate driver transistor 716 can be coupled to the ground bus 756. A drain of the lower high-side gate driver transistor 716 can be coupled to a high-side gate output terminal 717. The drain of the lower high-side gate driver transistor 716 can also be coupled to a drain of an upper high-side gate driver transistor 722. Thus, the drain of the upper high-side gate driver transistor 722 can also be coupled to the high-side gate output terminal 717. A source of the upper high-side gate driver transistor 722 can be coupled to the step-up voltage rail 755 to receive the boot voltage. The upper high-side gate driver transistor 722 can be a MOSFET pull-up transistor, whereas the lower high-side gate driver transistor 716 can be a MOSFET pull-down transistor. By way of example, the upper high-side gate driver transistor 722 can be a depletion-mode MOSFET (DEPMOS) and the lower high-side gate driver transistor 716 can be a dense enhancement-mode MOSFET (DENMOS). The lower high-side gate driver transistor 716 and the upper high-side gate driver transistor 722 can have a maximum gate-to-source voltage rating or operational voltage range of about 12V in some examples. Other ratings and/or ranges can be used in other examples.

By way of further example, the driver stage 700 can further include a fifth multiplexer 719 and a sixth multiplexer 720. The first inputs of each of the fifth and sixth multiplexers 719-720 can receive the high-side gate control signal, for example, when the regulator 100, 200 operates in the buck mode of operation. Second inputs of each of the fifth and sixth multiplexers 719-720 can receive the driver supply voltage, for example, when the regulator 100, 200 operates in the LDO mode of operation. The driver stage 700 includes a second level shifter 721. For example, a first input of the second level shifter 721 can be coupled to the ground bus 756. A second input of the second level shifter 721 can be coupled to an output of the fifth multiplexer 719 and a third input of the second level shifter 721 can be coupled to an output of the sixth multiplexer 720. A fourth input of the second level shifter 721 can receive the driver supply voltage. A fifth input of the second level shifter 721 can be coupled to the step-up voltage rail 755 and thus receives the boot voltage.

In some examples, an output of the second level shifter 721 can be coupled to a gate of the upper high-side gate driver transistor 722, as shown in FIG. 7A. The driver stage 700 further includes a buffer 715 and a capacitor 712. The buffer 715 can receive at an input the LDO enable signal at the logical high level, for example, when the regulator 100, 200 operates in the LDO mode of operation. An output of the buffer 715 can be coupled to a first terminal of the capacitor 718, which can be a negative terminal or negative plate. A second terminal of the capacitor 718, which can also be known as a positive terminal or positive plate, can be coupled to the output of the second level shifter 721 and the gate of the upper high-side gate driver transistor 722. In some examples, the step-up converter 702 can receive at a third input the driver supply voltage and at a fourth input the inverted level-shifted LDO enable signal. The step-up converter 702 can receive the inverted level-shifted LDO enable signal at a logical high level, for example, when the regulator 100, 200 is operating the LDO mode of operation. FIG. 7B is an example of the step-up converter 702, as shown in FIG. 7A. The step-up converter 702 can output the boot voltage (identified as “V_{BOOT}” in FIG. 7B) on the step-up voltage rail 755. For example, the step-up converter 702 can output the boot voltage on the step-up voltage rail 755 based on the driver supply voltage and in response to receiving first and second phase signals that are in phase, such as during the buck mode of operation of the regulator 100. The step-up converter 702 can be referred to as operating in a bootstrap mode to provide the boot voltage on the step-up voltage rail 755.

In other examples, the step-up converter 702 can output a charge pump voltage (identified as “V_{BOOT_CP}” in FIGS. 7A-7B) on the step-up voltage rail 755 based on the driver supply voltage and in response to receiving first and second phase signals that are out of phase, such as during the LDO mode of operation of the regulator 100. The step-up converter 702 can be referred to as operating in a charge pump mode to provide the charge pump voltage on the step-up voltage rail 755. In the bootstrap mode, the step-up converter 702 can provide the boot voltage as a boot switching voltage that switches between the driver supply voltage and a multiple of the driver supply voltage (e.g., two times the driver supply voltage) corresponding to the boot voltage. In the charge pump mode, the step-up converter 702 can provide the boot voltage that is a steady state voltage and is a multiple of the driver supply voltage (e.g., two times the driver supply voltage) corresponding to the charge pump voltage.

The first and second phase signals received by the step-up converter 702 for generating the first and charge pump voltages can be derived based on the second clock signal (identified as “CLK_2” in FIG. 7A), which has a fixed duty cycle and can operate in some instances at a frequency within a range from about 20 kHz to about 250 kHz. The fixed duty cycle of the second clock signal can determine (set) a timing of the first and second phase signals, enabling the step-up converter 702 to function as a charge pump by continuously charging and discharging the capacitors 739 and 723 in an alternating manner, such as described herein. This coordinated operation, based on the second clock signal, incrementally raises the voltage at the step-up voltage rail 755 to a steady-state level (e.g., about twice the driver supply voltage), thereby producing the charge pump voltage. The charge pump voltage provides a consistent voltage source to support the operation of the upper high-side gate driver transistor 722 during the LDO mode for providing a regulated LDO output voltage.

For example, the step-up converter 702 includes a transistor 732 (identified as “MP2” in FIG. 7B) and a transistor 736 (identified as “MP1” in FIG. 7B). A gate of the transistor 732 is to receive the first phase signal and a gate of the transistor 736 is to receive the second phase signal. Each of the sources of the transistors 732, 736 can be coupled to the driver supply voltage (identified as “VDD_DRV” in FIG. 7B). A drain of each of the transistors 732, 736 can be coupled to a source of one of transistors 733 and 737 of the step-up converter 702. The drain of the transistor 736 can be coupled to the source of the transistor 737 and the drain of the transistor 732 can be coupled to the source of the transistor 733. The transistors 733, 737 (identified as “MN1” and “MN2” respectively in FIG. 7B) can be 5V N-channel transistors. Thus, the transistors 733, 737 can have a voltage tolerance or operational rate of about 5V. The transistors 732, 733, 736 and/or 737 can define or be part of a switching network. The transistors 732, 733, 736 and 737 can be controlled by one of the first and second phase signals and the inverted LDO enable signal. The transistors 732, 733, 736 and 737 can alternately charge and discharge the capacitors 723 and 739, enabling the generation of the boot voltage in both the bootstrap and charge pump modes of operation of the step-up converter 702.

For example, a gate of each of the transistors 733, 737 can receive the driver supply voltage. A drain of the transistor 737 can be coupled to a drain of a transistor 730 (identified as “MPX1” in FIG. 7B), coupled to a source of a transistor 730 and further coupled to a first terminal of a first capacitor 739. A second terminal of the first capacitor 739 can be coupled to the driver stage 700 and thus can receive the first phase signal (identified as “PH1” in FIG. 7B) from the driver stage 700 (e.g., the second multiplexer 706 of FIG. 7A). The second terminal of the first capacitor 739 can also be coupled to a first input of a first multiplexer 725 and thus the first input of the first multiplexer 725 can be coupled to the driver stage 700 to receive the first phase signal. A second input of the first multiplexer 725 can receive the driver supply voltage.

A drain of the transistor 733 can be coupled to a drain of a transistor 731 (identified as “MPX2” in FIG. 7B), coupled to a source of a transistor 729 and further coupled to a first terminal of a second capacitor 723. A second terminal of the second capacitor 723 can be coupled to the driver stage 700 and thus can receive the second phase signal (identified as “PH2” in FIG. 7B) from the driver stage 700 (e.g., the output of the third inverter 710 of FIG. 7A) The second terminal of the second capacitor 723 can be further coupled to a first input of a second multiplexer 724 and thus the first input of the second multiplexer 724 can be coupled to the driver stage 700 to receive the second phase signal. A second input of the second multiplexer 724 can receive the driver supply voltage.

A source of each of the transistors 730-731 can be coupled to the step-up voltage rail 755. A gate of the transistor 730 can be coupled to a drain of the transistor 729 and further coupled to a drain of a transistor 727, whereas a gate of the transistor 731 can be coupled to a drain of the transistor 728 and further coupled to a drain of a transistor 726. Gates of the transistors 728-729 can be coupled to the driver stage 700 to receive inverted level-shifted LDO enable signal (identified as “LDOenz_Is” in FIG. 7B) at a logical high level (“1”), for example, during the LDO mode of operation of the regulator 100, 200, which can be provided according to one or more examples herein. Gates of the transistors 726-727 can receive the driver supply voltage. A source of the transistor 726 can be coupled to an output of the first multiplexer 725 and a source of the transistor 727 can be coupled to an output of the second multiplexer 724. The first multiplexer 725 can receive at a signal select input an LDO enable signal (identified as “LDOen” in FIG. 7B) at a logical high level (“1”). The second multiplexer 724 can also receive at a signal select input the LDO enable signal.

In some examples, the step-up converter 702 includes a pre-charge circuit 760, or can be coupled to the pre-charge circuit 760. The pre-charge circuit 760 can be coupled to the step-up voltage rail 755. The pre-charge circuit 760 includes a transistor 735. A drain of the transistor 735 can be coupled to the step-up voltage rail 755. A source of the transistor 735 can be coupled to an anode of a first diode 734 whose cathode can be coupled to the drain of the transistor 735 and thus to the step-up voltage rail 755. The source of the transistor 735 and the anode of the first diode 734 can be configured to receive the driver supply voltage. A gate of the transistor 735 can be coupled to a first terminal of a third capacitor 745 (identified as “CCHRG” in FIG. 7B), an anode of a second diode 747 and a first terminal of a first resistor 751. A second terminal of the first resistor 751 is coupled to a drain of the transistor 740. A second terminal of the third capacitor 745 can receive the first inverted high-side gate control signal (identified as “HGD1Z” in FIG. 7B) and thus in some examples can be coupled to the output of the second inverter 705 of FIG. 7A. A cathode of the second diode 747 can be coupled to an anode of a third diode 746 whose cathode can be coupled to an anode of a fourth diode 744. A cathode of the fourth diode 744 can be coupled to a first terminal of a second resistor 743.

In some examples, a second terminal of the second resistor 743 can be coupled to an input terminal 742 and thus receives the driver supply voltage. In some examples, the driver supply voltage can be a voltage in a range of about 2.5 to about 5.5V. As shown in FIG. 7B, a second terminal of the second resistor 738 can be coupled to a drain of a transistor 740 whose gate can be coupled to the step-up voltage rail 755. A source of the transistor 740 can be coupled to a source of the transistor 741. A gate of the transistor 741 can be coupled to the second terminal of the third capacitor 745 and thus can receive the first inverted high-side gate control signal. In some examples, the gate of the transistor 741 can be coupled to the output of the second inverter 705 of FIG. 7A.

For example, the step-up converter 702 provides the boot voltage during the buck mode of operation of the regulator 100, 200 based on the driver supply voltage and the first and second phase signals provided by the phase signal generator 701. The boot voltage, also can be referred to as a bootstrap voltage, alternates between driver supply voltage and a multiple of the driver supply voltage (e.g., two times the driver supply voltage) depending on the timing of the phase signals. Thus, in the buck mode of operation of the regulator 100, 200, the step-up converter 702 operates as a bootstrap circuit to provide a boot voltage to drive the upper high-side gate driver transistor 722 without relying on external boot supplies.

The boot voltage drives the upper high-side gate driver transistor 722 by establishing a voltage potential at the source of the upper high-side gate driver transistor 722, which can be coupled to the step-up voltage rail 755. The second level shifter 721 provides the high-side gate driver voltage to the gate of the upper high-side gate driver transistor 722. The combination of the boot voltage at the source and the high-side gate driver voltage at the gate of the upper high-side gate driver transistor 722 results in a gate-to-source voltage (VGS) to turn on the upper high-side gate driver transistor 722. When the upper high-side gate driver transistor 722 is turned on, the upper high-side gate driver transistor 72 functions as a pull-up transistor, coupling the high-side gate output terminal 717 to the step-up voltage rail 755, which raises the high-side gate voltage at the high-side gate output terminal 717 to a level sufficient to drive the high-side transistor (e.g., the high-side transistor 170, 270), enabling the high-side transistor to conduct and perform efficient switching in the buck mode. By alternately providing the boot voltage and ground potential through coordinated operation of the driver stage 700, the high-side transistor can be switched on and off as needed.

Accordingly, in the buck mode of operation, the high-side gate control signal acts as a natural high-side turn-on control signal, controlling a P-gate output driver (e.g., the upper high-side gate driver transistor 722). This control allows for a fixed gate-to-source voltage relative to driver supply voltage while switching an amplitude of the boot voltage between the driver supply voltage and about two times the driver supply voltage. This coordinated operation enables efficient regulation of the boot voltage, ensuring reliable switching of the upper high-side gate driver transistor 722.

By way of further example, during the buck mode of operation of the regulator 100, 200, the first capacitor 739 can receive the first phase signal at one terminal and the driver supply voltage at the other terminal via the transistor 730. Similarly, the second capacitor 723 can receive the second phase signal at one terminal and the driver supply voltage at the other terminal via the transistor 731. The first and second phase signals provided by the phase signal generator 701 are in phase during the buck mode of operation. The in-phase relationship of the first and second phase signals during the buck mode of operation synchronizes charge transfer cycles of the capacitors 739 and 723. This synchronization allows the first and second capacitors 723, 239 to periodically transfer together respective stored charges, doubling the driver supply voltage momentarily at the step-up voltage rail 755 to produce the boot voltage.

As the phase signals alternate, the first and second capacitors 723, 239 charge and discharge in synchronization with a timing of the first and second phase signals. When the first phase signal transitions to a high logical level, the first capacitor 739 charges to the driver supply voltage. Similarly, when the second phase signal transitions to a high logical level, the second capacitor 723 charges to the driver supply voltage. When the first and second phase signals are at low logic levels, the stored charges in the first and second capacitors 723, 739 can be transferred through the transistors 733 and 737, which are controlled by the driver supply voltage. This charge transfer raises the voltage at the step-up voltage rail 755, effectively doubling the driver supply voltage to produce the boot voltage. By alternating the charging and discharging cycles of the capacitors 739 and 723, the step-up converter 702 can provide a continuous supply of the boot voltage at the step-up voltage rail 755. The boot voltage can be supplied to the source of the upper high-side gate driver transistor 722, enabling operation of the upper high-side gate driver transistor 722 as a pull-up transistor during the buck mode of operation. The use of first and second capacitors 739 and 723 in this bootstrap configuration (mode) of the step-up converter 702 eliminates a need for external boot voltage sources, reducing system complexity and pin count in a PMIC design when compared to PMIC designs using an BLDO circuit.

In some examples, during the LDO mode of operation of the regulator 100, 200, the step-up converter 702 functions as a charge pump. The step-up converter 702 provides the charge pump voltage based on the driver supply voltage and the first and second phase signals provided by the phase signal generator 701. The charge pump voltage is a steady-state voltage that is a multiple of the driver supply voltage (e.g., two times the driver supply voltage).

As such, during the LDO mode of operation, the upper high-side gate driver transistor 722 remains turned off as a gate voltage (a high-side gate driver voltage (identified as “VG_{PU}” in FIG. 7A)) at the upper high-side gate driver transistor 722 is equal to the second boot voltage at the source of the upper high-side gate driver transistor 722. The buffer 715 outputs a signal based on the LDO enable signal at the logical high level during the LDO mode of operation, which can hold a voltage at the gate of the upper high-side gate driver transistor 722 to be at about the second boot voltage. This configuration, with the gate voltage matching the voltage at the source, turns off the upper high-side gate driver transistor during the LDO mode of operation of the regulator 100, 200.

For example, during the LDO mode of operation of the regulator 100, 200, the charge pump voltage drives the upper high-side gate driver transistor 722 by establishing a voltage potential at the source, which can be coupled to the step-up voltage rail 755. During the LDO mode, the phase signal generator 701 provides first and second phase signals that are out of phase to the step-up converter 702 for generating the charge pump voltage on the step-up voltage rail 755. An out-of-phase relationship of the first and second phase signals during the LDO mode of operation allows for a continuous charge and discharge cycle of the capacitors 739 and 723. This out-of-phase timing results in one capacitor charging, and another capacitor discharging a respective stored charge through the transistors 733 and 737. This coordinated behavior results in a steady-state voltage at the step-up voltage rail 755, effectively maintaining the charge pump voltage at a multiple of the driver supply voltage. The out-of-phase operation of the capacitors 739 and 723. enables the step-up converter 702 to function as a charge pump, establishing a consistent voltage at the source of the upper high-side gate driver transistor 722 during the LDO mode of the regulator 100, 200.

By way of example, during the LDO mode of operation, the first capacitor 739 can receive the first phase signal at one terminal and the driver supply voltage at the other terminal via the transistor 730. Similarly, the second capacitor 723 can receive the second phase signal at one terminal and the driver supply voltage at the other terminal via the transistor 731. The out-of-phase relationship of the first and second phase signals results in one capacitor charging while the other capacitor is discharging a stored charge through the transistors 733 and 737, which are controlled by the driver supply voltage. When the first phase signal transitions to a high logical level, the first capacitor 739 charges based on the driver supply voltage, storing energy. Likewise, when the second phase signal transitions to a high logical level, the second capacitor 723 charges to the driver supply voltage. During intervals when the phase signals are at low logical levels, the stored charges in the capacitors 739 and 723 are sequentially transferred through the transistors 733 and 737 to the step-up voltage rail 755. This charge transfer process incrementally raises a voltage at the step-up voltage rail 755 to a steady-state level of approximately twice the driver supply voltage. This steady-state voltage, referred to as the charge pump voltage, establishes a stable voltage at the source of the upper high-side gate driver transistor 722, enabling reliable operation of the high-side transistor (e.g., the high-side transistor 170, 270) during the LDO mode. By maintaining this consistent voltage, the step-up converter 702 functions as a charge pump, ensuring proper switching and efficient performance of the regulator 100, 200 during the LDO mode of operation of the regulator 100, 200.

Existing PMIC designs configured with a BLDO circuit rely on external boot supplies for driving one or more transistors in a driver output stage. This configuration results in increased pin counts on the PMIC and higher overall costs. In contrast, by integrating the step-up converter as described herein (the step-up converter 702) into a PMIC design eliminates dependence on external boot supplies by generating a boot voltage internally that supports the operation of the upper high-side gate driver transistor 722 in both modes, a buck and LDO mode.

For example, during the buck mode of operation, the upper high-side gate driver transistor 722 is configured to provide the high-side gate voltage (identified as “HSGATE” in FIG. 7A) at the high-side gate output terminal 717 for driving the high-side transistor, such as the high-side transistor 170 of FIG. 1 or the high-side transistor 270 of FIGS. 2A-2B. This can be achieved by using the boot voltage at the source of the upper high-side gate driver transistor 722 and a high-side gate driver voltage (identified as “VG_{PU}” in FIG. 7A) received at the gate of the upper high-side gate driver transistor 722. The high-side gate driver voltage can be provided by the second level shifter 721, which translates the driver supply voltage to an appropriate voltage level for driving the gate of the upper high-side gate driver transistor 722. The high-side gate voltage can correspond to the high-side gate voltage of FIGS. 1-2 (identified as “VG_{HS}” in FIGS. 1-2).

For example, the second level shifter 721 uses the boot voltage, the driver supply voltage, and the high-side gate control signal to produce the high-side gate driver voltage for proper switching performance of the upper high-side gate driver transistor 722 in the buck mode. The second level shifter 721 receives the high-side gate control signal from the fifth and sixth multiplexers 719-720, which select this signal during the buck mode of operation. The fifth and sixth multiplexers 719-720 can be controlled by the logical state of the LDO enable signal, which is at a logical low level (“0”) during the buck mode of operation of the regulator 100, 200. This logical low level results in the multiplexers 719-720 routing the high-side gate control signal to the second level shifter inputs.

The second level shifter 721 uses the driver supply voltage as a base input to establish a minimum operating voltage. The boot voltage, supplied via the step-up voltage rail 755, provides additional voltage for shifting the high-side gate control signal to a level sufficient to turn on the upper high-side gate driver transistor 722. The input of the buffer 715 is at a logical low level (e.g., at about 0V) as the LDO enable signal is at a logical low level, which results in the buffer 715 not actively driving its output, thereby preventing interference with the operation of the second level shifter 721 during the buck mode of operation. The capacitor 718, coupled between the output of the buffer 715 and the gate of the upper high-side gate driver transistor 722, can be used to stabilize the high-side gate driver voltage by filtering any transient signals and maintaining a steady voltage level during switching operations of the upper high-side gate driver transistor 722.

Accordingly, the upper high-side gate driver transistor 722 functions as a pull-up transistor by coupling the high-side gate output terminal 717 to the step-up voltage rail 755 when turned on. In this configuration, the boot voltage at the source of the upper high-side gate driver transistor 722 establishes a voltage potential for driving the high-side transistor 170, 270. The upper high-side gate driver transistor 722 can pull up the high-side gate voltage to an appropriate voltage level to enable efficient switching and operation of the high-side transistor 170, 270 during the buck mode. During the buck mode of operation of the regulator 100, 200, the lower high-side gate driver transistor 716 functions as a pull-down transistor. When turned on by a low-side gate driver voltage (identified as “VGPD” in FIG. 7A) received at the gate of the lower high-side gate driver transistor 716, the lower high-side gate driver transistor 716 couples the high-side gate output terminal 717 to the ground bus 756. This pull-down action drives the high-side gate voltage at the high-side gate output terminal 717 to a lower voltage level by providing a current path from the high-side gate output terminal 717 to the ground bus 756 so that the high-side transistor 170, 270 turns off.

In some examples, the low-side gate driver voltage can be provided by the fourth multiplexer 714. During the buck mode, the LDO enable signal is at a logical low level, which results in the fourth multiplexer 714 providing the inverted second phase signal to the gate of the lower high-side gate driver transistor 716 as the low-side gate driver voltage. The inverted second phase signal can be provided by the fifth inverter 713, which inverts the second phase signal output from the third inverter 710 of the phase signal generator 701. The complementary operation of the upper high-side gate driver transistor 722 and the lower high-side gate driver transistor 716 controls the high-side gate voltage at the high-side gate output terminal 717, alternating between the boot voltage for a high level and ground for a low voltage level. This alternating behavior allows for efficient switching and reliable operation of the high-side transistor 170, 270 in the buck mode through synchronized control of the high-side gate voltage.

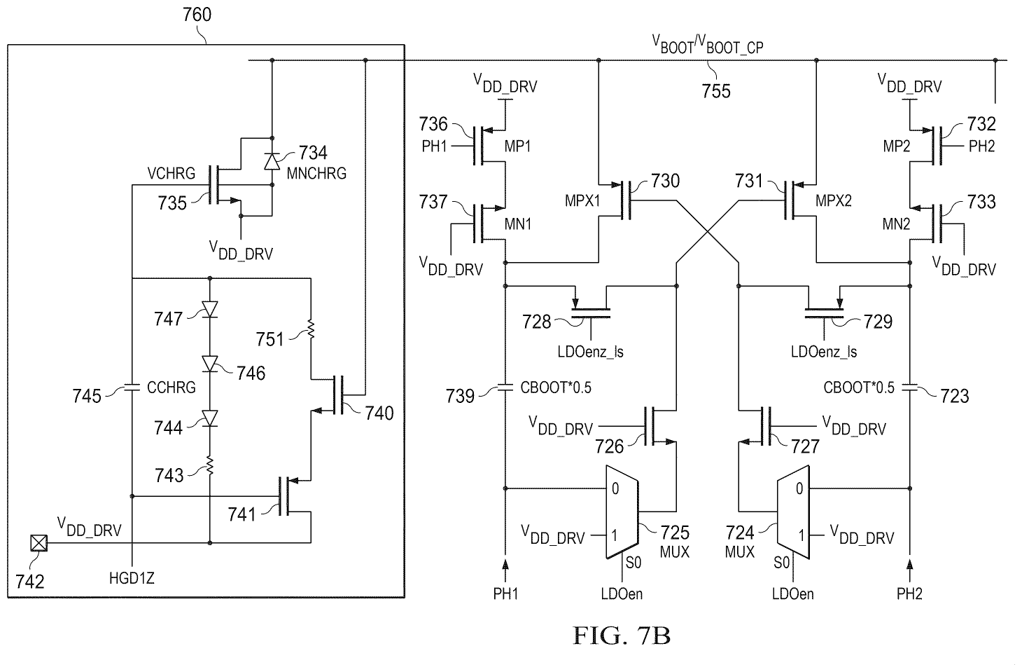

FIG. 8 illustrates an example of a level shifter 800. In some examples, the level shifter 800 can correspond to the level shifter 110 of FIG. 1, the level shifter 210 of FIGS. 2A-2B, the first level shifter 708 of FIG. 7A and/or the second level shifter 721 of FIG. 7A. The level shifter 800 translates an input voltage signal from a first voltage domain to a second voltage domain to provide a level shifted output voltage (identified as “out” in FIG. 8). The level shifter 800 provides the level shifted output voltage in a higher voltage domain at the same logical state as the input voltage signal from a lower voltage domain. For example, the level shifter 800 can translate an input voltage signal (identified as “in5v” in FIG. 8) from the voltage domain of a first supply voltage (identified as “VDD1” in FIG. 8) to the voltage domain of a second supply voltage (identified as “VDD2” in FIG. 8).

The level shifter 800 includes a transistor 802. A gate of the transistor 802 can receive the input voltage signal. The input voltage signal can be referred to as “inV” in FIG. 8. This input voltage signal can be supplied by a system supply voltage VSYS, which can range from about 2.5V to 5.5V, as provided by a VDD1/GND1 domain. The system supply voltage can be provided by a source, such as a battery (e.g., Li-ion battery), an automotive power source, or a regulated output from another power supply. In some configurations, a driver supply voltage source, which can be connected to one or more driver circuits, can be derived from system supply voltage or sub-regulated from this voltage. In other examples, the input voltage signal is at a different voltage level.

The input voltage signal can be provided to an inverter 804 to provide a complementary voltage or inverted input voltage signal to drive a gate of the transistor 807. A source of the transistor 802, 807 can be coupled to a first ground bus 828 (identified as “GND1” in FIG. 8). The transistors 802, 807 can be N-channel MOSFET transistors that operate based on the first supply voltage and thus the input voltage signal can be a 5V input signal in some examples. The level shifter 800 can include a transistor 803. A gate of the transistor 803 can receive the first supply voltage (identified as “VDD1” in FIG. 8). The first supply voltage can be provided to a gate of a transistor 806. A source of the transistor 806 can be coupled to a drain of the transistor 807. The transistors 803, 806 can be depletion-mode transistors that are configured to operate within the second voltage domain. A source of the transistor 803 can be coupled to a drain of the transistor 802. A source of the transistor 806 can be coupled to a drain of the transistor 807.

The level shifter 800 includes a transistor 810 (identified as “MP1” in FIG. 8), a transistor 812 (identified as “MP3” in FIG. 8), a transistor 813 (identified as “MP4” in FIG. 8) and a transistor 814 (indicated as “MP2” in FIG. 8). The level shifter 800 can further include transistors 808-809 (identified as “MN3” and “MN1” respectively in FIG. 8), transistors 816-817 (identified as “MN2” and “MN4” respectively in FIG. 8), and transistors 818-819 (identified as “MN5” and “MN6” respectively in FIG. 8). The transistors 810, 814, 818-819 can be P-channel MOSFET transistors that operate within a voltage domain supplied by a first voltage source. The transistor 808 can be an N-channel MOSFET transistor that operates within a voltage domain supplied by the first voltage source. The transistor 812 can be a depletion-mode transistor that operates within a voltage domain supplied by a second voltage source. A source of each of the transistors 810-814 can be coupled to an upper supply voltage rail 822 to receive a second supply voltage (identified as “VDD2” in FIG. 8).

For example, the second voltage domain can correspond to a level-shifted domain VBOOT or VBOOT_CP, as shown in FIG. 7A. The VDD2 voltage range can depend on a mode of operation of the regulator 100, 200. In LDO mode, V_{BOOT} can be held nearly constant at about 2×VDD_DRV via the step-up converter 702. Given that VDD_DRV ranges from 2.5V to 5.5V, VBOOT in LDO mode would range from 5.0V to 11V, with some ripple. In BUCK mode, VBOOT toggles between 2×VDD_DRV and 1×VDD_DRV. In such an example, VBOOT ranges from 2.5V to 11V. The VBOOT in BUCK mode can be a pulsed signal, whose value can be dependent on a HSON signal: when HSON=0, VBOOT=VDD_DRV; when HSON=1, VBOOT=2×VDD_DRV. In some examples, where VDD_DRV is not supplied by VSYS, in the LDO mode, VBOOT=VDD_DRV+VSYS, and in the buck mode, VBOOT=VDD_DRV when HSON=0, VBOOT=VDD_DRV+VSYS when HSON=1.

A drain of the transistor 810 can be coupled to a drain of the transistor 808 (identified as “MN3” in FIG. 8) and further coupled to a gate of the transistor 809. A source of the transistors 809-810 can be coupled to a second ground bus 826 (identified as “GND2” in FIG. 8). The first and second ground buses 826, 828 can be at different ground voltage potentials. A gate of the transistor 810 can be coupled to a gate of the transistor 812, which can be coupled to a first terminal of a first resistor 811 and a gate of the transistor 808. A second terminal of the first resistor 811 can be coupled to a drain of the transistor 809. A drain of the transistor 812 can be coupled to a drain of the transistor 803 and further coupled to a source of the transistor 818. The gate of the transistor 812 can be coupled to a source of the transistor 819 and to a gate of the transistor 819. A gate of the transistor 813 can be coupled to a drain of the transistor 818 and a gate of the transistor 818. The gates of the transistors 818-819 can be coupled to the second ground bus 826. A drain of the transistor 813 can be coupled to a source of the transistor 819 and further coupled to a drain of the transistor 806. The gate of the transistor 813 can be coupled to a gate of the transistor 814. The gate of the transistor 813 can be coupled to a first terminal of a second resistor 815 and further coupled to a gate of the transistor 817. A source of the transistors 816-817 can be coupled to the second ground bus 826. A second terminal of the second resistor 815 can be coupled to a drain of the transistor 816. A gate of the transistor 816 can be coupled to a drain of the transistor 814 and further coupled to a drain of the transistor 817.

The level shifter 800 can provide a level shifted output voltage (identified as “out” in FIG. 8) at an output terminal 830. For example, the level shifter can provide the level-shifted output voltage at the output terminal 830 by translating the input voltage signal from a lower voltage domain, such as 5V, to a higher voltage domain, such as 12V. The transistors 802 and 807, operating in a lower voltage domain, provide an intermediate voltage that can be coupled to the transistor 803 based on the input voltage signal. The transistor 803 can provide a continuous current path and establishes a connection between the lower and higher voltage domains, enabling the input voltage signal to transition from a lower voltage range to a higher voltage range. Similarly, transistor 806, with its source coupled to the drain of transistor 807, provides an additional controlled current path and, in coordination with transistor 812, facilitates a transfer of the input voltage signal. This transfer includes adapting a voltage level of the input voltage signal from the lower voltage domain to the higher voltage domain so that components operating in the higher voltage domain can correctly interpret and process this signal originating from the lower voltage domain.

In some examples, the higher voltage domain of the level shifter 800 can be powered by the upper supply voltage rail 822, which provides the second supply voltage (e.g., 12V). The transistors 810 and 814, along with transistors 809-810, form complementary signal paths that stabilize and amplify the input voltage signal during a signal transition from the lower voltage domain to the higher voltage domain. The first and second resistors 811, 815 can provide biasing for proper operation of transistors 810-814, allowing for stable signal amplification and maintaining signal integrity. Transistors 813 and 818-819 form part of an output stage of the level shifter 800, where transistor 813 can drive a voltage at the output terminal 830 towards the higher voltage domain by pulling the voltage at the output terminal 830 to the second supply voltage when the input voltage signal corresponds to a logical high state. Transistors 818-819, configured as pull-down circuit components, can be used to provide a current path to the second ground bus 826 so that the output voltage at the output terminal 830 transitions correctly between logical states.

In some examples, the level shifter 721 can be implemented as the level shifter 800. In such examples, the second supply voltage (VDD2) can correspond to the boot voltage (or charge pump voltage), the first supply voltage (VDD1) can correspond to the driver supply voltage, the first ground (GND1) can be coupled to the output of the sixth multiplexer 720, the second ground (GND2) can be coupled to the output of the fifth multiplexer 719, and the level shifted output voltage at output terminal 830 can correspond to the high-side gate driver voltage. In yet some examples, the level shifter 708 can be implemented as the level shifter 800. In such examples, the second supply voltage (VDD2) can correspond to the boot voltage (or charge pump voltage), the first ground (GND1) can be coupled to the output of the mode detector 126, 226, 300, 400 to receive the LDO enable, the second ground (GND2) can be coupled to the output of the third multiplexer 707, and the level shifted output voltage at output terminal 830 can correspond to the level shifted LDO enable signal and thus output terminal 830 can be coupled to the input of the fourth inverter 709. In yet further examples, the level shifter 110, 210 can be implemented as the level shifter 800. In such examples, the second supply voltage (VDD2) can correspond to the boot voltage (or charge pump voltage), the first supply voltage (VDD1) can correspond to the driver supply voltage, the first ground (GND1) can be coupled to the output of the error feedback circuit 106, 206 and thus to the compensation node 188, 288, the second ground (GND2) can be coupled to the ground 156, 256, and the level shifted output voltage at output terminal 830 can correspond to the high-side gate driver voltage.

FIG. 9 is an example of a voltage regulation system 900 that can be used to provide a regulated voltage (identified as “V_{OUT}” in FIG. 9) to a load 912 that is noise tolerant, which can be referred to as a non-noise sensitive load. In some examples, the voltage regulation system 900 can be implemented on a PCB of an electronic system, for example, as described herein, or other types of electronic systems. In some examples, the load 912 is implemented on the PCB, in yet other examples, the load 912 is implemented on a different PCB (or outside the PCB). Examples of the load can include, but not limited to, processors, memory modules, digital circuits, or other components that can tolerate switching noise. The voltage regulation system 900 includes a power management system 902, an output circuit 910, and a feedback circuit 914. In some examples, the power management system 902 is implemented as part of a PMIC. The power management system 902 includes a multi-mode voltage regulator 904 (referred to herein for simplicity as a regulator 904) that can operate in a buck mode, LDO mode, and, in some instances, an error mode according to one or more examples, as described herein. In some examples, the regulator 904 corresponds to the regulator 100 of FIG. 1 or the regulator 200 of FIGS. 2A-2B. In the example of FIG. 9, the regulator 904 is configured to operate in the buck mode of operation in response to a mode detector (e.g., the mode detector 126 of FIG. 1, the mode detector 226 of FIGS. 2A-2B, the mode detector 300 of FIG. 3 or the mode detector 400 of FIG. 4) of the regulator 904 determining (detecting) that an inductor 916 is coupled to an output terminal 906.

The power management system 902 includes the output terminal 906 (corresponding to the output terminal 132 of FIG. 1, the output terminal 232 of FIGS. 2A-2B, the output terminal 306 of FIG. 3 or the output terminal 406 of FIG. 4). An output of the regulator 904 can be coupled to the output terminal 906 (e.g., an output pin of the PMIC). The power management system 902 can be coupled to an input of the output circuit 910 whose output can be coupled to the load 912 and an input of the feedback circuit 914 (corresponding to the voltage scaling circuit 258 of FIGS. 2A-2B). The output circuit 910 includes the inductor 916 and a capacitor 918. A first terminal of the inductor 916 can be coupled to the output terminal 906 and a second terminal of the inductor 916 can be coupled to a first terminal of the capacitor 918. A second terminal of the capacitor 918 can be coupled to a ground 920 (corresponding to the ground 156 of FIG. 1 or the 256 of FIGS. 2A-2B).

In response to the regulator 904 being powered, the regulator 904 can detect (or determine) that the inductor 916 (an external inductor) is coupled to the output terminal 906 according to one or more examples, as described herein. In buck mode of operation, the regulator 904 provides the switching voltage at the output terminal 906. The inductor 916 and capacitor 918 form an LC filter (or circuit) and smooth the switching voltage to produce the regulated voltage at a load node 922 (corresponding to the load node 298 of FIG. 3) to which the load 912 can be coupled. The LC filter attenuates high-frequency noise and ripple introduced by a switching process implemented by the regulator 904 (as described herein), allowing the load 912 to operate efficiently and reliably under varying conditions. In the example of FIG. 9, the load 912 is a non-noise-sensitive load, by way of non-limiting example, a processor. The regulated voltage ensures that the processor receives stable power with minimal fluctuations, even under dynamic load conditions. The LC filter provides sufficient smoothing to prevent high-frequency noise or voltage ripple from affecting the performance of the load 912. The voltage regulation system 900 thus provides efficient and reliable power delivery tailored to the requirements of non-noise-sensitive applications.

In some examples, an input of the feedback circuit 914 can be coupled to an output of the output circuit 910 and thus to the second terminals of the inductor 916 and the capacitor 918. An output of the feedback circuit 914 can be coupled to an input node 908 of the power management system 902 (e.g., a pin of the PMIC) to which the regulator 904 can be coupled, as shown in FIG. 9, to receive the feedback output voltage. The feedback output voltage can be a scaled representation of the regulated voltage. The feedback circuit 914 can provide a feedback output voltage (identified as “V_{FB}” in FIG. 9), which can correspond to the feedback voltage as shown in FIGS. 1-2. The feedback output voltage can be provided based on the regulated voltage. The feedback output voltage can be used by the regulator 904 to adjust a duty cycle of the switching voltage. Adjusting the duty cycle of switching voltage enables the regulator 904 to control an amount of energy delivered to the output circuit 910, thereby tuning the switching voltage to provide the regulated voltage. For example, if the regulated voltage drops below a desired level due to increased load demand from the load 912, the duty cycle of switching voltage can be increased, providing more energy to the output circuit 910 and thus to the load 912.

FIG. 10 is an example of a voltage regulation system 1000 that can be used to provide a regulated LDO output voltage (identified as “V_{LDO}” in FIG. 10) as an output voltage (identified as “V_{OUT}” in FIG. 10) to a load 1012 that is sensitive to noise, in some instances, referred to as a noise sensitive load. In some examples, the voltage regulation system 1000 can be implemented on a PCB of an electronic system, for example, as described herein, or other types of electronic systems. In some examples, the load 1012 is implemented on the PCB, in yet other examples, the load 1012 is implemented on a different PCB (or outside the PCB). Examples of the load can include, but are not limited to, analog circuits, RF modules, sensors, or other components that are sensitive to switching noise and require a stable, low-noise voltage supply. The voltage regulation system 1000 includes a power management system 1002 and a feedback circuit 1014. In some examples, the power management system 1002 is implemented as part of a PMIC. The power management system 1002 includes a multi-mode voltage regulator 1004 (referred to herein for simplicity as a regulator 1004) that can operate in a buck mode, LDO mode, and, in some instances, an error mode according to one or more examples, as described herein. In some examples, the regulator 1004 corresponds to the regulator 100 of FIG. 1 or the regulator 200 of FIGS. 2A-2B. In the example of FIG. 10, the regulator 1004 is configured to operate in the LDO mode of operation in response to a mode detector (e.g., the mode detector 126 of FIG. 1, the mode detector 226 of FIGS. 2A-2B, the mode detector 300 of FIG. 3 or the mode detector 400 of FIG. 4) of the regulator 1004 determining (detecting) that an inductor 916 is coupled to an output terminal 906.

The power management system 1002 includes an output terminal 1006 (corresponding to the output terminal 132 of FIG. 1, the output terminal 232 of FIGS. 2A-2B, the output terminal 306 of FIG. 3 or the output terminal 406 of FIG. 4). An output of the regulator 1004 can be coupled to the output terminal 1006 (e.g., an output pin of the PMIC). The load 1012 can be coupled to the output terminal 1006. In some examples, an input of the feedback circuit 1014 can be coupled to the output terminal 1006. An output of the feedback circuit 1014 can be coupled to an input node 1008 of the power management system 1002 (e.g., a pin of the PMIC) to which the regulator 1004 can be coupled, as shown in FIG. 10, to receive the feedback output voltage. The feedback output voltage is a scaled representation of the regulated LDO output voltage. The feedback circuit 1014 can provide a feedback output voltage (identified as “V_{FB}” in FIG. 10), which can correspond to the feedback voltage as shown in FIGS. 1-2. The feedback output voltage can be provided based on the regulated LDO output voltage. The regulator 1004 can adjust an amount of current flowing into or through the output terminal 1006 to the load 1012 based on the feedback output voltage to provide a stable output voltage corresponding to the linear regulated voltage.

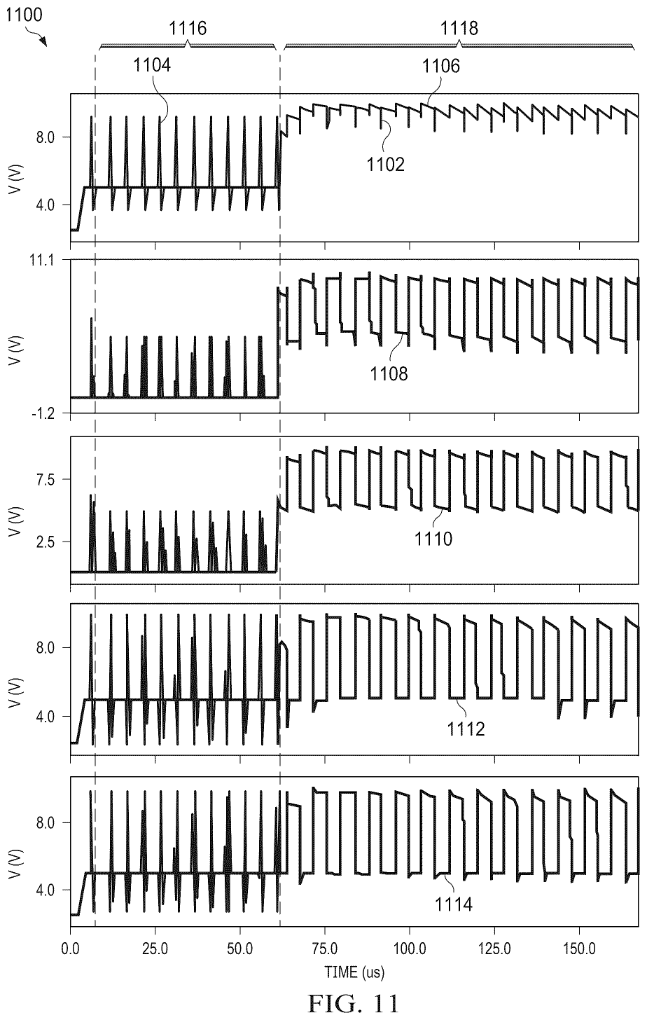

FIG. 11 illustrates an example of a waveform diagram 1100 relating to an operation of a step-up converter, such as the step-up converter 114 of FIG. 1, the step-up converter 214 of FIGS. 2A-2B, or the step-up converter 702 of FIGS. 7A-7B. An x-axis of the waveform diagram 1100 represents time in microseconds (μs) and a y-axis of the waveform diagram 1100 represents a voltage in volts (V). The waveform diagram 1100 includes a step-up converter voltage 1102 that can be generated by the step-up converter 114, 214, 702, which can correspond to the boot voltage, as shown in FIGS. 1-2 and 7A-7B. As shown in FIG. 11, the step-up converter 114, 214, 702 can be configured according to one or more examples herein to provide a boot voltage 1104 as the step-up converter voltage 1102 on a step-up voltage rail, such as the step-up voltage rail 111 of FIG. 1, the step-up voltage rail 211 of FIGS. 2A-2B or the step-up voltage rail 755 of FIGS. 7A-7B in a bootstrap mode of operation, and a charge pump voltage 1106 as the step-up converter voltage 1102 on the step-up voltage rail 111, 211, 755 in a charge pump mode of operation. The waveform diagram 1100 further includes a first phase signal 1108 (corresponding to the first phase signal of FIGS. 1-2 and 7A-B), a second phase signal 1110 (corresponding to the first phase signal of FIGS. 1-2 and 7A-B), which can be used to drive the step-up converter 114, 214, 702 during different mode of operation. Additionally, the waveform diagram 1100 includes a first capacitor voltage signal 1112 and a second capacitor voltage signal 1114, representing voltage potentials across respective first and second capacitors 723 and 739 of the step-up converter 114, 214, 702.

For example, during a first period of time 1116 the regulator 100, 200 is used in a buck mode of operation and thus an inductor is coupled to an output terminal (e.g., the output terminal 132 of FIG. 1, the output terminal 232 of FIGS. 2A-2B, the output terminal 306 of FIG. 3 or the output terminal 406 of FIG. 4). During the first period of time 1116, the step-up converter voltage 1102 is provided as the boot voltage 1104 corresponding to the step-up converter 114, 214, 702 operating in the bootstrap mode of operation. In the bootstrap mode, the step-up converter 114, 214, or 702 boosts a driver supply voltage (e.g., the driver supply voltage of FIGS. 1-2 and 7A-7B) to a level sufficient to drive the gate of the upper high-side gate driver transistor 722. The first and second phase signals 1108-1110 are in-phase during the first period of time 1116 and thus these signals transition between logical high and low states about at about the same time, as shown in FIG. 11. When the first and second phase signals 1108-1110 are in-phase, these signals reach a logical high state (“1”) and a logical low state (“0”) at about the same time. The logical high state during this period has a first voltage level (e.g., amplitude), which is greater than a second voltage level (e.g., amplitude) of the first and second phase signals 1108-1110 during a second period of time 1118 needed for rapid switching for the buck mode of operation of the regulator 100, 200. The in-phase signals 1108 and 1110 charge and discharge the corresponding first and second capacitors 723 and 739 during the first period of time 1116, thereby establishing the first capacitor voltage signal 1112 and the second capacitor voltage signal 1114, respectively, as shown in FIG. 11. During the first period of time 1116, a voltage amplitude of the first and second capacitor voltage signals 1114-1116 corresponds to a boosted driver supply voltage level (the charge pump voltage) provided by the step-up converter 114, 214, or 702. The voltage amplitude of the first and second capacitor voltage signals 1114-1116 is sufficient to support charging and discharging of the first and second capacitors 723 and 739, enabling efficient switching of the high-side gate driver transistor 722.

In other examples, during a second period of time 1118, the regulator 100, 200 operates in an LDO mode of operation, where no inductor is coupled to the output terminal 132, 232, 306, 406. In this period, the step-up converter voltage 1102 is provided as the charge pump voltage 1106, corresponding to the step-up converter 114, 214, 702 operating in the charge pump mode of operation. The step-up converter 114, 214, 702 boosts the driver supply voltage to a level suitable for providing a stable, low-noise output needed for LDO operation. During the second period of time 1118, the first and second phase signals 1108-1110 are out-of-phase and transition between logical high and low states alternately. When the first phase signal 1108 is in the logical high state (“1”), the second phase signal 1110 is in the logical low state (“0”), and vice versa, as shown in FIG. 11. The logical high state during this period has a second voltage level (e.g., amplitude), which is lower than the first voltage level used during the first period of time 1116. The out-of-phase signals 1108 and 1110 charge and discharge the corresponding first and second capacitors 723 and 739 in an alternating manner, thereby establishing the first capacitor voltage signal 1112 and the second capacitor voltage signal 1114, respectively. During this period, the voltage amplitude of the first and second capacitor voltage signals 1114-1116 corresponds to the lower driver supply voltage level provided by the step-up converter 114, 214, or 702.

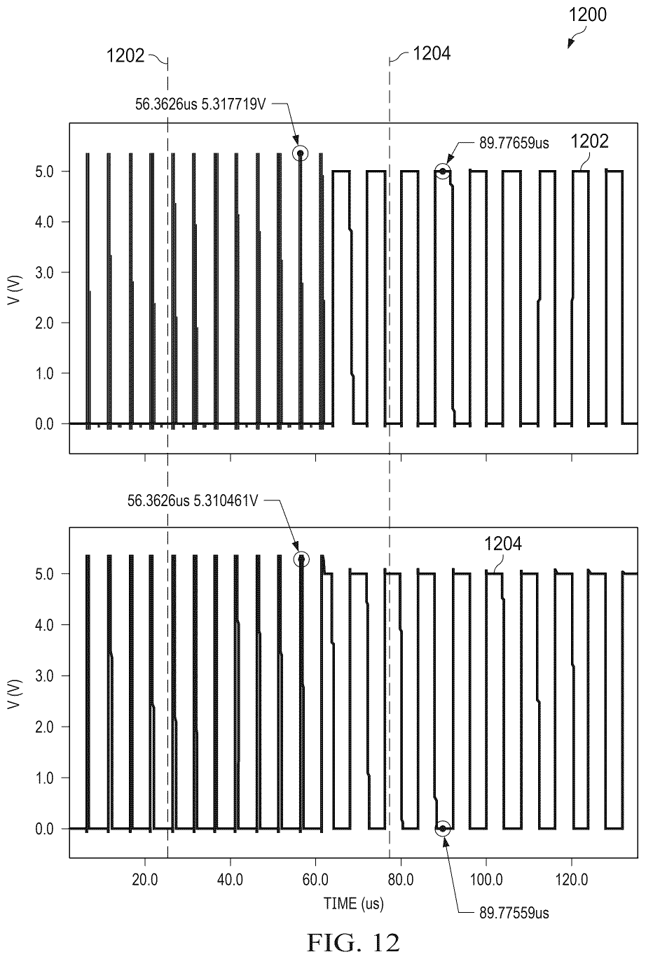

FIG. 12 an example of a waveform diagram 1200 relating to an operation of a phase signal generator 107 of FIG. 1, the phase signal generator 207 of FIGS. 2A-2B, or the phase signal generator 701 of FIG. 7A. An x-axis of the waveform diagram 1200 represents time in microseconds and a y-axis of the waveform diagram 1200 represents a voltage in volts. The waveform diagram 1200 includes a first phase signal 1202 and a second phase signal 1204 corresponding to the first and second phase signals of FIGS. 1-2, and 7A-7B. As described herein, the first and second phase signals 1202-1204 can be used by the step-up converter 114, 214, 702, which can function in either a bootstrap mode or a charge pump mode of operation. In the bootstrap mode of operation, the first and second phase signals are in phase, as shown at 1206 in FIG. 12. This synchronization ensures that both first and second capacitors 723, 739 in the step-up converter 114, 214, 702 charge and discharge about the same time. For example, when the first phase signal 1202 and the second phase signal 1204 transition to a high logical level simultaneously, these signals cause the first and second capacitors 723, 739 to charge based on a driver supply voltage (e.g., the driver supply voltage as shown in FIGS. 1-2 and 7A-7B).

When both phase signals transition to a low logical level, the stored charge in the capacitors 723, 239 can be transferred to a step-up voltage rail, such as the step-up voltage rail 111 of FIG. 1, the step-up voltage rail 211 of FIGS. 2A-2B, or the step-up voltage rail 755 of FIGS. 7A-7B. This coordinated charging and discharging raises a voltage at the step-up voltage rail 111, 211, 755 to double the driver supply voltage. The result is the generation of the boot voltage on the step-up voltage rail 111, 211, 755, which supports the operation of the high-side gate driver in a step-up configuration without requiring external boot supplies. In the charge pump mode of operation, the first and second phase signals are out of phase, as shown at 1204 in FIG. 12. This out-of-phase relationship indicates that while one phase signal is high, the other phase signal is low. This alternating behavior allows one capacitor (e.g., the second capacitor 723) to charge while the other capacitor (e.g., the first capacitor 739) discharges a stored charge through transistors of the step-up converter 114, 214, 702. The sequential charge transfer process incrementally increases the voltage at the step-up voltage rail 111, 211, 755, maintaining a steady-state voltage that is approximately twice the driver supply voltage. This steady-state voltage, known as the charge pump voltage.

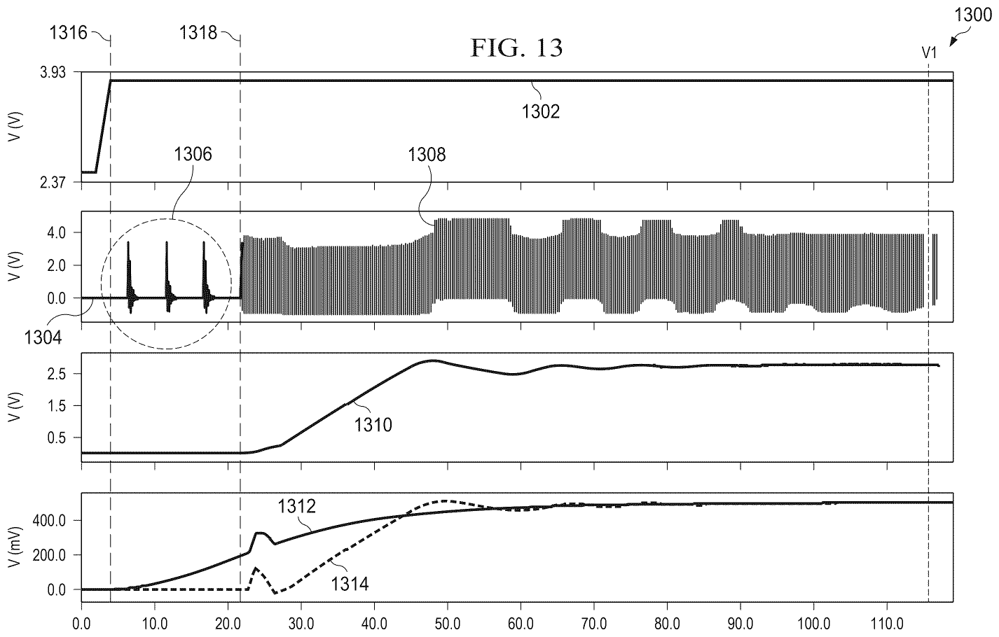

FIG. 13 illustrates an example of a waveform diagram 1300 relating to an operation of the regulator 100 of FIG. 1 or the regulator 200 of FIGS. 2A-2B in a buck mode of operation. An x-axis of the waveform diagram 1300 represents time in microseconds and a y-axis of the waveform diagram 1300 represents a voltage in volts. In the buck mode of operation, the regulator 100, 200 can provide a switching voltage, such as the switching voltage shown in FIGS. 1-2. The regulator 100, 200 can be configured to operate in the buck of operation in response to detecting that an inductor (e.g., the inductor 316 of FIG. 3) is coupled to an output terminal, such the output terminal 132 of FIG. 1, the output terminal 232 of FIGS. 2A-2B, the output terminal 306 of FIG. 3 or the output terminal 406 of FIG. 4.

The waveform diagram 1300 includes a driver supply voltage 1302 (corresponding to the driver supply voltage of FIGS. 1-2 and 7A-7B), which can be provided by a driver supply voltage source 199 of FIG. 1 or the driver supply voltage source 299 of FIGS. 2A-2B. The driver supply voltage 1302 can be used to power one or more components of the regulator 100, 200. At about a time 1316, after being powered, the mode detector 126 of FIG. 1, the mode detector 226 of FIGS. 2A-2B, the mode detector 300 of FIG. 3, or the mode detector 400 of FIG. 1 can set (configure) the regulator 100, 200 to operate in or enter a detection mode for setting a regulation mode of the regulator 100, 200 (e.g., to a buck mode or LDO mode).

The waveform diagram 1300 further includes an output terminal voltage 1304, which can be generated by the regulator 100, 200 at the output terminal 132, 232, 306, 406. The mode detector 126, 226, 300, 400 can generate a sequence of voltages pulses 1306 at the output terminal 132, 232, 306, 406 (as the output terminal voltage 1304) when the regulator 100, 200 is in the detection mode. The mode detector 126, 226, 300, 400 can determine that the inductor is coupled to the output terminal 132, 232, 306, 406 based on the output terminal voltage 1304 (the sequence of voltages pulses 1306). In response to detecting that the inductor is coupled to the output terminal 132, 232, 306, 406, the regulator 100, 200, at about a time 1318, is set to operate in the buck mode of operation.

The waveform diagram 1300 further includes a switching voltage 1308, a regulated voltage 1310, a mode reference voltage 1312 and a feedback output voltage 1314. The mode reference voltage 1312 can correspond to the mode reference voltage and the feedback output voltage can correspond to a feedback output voltage as shown in FIGS. 1-2. For example, at about a time 1318, the PWM controller 108, 208 is enabled during the buck mode of operation of the regulator 100, 200. In this mode, the PWM controller 108, 208 generates high-side and low-side gate control signals to alternately switch the high-side transistor 170, 270 and the low-side transistor 174, 274. This alternating conduction generates the switching voltage 1308, as shown in FIG. 13. The switching voltage 1308 at the output terminal 132, 232, 306, 406 can be filtered by the inductor and a capacitor (e.g., inductor 264 and capacitor 266) to smooth out high-frequency variations. This filtering process results in a regulated voltage 1310, as shown in FIG. 13, at the output terminal 132, 232, 306, 406, which is a stable DC voltage that can be provided to non-noise-sensitive loads, such as processors, memory modules etc. The feedback output voltage 1314 can be dynamically adjusted to match the mode reference voltage 1312, as shown in FIG. 13. This can be achieved through an error feedback circuit (e.g., the error feedback circuit 106 of FIG. 1 or the error feedback circuit 206 of FIGS. 2A-2B), which generates an error voltage based on the difference between these two feedback signals. By continually minimizing this difference, the regulator 100, 200 stabilizes the regulated voltage 1310 so that an amplitude of this voltage is within a specified or desired output voltage range.

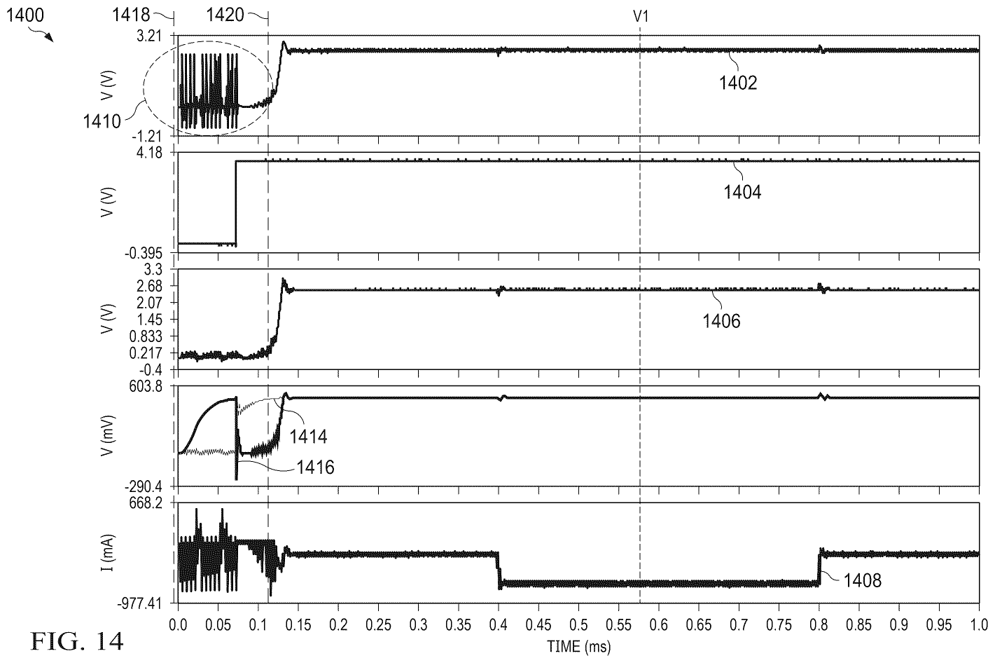

FIG. 14 illustrates an example of a waveform diagram 1400 relating to an operation of the regulator 100 of FIG. 1 or the regulator 200 of FIGS. 2A-2B in an LDO mode of operation. An x-axis of the waveform diagram 1400 represents time in microseconds and a y-axis of the waveform diagram 1400 represents a voltage in volts. In the LDO mode of operation, the regulator 100, 200 can provide a regulated LDO output voltage, such as the regulated LDO output voltage shown in FIGS. 1-2. The regulator 100, 200 can be configured to operate in the LDO mode of operation in response to detecting that an inductor (e.g., the inductor 316 of FIG. 3) is not coupled to an output terminal, such the output terminal 132 of FIG. 1, the output terminal 232 of FIG. 2, the output terminal 306 of FIG. 3 or the output terminal 406 of FIG. 4.

The waveform diagram 1400 further includes an output terminal voltage 1402, which can be generated by the regulator 100, 200 at the output terminal 132, 232, 306, 406. At about a time 1418, after being powered, the mode detector 126 of FIG. 1, the mode detector 226 of FIGS. 2A-2B, the mode detector 300 of FIG. 3, or the mode detector 400 of FIG. 1 can cause the regulator 100, 200 to operate in or enter a detection mode for setting a regulation mode of the regulator 100, 200. The mode detector 126, 226, 300, 400 can generate a sequence of voltages pulses 1410 at the output terminal 132, 232, 306, 406 (as the output terminal voltage 1402) when the regulator 100, 200 is in the detection mode. The mode detector 126, 226, 300, 400 can determine that the inductor is not coupled to the output terminal 132, 232, 306, 406 based on the output terminal voltage 1402 (the sequence of voltages pulses 1410). In response to determining that the inductor is not coupled to the output terminal 132, 232, 306, 406, the regulator 100, 200, at about a time 1420, can be set to operate in an LDO mode of operation.

The waveform diagram 1400 further includes an LDO enable signal 1404 (corresponding to the LDO enable signal of FIGS. 1-2), a linear regulated LDO output voltage 1406 (corresponding to the regulated LDO output voltage of FIGS. 1-2), a mode reference voltage 1414 and a feedback output voltage 1416. The mode reference voltage 1414 can correspond to the mode reference voltage and the feedback output voltage 1416 can correspond to a feedback output voltage as shown in FIGS. 1-2. The waveform diagram 1400 further includes a load current 1408 indicating an amount of current delivered by the regulator 100, 200 during the LDO mode of operation to a load, such as a noise-sensitive load, as described herein. In the LDO mode of operation, the linear regulated voltage 1406 being provided to the load can be maintained according to one or more examples, as described herein. The feedback output voltage 1416 can be dynamically adjusted to match the mode reference voltage 1414, as shown in FIG. 14. This adjustment can be facilitated by an error feedback circuit (e.g., the error feedback circuit 106 of FIG. 1 or the error feedback circuit 206 of FIGS. 2A-2B), which generates an LDO error voltage based on a difference between these two feedback signals. By continuously minimizing this difference, the regulator 100, 200 ensures that the linear regulated voltage 1406 remains stable and within a specified or desired voltage output range.

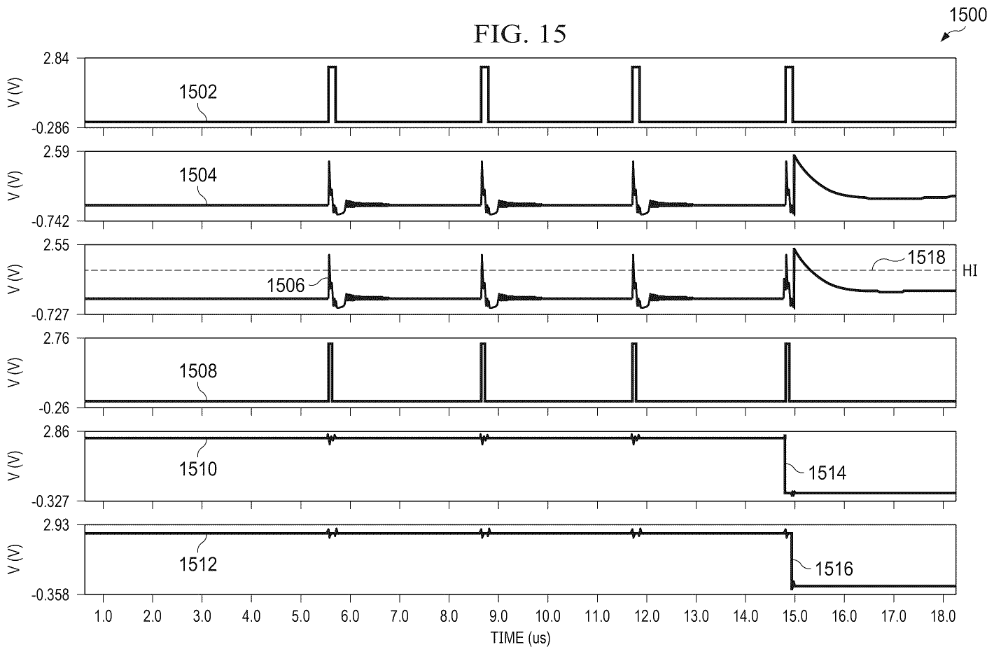

FIG. 15 illustrates an example of a waveform diagram 1500 for configuring (setting) the regulator 100 of FIG. 1 or the regulator 200 of FIG. 1 to operate in a buck mode of operation. An x-axis of the waveform diagram 1500 represents time in microseconds and a y-axis of the waveform diagram 1500 represents a voltage in volts. The regulator 100, 200 can be configured to operate in the buck of operation in response to detecting that an inductor (e.g., the inductor 316 of FIG. 3) is coupled to an output terminal, such the output terminal 132 of FIG. 1, the output terminal 232 of FIGS. 2A-2B, the output terminal 306 of FIG. 3 or the output terminal 406 of FIG. 4. The waveform diagram 1500 depicts signals generated during a detection process for detecting whether an inductor is coupled to the output terminal 132, 232, 306, 406. For example, the detection process can be implemented by a mode detector of the regulator 100, 200, such as the mode detector 126 of the regulator 100, the mode detector 226 of FIGS. 2A-2B, the mode detector 300 of FIG. 3, or the mode detector 400 of FIG. 4. The waveform diagram 1500 includes inductor detection signals 1502 (e.g., corresponding to inductor detection signals “Inductor_det_pulse” of FIG. 4), voltage pulses 1504, filtered comparator input voltage signals 1506 (e.g., corresponding to filtered comparator input voltages “INPRC” of FIG. 4), voltage pulse status signals 1508 (e.g., corresponding to voltage pulse status signals of FIG. 4), an LDO enable signal 1510 (e.g., corresponding to the LDO enable signal of FIGS. 1-4), and a mode detected signal 1512 (e.g., corresponding to the mode detected signal “mode_det” of FIGS. 3-4).

For example, the control circuit 310 of the mode detector 300 can cause the pull-up transistor 302 to provide a sequence of the voltage pulse signals 1504 at the output terminal 132, 232, 306, 406. The inductor detector circuit 312 of the mode detector 300 or the inductor detector circuit 402 of the mode detector 400 can detect each voltage pulse signal 1504 of the sequence and compare each detected voltage pulse signal (a corresponding filtered comparator input voltage signal of the filtered comparator input voltage signals 1506) to a reference threshold 1518 (e.g., the first input comparator voltage “INM” as shown in FIG. 4). For each detected voltage pulse signal that is greater than or equal to the reference threshold 1518 (identified as “H1” IN FIG. 15), the inductor detector circuit 312, 402 can output a corresponding inductor detection signal of the inductor detection signals 1502.

The inductor detector logic 314 of FIG. 3 or the inductor detector logic 435 of FIG. 4 can generate a corresponding voltage pulse status signal of the voltage pulse status signals 1508 that indicates whether the detected voltage pulse signal (the corresponding filtered comparator input voltage signal of the filtered comparator input voltage signals 1506) was equal to or greater than the reference threshold 1518. A voltage pulse status signal has a logical high state “1” to indicate that the detected voltage pulse signal was equal to or greater than the reference threshold 1518 corresponding to satisfying a threshold condition.

The inductor detector logic 435 transitions (causes) the LDO enable signal 1510 from a logical high state “1” to a logical low state “0”, as indicated in FIG. 15 at 1514, in response to determining that each of the detected voltage pulse signals (the filtered comparator input voltage signals 1506) satisfied the threshold condition. The inductor detector logic 435 transitions the mode detected signal 1512 from a logical high state “1” to a logical low state “0”, as shown in FIG. 15, as indicated in FIG. 15 at 1516. The mode detected signal 1512 can be at the logical low state in response to the threshold condition being satisfied. As shown in FIG. 15, in some examples, the LDO enable signal 1510 and the mode detected signal 1512 are initially in the logical high state, and when these signals are in the logical high state, the regulator 100, 200 can be referred to as operating in a detection mode. Accordingly, if the inductor detector logic 314 or 435 determines that the threshold condition was satisfied (e.g., all of the voltage pulse status signals 1508 are in a logical high state “1”), both the LDO enable signal 1510 and the mode detected signal 1512 remain at a logical low state “0,” which can indicate that the regulator 100, 200 is operating in the buck mode of operation.

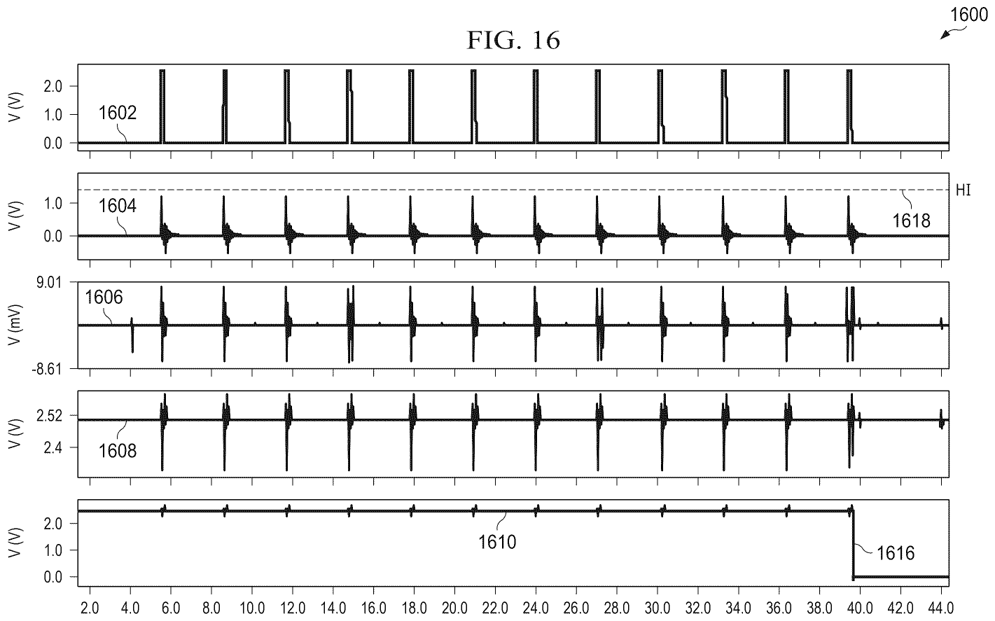

FIG. 16 illustrates an example of a waveform diagram 1600 for configuring (setting) the regulator 100 of FIG. 1 or the regulator 200 to operate in an LDO mode of operation. An x-axis of the waveform diagram 1600 represents time in microseconds and a y-axis of the waveform diagram 1600 represents a voltage in volts. The regulator 100, 200 can be configured to operate in the LDO mode of operation in response to not detecting an inductor (e.g., the inductor 316 of FIG. 1) being coupled to an output terminal, such the output terminal 132 of FIG. 1, the output terminal 232 of FIGS. 2A-2B, the output terminal 306 of FIG. 3 or the output terminal 406 of FIG. 4. The waveform diagram 1600 depicts signals generated during a detection process of a mode detector of a voltage regulator, such as the mode detector 126 of the regulator 100, the mode detector 226 of FIGS. 2A-2B, the mode detector 300 of FIG. 3, or the mode detector 400 of FIG. 4, for detecting that an inductor is coupled to the output terminal. The waveform diagram 1600 includes inductor detection signals 1602 (e.g., corresponding to inductor detection signals “Inductor_det_pulse” of FIG. 4), filtered comparator input voltage signals 1604 (e.g., corresponding to the filtered comparator input voltage “INPRC” of FIG. 4), voltage pulse status signals 1606 (e.g., corresponding to voltage pulse status signals of FIG. 4), an LDO enable signal 1608 (e.g., corresponding to the LDO enable signal of FIGS. 1-4), and a mode detected signal 1610 (e.g., corresponding to the mode detected signal “mode_det” of FIGS. 3-4).

In some examples, the control circuit 310 can cause the pull-up transistor 302 to provide a number of sequences of voltage pulse signals at the output terminal 132, 232, 306, 406. The inductor detector circuit 312 of FIG. 3 or the inductor detector circuit 402 of FIG. 4 can detect each voltage pulse signal of each sequence and compare each detected voltage pulse signal (a corresponding filtered comparator input voltage signal of the filtered comparator input voltage signals 1604) to a reference threshold 1618 (e.g., the first input comparator voltage “INM” of FIG. 4). For each detected voltage pulse signal that is greater than or equal to the reference threshold 1618 (identified as “H1” in FIG. 16), the inductor detector circuit 312, 402 can output a corresponding inductor detection signal of the inductor detection signals 1602.

The inductor detector logic 314 of FIG. 3 or the inductor detector logic 435 of FIG. 4 can generate a corresponding voltage pulse status signal of the voltage pulse status signals 1606 that indicates whether the detected voltage pulse signal (the corresponding filtered comparator input voltage signal of the filtered comparator input voltage signals 1604) was equal to or greater than the reference threshold 1618. A voltage pulse status signal has a logical low state “0” to indicate that the detected voltage pulse signal was not equal to or greater than the reference threshold 1618 corresponding to not satisfying a threshold condition.

In some examples, the inductor detector logic 435 provides the LDO enable signal at a logical low state “0”, in response to determining that each of the detected voltage pulse signals (the filtered comparator input voltage signals) for a last (final) sequence of voltage pulses satisfied the threshold condition. The inductor detector logic 435 transitions the mode detected signal 1610 from a logical high state “1” to a logical low state “0”, as indicated in FIG. 16 at 1616. The mode enable signal can be at the logical low state in response to the threshold condition not being satisfied.

In a final sequence of voltage pulses (e.g., fourth sequence of voltage pulses), if all the voltage pulse status signals 1606 for that sequence are in the logical low state “0,” this indicates that none of the pulses met the threshold condition. As a result, the inductor detector logic 314 or 435 causes the LDO enable signal to be provided at a logical high state “1,” and the mode detected signal 1610 to be provided at the logical low state “0”. Accordingly, if the inductor detector logic 314 or 435 determines that the threshold condition was not satisfied (e.g., all of the voltage pulse status signals 1606 for the final sequence of voltage pulses are in a logical high state “1”), the LDO enable signal is at the logical high state “1” and the mode detected signal 1610 is at a logical low state “0,” which can indicate that the regulator 100, 200 is operating in the LDO mode of operation.

In scenarios where both the LDO enable signal and the mode detected signal 1610 are at a logical high state “1,” the regulator 100 or 200 is in a detection mode. In detection mode, the regulator 100 or 200 determines whether to operate in LDO mode or buck mode based on voltage pulses. If the mode detected signal 1610 is at a logical high state “1” and the LDO enable signal is at a logical low state “0,” this indicates that the regulator 100 or 200 is in an error mode. In error mode, neither LDO mode nor buck mode can be determined, signaling a fault condition in the detection process and the regulator 100, 200 can be referred to as an error or fault mode of operation.

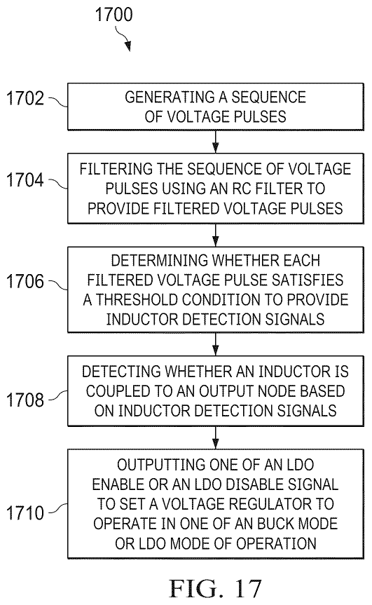

FIG. 17 illustrates a flowchart of an example method 1700 for setting (configuring) an operating mode of a regulator, such as the regulator 100 of FIG. 1, the regulator 200 of FIGS. 2A-2B, the regulator 904 of FIG. 9, or the regulator 1004 of FIG. 10. The method 1700 can be implemented by a mode detector as described herein, such as the mode detector 300 of FIG. 3. The method 1700 can begin at 1702 by generating (e.g., using the control circuit 310 of FIG. 1) a sequence of voltage pulses at an output terminal (e.g., the output terminal 132 of FIG. 1, the output terminal 232 of FIGS. 2A-2B, the output terminal 306 of FIG. 3, the output terminal 406 of FIG. 4, the output terminal 906 of FIG. 9 or the output terminal 1006 of FIG. 10). The sequence of voltage pulses is generated to evaluate inductive characteristics at the output terminal.

At 1704, filtering the sequence of voltage pulses using an RC filter (e.g., using the internal RC filter 438 of FIG. 4 of the inductor detector circuit 402 of FIG. 4 or the inductor detector circuit 312 of FIG. 3) to provide filtered voltage pulses. A filtered voltage pulse can represent an amount of inductance present at the output terminal. At 1706, determining (e.g., by the comparator 410 of FIG. 4) whether each filtered voltage pulse satisfies a threshold condition to provide inductor detection signals (e.g., the inductor detection signals of FIG. 4). The threshold condition can correspond to a pseudo-inductive threshold that represents a parasitic inductive at the output terminal. Each inductor detection signal indicates whether a corresponding filtered voltage pulse was greater than or equal to a reference threshold (e.g., the first input comparator voltage INM of FIG. 4).

At 1708, detecting whether the inductive element is coupled to the output terminal based on the inductor detection signals. At 1710, outputting one of an LDO enable signal (identified as “LDOen” in FIG. 3) in response to determining that the inductive element is coupled to the output terminal to configure the regulator 100, 200 to operate in a buck mode of operation, or the LDO disable signal (identified as “LDOenz”) in response to determining that the inductive element is not coupled to the output terminal to configure the regulator 100, 200 to operate in an LDO mode of operation.

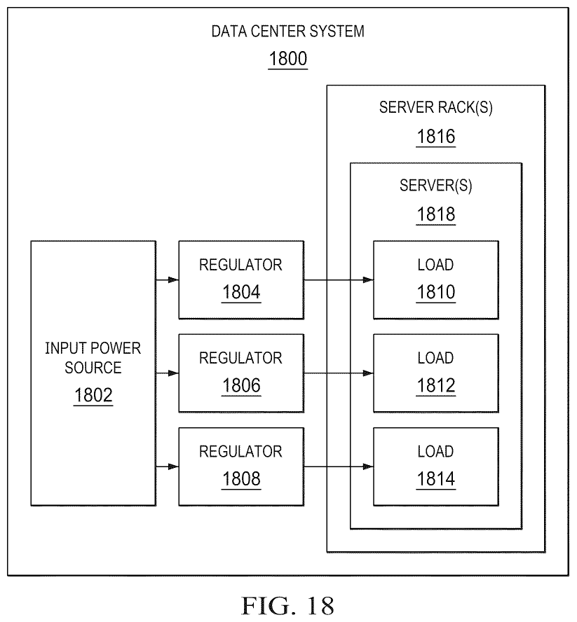

FIG. 18 illustrates an example of a datacenter system 1800. The system 1800 includes an input power source 1802, a number of regulators 1804-1808 and loads 1810-1814. One or more of the regulators 1804-1808 can be implemented as the regulator 100 of FIG. 1, the regulator 200 of FIGS. 2A-2B, the regulator 904 of FIG. 9, or the regulator 1004 of FIG. 10, as described herein. Each regulator 1804-1808 can be configured to deliver power to specific loads based on the operational requirements of the datacenter system. For example, the regulator 1804 can be configured to supply power to a high-performance processor or memory module that may need high efficiency, while the regulator 1808 can support a low-noise communication device.

In some examples, the input power source 1802 can include an AC-to-DC converter or a DC power supply to deliver stable input power to the regulators 1804-1808. In some examples, the input power source 1802 can include an uninterruptible power supply (UPS) system that provides reliable backup power to ensure continued operation during power outages or fluctuations. The UPS can supply input power to an AC-to-DC converter or a DC power supply, which delivers stable input power to the regulators 1804-1808. The UPS can also manage power distribution across server racks, where each rack contains multiple servers or other equipment.

The regulators 1804-1808 can be configured to operate in a respective operating mode, such as an LDO mode or a buck mode based on whether an inductor is coupled to an output of a respective regulator 1804-1808. For example, if no external inductor is detected at the output terminal, the respective regulator 1804-1808 can operate in the LDO mode to supply a low-noise, regulated voltage. In other examples, if an external inductor is detected, the respective regulator 1804-1808 operates in the buck mode to provide a high-efficiency, regulated voltage suitable for non-noise-sensitive loads.

In some configurations, the regulators 1804-1808 are integrated within PMIC (or within respective PMICs) to optimize space and/or reduce system complexity. The PMIC may include features such as thermal monitoring, fault detection, and power sequencing to enhance the robustness and scalability of the datacenter system 1800. The loads 1810-1814 can encompass a wide range of devices, including servers, networking equipment, and storage systems, which are housed within one or more server racks 1816 in the datacenter. The one or more server racks 1816 can be interconnected via networking infrastructure to facilitate high-speed communication and data processing. Each load 1810-1814 may need precise voltage regulation to ensure reliable operation. For example, one or more servers 1818 in the one or more server racks 1816 may need regulated power for corresponding CPU, memory modules, and I/O systems, while networking equipment may need a stable, noise-free voltage for sensitive communication components.

In this description, numerical designations “first”, “second”, etc. are not necessarily consistent with the same designations in the claims herein. Additionally, the term “couple” or variants thereof may cover connections, communications, or signal paths that enable a functional relationship consistent with this description. For example, if device A provides a signal to control device B to perform an action, then: (a) in a first example, device A is directly coupled to device B; or (b) in a second example, device A is indirectly coupled to device B through intervening component C if intervening component C does not alter the functional relationship between device A and device B, so device B is controlled by device A via the control signal provided by device A. In this description, the term “based on” means based at least in part on.

Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Furthermore, a circuit or device described herein as including certain components may instead be configured to couple to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor wafer and/or integrated circuit (IC) package) and may be configured to couple to at least some of the passive elements and/or the sources to form the described structure, either at a time of manufacture or after a time of manufacture, such as by an end user and/or a third party.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means within +/−10 percent of the stated value, or, if the value is zero, a reasonable range of values around zero. Modifications are possible in the described embodiments, and other embodiments are possible, within the scope of the claims.

What is claimed is:

1. A system comprising:
a voltage regulator having an output terminal, the voltage regulator comprising:
a mode detector configured to determine whether an inductive element is coupled to the output terminal based on an amount of inductance at the output terminal, the mode detector configured to set the voltage regulator to operate in either a buck mode of operation or a linear dropout (LDO) mode of operation based on the amount of inductance at the output terminal.

2. The system of claim 1, wherein the voltage regulator includes a power stage comprising a high-side transistor configurable for use in both the buck and LDO mode of operation to provide a regulated voltage at the output terminal.

3. The system of claim 1, wherein the mode detector is configured to provide an LDO enable signal to set the voltage regulator to operate in the LDO mode of operation in response to determining that the inductive element is not coupled to the output terminal based on the inductance at the output terminal, the voltage regulator further comprising:
a level shifter configured to provide a gate voltage responsive to a charge pump voltage; and
a power stage comprising a high-side transistor and a low-side transistor, the low-side transistor is configurable to be disabled based on the LDO enable signal, and a control terminal of the high-side transistor receives the gate voltage.

4. The system of claim 3, wherein the voltage regulator further comprises a voltage converter configured to provide the charge pump voltage based on first and second phase signals that are out-of-phase to control an operation of the voltage converter in a charge pump mode, and a boot voltage based on the first and second phase signals that are in-phase to control the operation of the voltage converter in a bootstrap mode, the first and second phase signals representing timing signals.

5. The system of claim 3, wherein the voltage regulator is configured to operate in an inductor detection mode of operation responsive to initialization, wherein the mode detector is configured to, when the voltage regulator is operating in the inductor detection mode of operation, determine whether a pre-bias voltage is present at the output terminal and apply a sequence of voltage pulses based on the pre-bias voltage for determining a mode of operation of the voltage regulator, the mode of operation including the buck mode of operation and the LDO mode of operation.

6. The system of claim 5, wherein the mode detector comprises:
a pre-bias comparator circuit configured to compare an output terminal voltage at the output terminal relative to a reference voltage to determine whether the pre-bias voltage is present at the output terminal; and
a pre-bias detection logic circuit configured to drive a transistor to generate the sequence of voltage pulses based on the pre-bias voltage for determining the mode of operation of the voltage regulator.

7. The system of claim 1, wherein the voltage regulator is configured to operate in an inductor detection mode of operation responsive to initialization, and the mode detector comprises an inductor detector circuit comprising a comparator and a filter, and
wherein, when the voltage regulator is operating in the inductor detection mode of operation, the filter is configured to filter a sequence of voltage pulses applied to the output terminal to provide filtered voltage pulses representing an amount of inductance present at the output terminal, the comparator is configured to compare each filtered voltage pulse relative to a pseudo-inductive threshold representing a parasitic inductance at the output terminal and provide an inductor detection signal indicative of a result of the comparison.

8. The system of claim 7, wherein the mode detector further comprises inductor detector logic configured to either:
set the voltage regulator to operate in the buck mode of operation in response to determining that each of the voltage pulses of the sequence of voltage pulses satisfy the threshold responsive to inductor detection signals provided by the comparator; or
initiate a retry process to apply a subsequent sequence of voltage pulses to the output terminal in response to determining that the sequence of voltage pulses do not satisfy the threshold corresponding to at least one of the inductor detection signals being at a logical low.

9. The system of claim 8, wherein the retry process is applied for a number of retry loops, and after the number of retry loops reaches a maximum count value, the inductor detector logic is configured to set the voltage regulator to operate in the LDO mode of operation in response to determining that a last sequence of voltage pulses applied to the output terminal did not satisfy the threshold corresponding to at least one inductor detection signal of inductor detection signals for the last sequence of voltage pulses being at the logical low.

10. The system of claim 8, wherein the retry process is applied for a number of retry loops, and after the number of retry loops reaches a maximum count value, the inductor detector logic is configured set the voltage regulator to operate in an error mode of operation in response to determining that one or more voltage pulses in a last sequence of voltage pulses applied to the output terminal satisfied the threshold corresponding to at least one inductor detection signal of inductor detection signals for the last sequence of voltage pulses being at the logical high.

11. The system of claim 1, wherein the mode detector is configured to provide an LDO disable signal in response to determining that the inductive element is coupled to the output terminal, the voltage regulator further comprises:
a power stage comprising a transistor;
a driver stage, the driver stage is enabled in response to the LDO disable signal to provide a gate voltage to a control terminal of the transistor based on a boot voltage; and
a voltage converter configured to provide the boot voltage based on first and second phase signals being in-phase, the first and second phase signals representing timing signals and used to control an operation of the voltage converter in a bootstrap mode.

12. The system of claim 1, further comprising a power management system that comprises the output terminal and input terminal, the input terminal of the power management system is coupled to an input of the voltage regulator, wherein a feedback voltage is received at the input terminal based on a regulated voltage that is provided while the inductive element is coupled to the output terminal, the voltage regulator configured to provide a switching voltage while operating in the buck mode of operation responsive to the feedback voltage, and wherein the regulated voltage is provided responsive to the switching voltage at the output terminal.

13. The system of claim 1, further comprising a power management system that comprises the output terminal and an input terminal that is coupled to an input of the voltage regulator, wherein a feedback voltage is received at the input terminal based on a regulated LDO output voltage provided by the voltage regulator while operating in the LDO mode of operation, and wherein the voltage regulator while operating the LDO mode of operation is configured to adjust the regulated output voltage based on the feedback voltage.

14. A circuit comprising:
a transistor having a control terminal;
a step-up converter having first and second inputs and an output, the output of the step-up converter coupled to the control terminal of the transistor;
a phase signal generator having first and second outputs, the first output of the phase signal generator is coupled to the first input of the step-up converter, and the second output of the phase signal generator is coupled to the second input of the step-up converter; and
a level shifter having an input and an output, the input of the level shifter coupled to the output of the step-up converter, and the output of the level shifter coupled to the control terminal of the transistor.

15. The circuit of claim 14, further comprising
a switch having a first input, a second input, and an output, wherein the first input of the switch is coupled to the output of the level shifter and the output of the switch is coupled to the control terminal of the transistor; and
a mode detector having an input adapted to be coupled to an output terminal, the output of the mode detector coupled to the second input of the switch.

16. The circuit of claim 15, wherein the switch is a first switch, the output of the mode detector is a first output and the mode detector has a second output, the phase signal generator comprising a first input and a second input, the circuit further comprising:
a gate signal router having an input and an output, the input coupled to the output of the mode detector and the output coupled to the first input of the phase signal generator;
a clock selector having an output, the output of the clock selector coupled to the second input of the phase signal generator; and
a second switch having a first input, a second input, and an output, the first input of the second switch adapted to be coupled to an error feedback circuit, the second input of the second switch is coupled to the second output of the mode detector, and the output of the second switch being adapted to be coupled to a pulse width modulation (PWM) controller.

17. A method comprising
filtering one or more sequences of voltage pulses applied to an output terminal to detect an amount of inductance at the output terminal, wherein an output of a multi-mode voltage regulator is coupled to the output terminal;
evaluating each of the filtered one or more sequence of voltage pulses to a pseudo-inductive threshold representative of a parasitic inductance at the output terminal to provide one or more sets of inductor detection signals; and
setting the multi-mode voltage regulator to one of a first mode or a second mode of operation based on a logical state of the one or more sets of inductor detection signals.

18. The method of claim 17, further comprising:
receiving at an input of the multi-mode voltage regulator a feedback voltage based on a regulated voltage, the regulated voltage is provided based on an output voltage at the output terminal while an inductive element is coupled to the output terminal; and
adjusting the output voltage at the output terminal based on the feedback voltage.

19. The system of claim 17, further comprising, while operating in the first mode of operation:
receiving at an input of the multi-mode voltage regulator a feedback voltage based on an output voltage at the output terminal; and
adjusting the output voltage at the output terminal based on the feedback voltage.

20. The method of claim 17, wherein the first mode of operation is a buck mode and the second mode of operation is a linear dropout (LDO) operating mode.
